(19) United States
(12) Patent Application Publication
(10) Pub. No.: US 2021/0400975 A1
(43) Pub. Date: Dec. 30, 2021

(54) Methods and Compositions for Use in Glued-Wood Products

(71) Applicant: Lonza Solutions AG, Visp (CH)

(72) Inventors: Christopher Edmond Rowse, Pakuranga Auckland (NZ); Kristina Maree Day, New Plymouth (NZ); Peter James Hayward, New Plymouth (NZ); Christopher Molloy, New Plymouth (NZ); André Frederik Siraa, New Plymouth (NZ); Steven John Foggo, New Plymouth (NZ); Hemant Kumar, New Plymouth (NZ)

(21) Appl. No.: 17/358,250

(22) Filed: Jun. 25, 2021

(30) Foreign Application Priority Data
Jun. 26, 2020 (EP) 20 182 504.9

(51) Int. Cl. A01N 47/42; B27M 3/00; C09J 9/00; C09J 11/04; C09J 125/12; C09J 125/06; A01N 43/653; A01N 53/00; C09J 11/06

(52) U.S. Cl. CPC A01N 47/42; B27M 3/0053; C09J 9/00; C09J 11/04; C09J 2400/30; C09J 125/06; A01N 43/653; A01N 53/00; C09J 11/06; C09J 125/12

(57) ABSTRACT

The present invention relates to biocide-composites providing high retention of biocides in glueline-treated glued-wood products that are hot-pressed or hot-pressed and block-stacked during manufacture.

### FIELD OF THE INVENTION

The present invention is in the field of materials including wood or other cellulosic fibres and adhesion of such wood products, and more specifically directed to the manufacture of such glued-wood products, and more specifically to providing a biocide-composite applied to the adhesive of the wood-product providing high retention of biocides in such glued-wood products that are hot-pressed or hot-pressed and block-stacked during manufacture.

### BACKGROUND OF THE INVENTION

Biocides of various kinds are used to protect commercial wood products with low natural durability from degradation by insects including termites, ants, boring insects, weevils and beetles, as well as decay microorganisms, moulds and sap staining organisms. Historically wood protectants were largely based on inorganic mixtures comprising copper, chromium, arsenic, zinc, tin, boron and fluorine compounds but these are progressively being supplemented and/or replaced with more benign organic biocides in response to environmental and health concerns.

Biocide treated timber and wood products are sampled and analysed after treatment with biocides to ensure conformity to minimum biocide “retentions” required to protect the material. These minimum retentions are codified as part of country or regional “standards” or codes, which are typically based on the material treated, the nature of the threat, e.g. insect or decay, and “hazard class”, a term referring to the location of the product in a building or structure and the severity of environmental challenge in service, e.g. whether the product is exposed to the weather or protected by cladding in a building. Further standards specify methods of sampling and biocide analysis, treatment methods, etc.

Biocide application methods in commercial use range from surface treatments, such as spraying and dipping, to pressure treatments involving full immersion in combination with various cycles of pressure and/or vacuum. Surface or “envelope” treatments produce limited penetration and are generally suitable for insecticides and anti-sapstain compounds, whereas pressure treatments result in partial or complete penetration depending on the wood species, the type of wood, i.e. sapwood versus heartwood, and the dimensions of the treated article. Pressure treatments are suitable for most types of biocide. Both application methods are widely used to treat sawn timber or lumber.

Similar treatment methods are possible with glued-wood products, which include glued-wood products comprising veneers such as plywood and LVL, as well as glued-wood products containing wood strands, particles, etc., such as oriented strand boards (OSB) and medium density fibreboard (MDF).

Generally, glued-wood products such as plywood and laminated veneer lumber (LVL), medium density fibreboard (MDF), oriented strand board (OSB), and the like may be surface treated with an insecticide in a minimal volume of water or organic solvent without any loss of structural integrity. Pressure treatments can be used to deliver water-borne or solvent-borne fungicides and/or insecticides to plywood and LVL but aqueous pressure treatments are generally not suitable for MDF, OSB, etc., which can break down when extensively rewetted during treatment. Surface and pressure treatments must be conducted post manufacture with associated logistical complexities and significant cost.

Another treatment option includes the delivery of wood protectants or biocides in the glues used to make these glued-wood products, also known as “glueline treatment”. Glueline treatment involves applying the biocide during manufacturing operations. For example, plywood and LVL are manufactured by spreading glue onto dry rotary peeled veneers, assembling a variable number of veneers in the appropriate configuration or “layup”, optionally cold pressing the layup, and then hot pressing it to compress the product to the required thickness and cure the glue. Glueline treatment of plywood and LVL involves blending the biocide into the glue before spreading thus distributing the biocide in the “gluelines” and adjacent regions of the wood component in the finished product. Glueline treatments are carried out in a similar fashion with products comprising wood flakes, strands and fibres, except there are more options for introducing the glue and the biocide depending on the particular product and its method of manufacture.

The choice of biocide for glueline addition is generally restricted to organic biocides because inorganic compounds are incompatible with most glues, with the exception of some zinc and boron compounds which are compatible with powdered glues used in some fibre and strand based products. However, hot pressing temperatures as high as 250° C. can lead to thermal degradation of organic biocides, which results in a reduction of biocide retention across a board compared to the nominal dose applied. Some glues such as isocyanate resins are highly reactive and capable of forming covalent adducts with organic biocides. Other resins may be acidic or alkaline. Heat and pressure, along with the introduction of steam (free water as reactant) in some processes, can exacerbate chemical degradation and/or sequestration of the biocide depending on the glue chemistry.

While not wishing to be bound by theory, reduced biocide retentions may result from a complex mixture of processes that may occur during the production including chemical degradation of the biocide, sequestration of the biocide within the cured resin, and conversion of the biocide to other biologically active and inactive chemical forms. The relative importance of these processes is likely to differ from biocide to biocide.

Moreover, some glued-wood products are “block-stacked” post-press to retain heat to allow further glue polymerisation and promote slow cooling to obtain stable flat boards that won't bow or twist post manufacture. The centre of a typical block stack cools from in excess of 100° C. to ambient temperature over about two days whereas exterior parts cool more rapidly.

Hot press conditions generally lead to relatively uniform reductions in biocide retention across a board compared to the theoretical dose applied. Block stack conditions generally lead to further reductions that are more pronounced at the centre of the stack than the edges. The net result is that the glue must be overdosed with biocide to ensure that all parts of the board pass minimum retention requirements.

It has been proposed that some biocidal ingredients are inherently more stable to degradation during hot pressing, including the fungicide epoxiconazole (U.S. Publication No. 2012/0100361), and the insecticides thiacloprid (U.S. Pat. No. 8,114,425) and bifenthrin (AU Patent No. 2003266461).

Formulation types in current use for glueline treatment with biocides (including the above) include micro emulsions (ME), emulsion concentrates (EC), suspension concentrates (SC) and wettable powders (WP) as disclosed in AU Patent No. 2003266461 or capsule suspensions (CS) as disclosed in AU Patent No. 2006220419. Further formulation types are described in US publication 2012/0100361 as an oil solution, an emulsion, a solubilizer, a wettable powder, a suspension, a flowable formulation and a dust formulation.

Water-insoluble thermoplastics and methods of forming composites with a biocide are included in the following publications, which are incorporated herein by reference:

(1) U.S. Publication No. 2012/0071324 discloses acrylonitrile polymers including styrene acrylonitrile polymers, the formation of composites by extrusion and the milling of composites in the presence or absence of non-solvent liquids. The publication proposed incorporation of biocides, in particular algicides, into such polymers for the purpose of reducing leaching into water and hence promoting the longevity of algicides when incorporated into paints.

(2) U.S. Publication No. 2006/0111242 discloses powdered formulations comprising an agrochemical, in particular imidacloprid, and a styrene acrylonitrile copolymer containing 20-40% acrylonitrile prepared by extrusion and milling for the purpose of overcoming the phytotoxicity of imidacloprid to seedlings when applied to the seeds as a seed dressing.

(3) U.S. Publication No. 2008/0069892 discloses a powdered formulation comprising an agrochemical and a polyurethane and/or polyurethane urea prepared by extrusion and milling or by solvent evaporation and milling for the purpose of applying to plants and/or their environment and achieving release over a prolonged period.

(4) U.S. Publication No. 2010/0297204 discloses a particulate polymer matrix prepared by extrusion and milling comprising a biocide and a thermoplastic polymer for the purpose of reducing leaching into water when incorporated into paints and renders. The polymers exemplified include water-insoluble polyurethanes and polyamides.

(5) U.S. Pat. No. 7,070,795 discloses matrix particles comprising agricultural active ingredients entrapped within polymeric matrices for the purpose of avoiding phytotoxicity to plants and seeds. A preferred method of matrix particle formation involves dissolution of an active ingredient and a polymer in an organic solvent (organic phase), emulsification into water (aqueous phase), then solvent removal by evaporation (“emulsification—solvent evaporation”). A further preferred method involved hot melt mixing active ingredient and polymer then dispersion into a hot non-miscible solvent (“hot melt microencapsulation”).

None of the above formulation types or biocide presentations provide any solution to the problem of significantly reduced biocide retentions in glued-wood products after hot pressing, in particular after hot pressing and block stacking during manufacture.

There is a need to provide compositions and methods for glueline preservation of glued-wood products wherein the biocide is more resistant to degradation, inactivation and/or sequestration during the manufacturing process. Degradation, inactivation and/or sequestration of the biocide during the manufacturing process leads to a decrease of biocide retention in the glued-wood product as well as uneven biocide retentions in different regions of the glued-wood product. This is particularly important after hot pressing and block stacking.

A desired feature of the present invention is therefore to overcome the problems as discussed, or at least to provide the public with a useful choice.

The present invention provides a solution to this problem by providing biocide-composite materials that achieve high retentions of the biocide in a glueline-treated glued-wood product after hot-pressing and block-stacking. Such high retentions cannot be achieved with the known biocide-formulations. A further advantage is that the biocide is more efficacious.

Any discussion of the prior art throughout the specification should in no way be considered as an admission that such prior art is widely known or forms part of the common general knowledge in the field. All references cited in this specification are incorporated by reference in their entirety.

### SUMMARY OF THE INVENTION

In one aspect, the present invention provides biocide-composite comprising a) at least one biocide and b) at least one non-biocidal solid selected from the group consisting of a thermoplastic, an embrittling agent, and combinations thereof.

In one embodiment, the at least one biocide comprises one or more insecticides, or one or more fungicides, or a combination thereof.

In one embodiment, the at least one biocide can be an insecticide independently selected from the group consisting of neonicotinoids, pyrethroids, phenylpyrazoles, avermectins, chitin synthesis inhibitors, uncouplers of oxidative phosphorylation, insect growth regulators, or a combination thereof.

In one embodiment the at least one insecticide can be independently selected from the group consisting of imidacloprid, bifenthrin, fipronil, etofenprox, permethrin, buprofezin, emamectin benzoate, or a combination thereof.

In one embodiment the at least one insecticide is imidacloprid.

In one embodiment the at least one biocide can be a fungicide independently selected from the group consisting of an azole, and a quinone outside inhibitor fungicide, or a combination thereof.

In one embodiment the at least one fungicide can be independently selected from the group consisting of cyproconazole, penconazole, triadimefon, pyraclostrobin, trifloxystrobin or combinations thereof.

In one embodiment, the at least one non-biocidal solid is i) a water-insoluble thermoplastic having a glass transition temperature (Tg) of 45° C. or more, or a Vicat softening temperature (VST) of 45° C. or more, and/or ii) an embrittling agent.

In one embodiment, the water-insoluble thermoplastic can be independently selected from the group consisting of polymers and copolymers comprising polyoxymethylene, polyamide, polyacrylonitrile, polycarbonate, polyetherimide, polyethersulfone, polyethylene, polyethylene terphthalate, polyphenylene sulphide, polypropylene, polystyrene, polysulfone, polyvinyl chloride, acrylonitrile butadiene styrene, an acrylate polymer, a methacrylate polymer, a polymethylmethacrylate, a sidechain modified polymer, a biopolymer comprising a cellulose ether or ester, polylactic acid, a water-insoluble protein, a high melting point wax, biopolymer blends, thermoplastic aliphatic and aromatic hydrocarbon resins, a styrene acrylonitrile copolymer, or a combination thereof.

In one embodiment, the thermoplastic can be independently selected from the group consisting of a styrene acrylonitrile copolymer, a polystyrene, a cellulose ether, a polylactic acid, a polyvinyl chloride, a polymethylmethacrylate or a combination thereof.

In one embodiment, the thermoplastic can be independently selected from the group consisting of a styrene acrylonitrile copolymer, a polystyrene, a cellulose ether, a polylactic acid, a polyvinyl chloride, a polymethylmethacrylate or a combination thereof, having a glass transition temperature (Tg) of 45° C. or more, or a Vicat softening temperature (VST) of 45° C. or more.

In one embodiment, the thermoplastic is a styrene acrylonitrile copolymer.

In one embodiment, the embrittling agent can be independently selected from the group consisting of a ground mineral, a chemically modified clay, an organoclay, a silicate, diatomaceous earth, pumice, limestone, chalk, calcium carbonate, calcite, dolomite, gypsum, feldspar, alumina, perlite, powdered coal or sulphur, ground ceramic, ground glass, sawdust, wood flour, ground bark, powdered lignin, ground nut shells, husks, kernels, talc or a combination thereof.

In one embodiment the embrittling agent can be independently selected from the group consisting of talc, an organoclay or a combination thereof.

In one embodiment the embrittling agent is an organoclay.

In one embodiment, the biocide-composite according to the present invention has a particle size Dv10 of at least about 5 μm and Dv90 of about 500 μm or less. In another embodiment the biocide-composite according to the present invention has a particle size Dv10 of at least about 5 μm and Dv90 of about 400 μm or less. In another embodiment the biocide-composite according to the present invention has a particle size range from about 1 μm to about 500 μm.

In one embodiment, the biocide-composite according to the present invention comprises from about 1 to about 98 wt. % biocide, or from about 1 to about 90 wt. % biocide, or from about 2 to about 80 wt. % biocide, or from about 3 to about 75 wt. % biocide, or from about 4 to about 60 wt. % biocide, or from about 5 to about 50 wt. % biocide, or from about 6 to about 40 wt. % biocide, or from about 7 to about 30 wt. % biocide, or from about 8 to about 25 wt. % biocide; from about 1 wt. % to about 98 wt. % thermoplastic, or from about 25 wt. % to about 95 wt. % thermoplastic, or from about 30 wt. % to about 90 wt. % thermoplastic, or from about 40 wt. % to about 89 wt. % thermoplastic, or from about 45 wt. % to about 85 wt. % thermoplastic, or from about 45 wt. % to about 80 wt. % thermoplastic, or from about 45 wt. % to about 70 wt. % thermoplastic, or from about 45 wt. % to about 60 wt. % thermoplastic, and from about 1 wt. % to about 98 wt. % embrittling agent, or from about 2 wt. % to about 75 wt. % embrittling agent, or from about 3 wt. % to about 50 wt. % embrittling agent, or from about 4 wt. % to about 45 wt. % embrittling agent, or from about 5 wt. % to about 40 wt. % embrittling agent, based on the combined weight of the biocide, the thermoplastic and the embrittling agent. Any combinations of the above are encompassed.

In one embodiment, the biocide-composite according to the present invention comprises from about 7 to about 30 wt. % biocide; from about 45 wt. % to about 85 wt. % thermoplastic; and from about 4 wt. % to about 45 wt. % embrittling agent, based on the combined weight of the biocide, the thermoplastic and the embrittling agent.

In one embodiment, the biocide-composite according to the present invention comprises from about 8 to about 25 wt. % biocide; from about 45 wt. % to about 80 wt. % thermoplastic, and from about 5 wt. % to about 40 wt. % embrittling agent, based on the combined weight of the biocide, the thermoplastic and the embrittling agent.

In one embodiment the present invention provides a biocide-composite obtainable by a process comprising the following steps
a) Contacting at least one biocide with at least one thermoplastic and at least one embrittling agent,
b) Mixing and melting the mixture from step a) to form a biocide-composite,
c) Cooling said biocide-composite from step b) to form a solid biocide-composite, and
d) Optionally comminution of said solid biocide-composite to obtain said biocide-composite in particulate form.

In one embodiment the present invention provides a biocide-composite obtainable by a process comprising the following steps
a) Contacting at least one insecticide with at least one thermoplastic and at least one embrittling agent,
b) Mixing and melting the mixture from step a) to form a biocide-composite,
c) Cooling said biocide-composite from step b) to form a solid biocide-composite, and
d) Optionally comminution of said solid biocide-composite to obtain said biocide-composite in particulate form,
   wherein said insecticide is independently selected from the group comprising a neonicotinoid, a pyrethroid, a phenylpyrazole, an avermectin, a chitin synthesis inhibitor, an uncoupler of oxidative phosphorylation, an insect growth regulators, or a combination thereof
   wherein said thermoplastic is independently selected from a group consisting of a styrene acrylonitrile copolymer, a polystyrene, a cellulose ether, a polylactic acid, a polyvinyl chloride, a polymethylmethacrylate or a combination thereof, and
   wherein said embrittling agent is independently selected from the group consisting of organoclay, talc or a combination thereof.

In one embodiment the present invention provides a biocide-composite obtainable by a process comprising the following steps
a) Contacting at least one insecticide with at least one thermoplastic and at least one embrittling agent,
b) Mixing and melting the mixture from step a) to form a biocide-composite,
c) Cooling said biocide-composite from step b) to form a solid biocide-composite, and
d) Optionally comminution of said solid biocide-composite to obtain said biocide-composite in particulate form,
   wherein said insecticide is independently selected from the group comprising a neonicotinoid, a pyrethroid, a phenylpyrazole, an avermectin, a chitin synthesis inhibitor, an uncoupler of oxidative phosphorylation, an insect growth regulators, or a combination thereof
   wherein said thermoplastic is independently selected from a group consisting of a styrene acrylonitrile copolymer, a polystyrene, a cellulose ether, a polylactic acid, a polyvinyl chloride, a polymethylmethacrylate or a combination thereof,
   wherein said embrittling agent is independently selected from the group consisting of organoclay, talc or a combination thereof, and
   wherein said biocide-composite comprises from about 6 to about 40 wt. % biocide, from about 45 wt. % to about 60 wt. % thermoplastic, and from about 5 wt. % to about 40 wt. % embrittling agent, based on the combined weight of the biocide, the thermoplastic and the embrittling agent.

In one embodiment the present invention provides a biocide-composite obtainable by a process comprising the following steps
a) Contacting at least one insecticide with at least one thermoplastic and at least one embrittling agent,
b) Mixing and melting the mixture from step a) to form a biocide-composite,
c) Cooling said biocide-composite from step b) to form a solid biocide-composite, and
d) Optionally comminution of said solid biocide-composite to obtain said biocide-composite in particulate form,
   wherein said insecticide is independently selected from the group comprising a neonicotinoid, a pyrethroid, a phenylpyrazole, an avermectin, a chitin synthesis inhibitor, an uncoupler of oxidative phosphorylation, an insect growth regulators, or a combination thereof
   wherein said thermoplastic is independently selected from a group consisting of a styrene acrylonitrile copolymer, a polystyrene, a cellulose ether, a polylactic acid, a polyvinyl chloride, a polymethylmethacrylate or a combination thereof,
   wherein said embrittling agent is independently selected from the group consisting of organoclay, talc or a combination thereof, and
   wherein said biocide-composite comprises from about 1 to about 90 wt. % biocide, from about 25 wt. % to about 95 wt. % thermoplastic, and from about 2 wt. % to about 75 wt. % embrittling agent, based on the combined weight of the biocide, the thermoplastic and the embrittling agent.

In one embodiment the present invention provides a biocide-composite obtainable by a process comprising the following steps
a) Contacting at least one insecticide with at least one thermoplastic and at least one embrittling agent,
b) Mixing and melting the mixture from step a) to form a biocide-composite,
c) Cooling said biocide-composite from step b) to form a solid biocide-composite, and
d) Optionally comminution of said solid biocide-composite to obtain said biocide-composite in particulate form,
   wherein said insecticide is independently selected from the group comprising a neonicotinoid, a pyrethroid, a phenylpyrazole, an avermectin, a chitin synthesis inhibitor, an uncoupler of oxidative phosphorylation, an insect growth regulators, or a combination thereof
   wherein said thermoplastic is independently selected from a group consisting of a styrene acrylonitrile copolymer, a polystyrene, a cellulose ether, a polylactic acid, a polyvinyl chloride, a polymethylmethacrylate or a combination thereof,
   wherein said embrittling agent is independently selected from the group consisting of organoclay, talc or a combination thereof, and
   wherein said biocide-composite comprises from about 8 to about 25 wt. % biocide, from about 45 wt. % to about 80 wt. % thermoplastic, and from about 5 wt. % to about 40 wt. % embrittling agent, based on the combined weight of the biocide, the thermoplastic and the embrittling agent.

In one embodiment the present invention provides a biocide-composite obtainable by a process comprising the following steps
a) Contacting at least one insecticide with at least one thermoplastic and at least one embrittling agent,
b) Mixing and melting the mixture from step a) to form a biocide-composite,
c) Cooling said biocide-composite from step b) to form a solid biocide-composite, and
d) Optionally comminution of said solid biocide-composite to obtain said biocide-composite in particulate form,
   wherein said insecticide is independently selected from the group consisting of imidacloprid, bifenthrin, fipronil, etofenprox, permethrin, buprofezin, emamectin benzoate, or a combination thereof,
   wherein said thermoplastic is independently selected from the group consisting of a styrene acrylonitrile copolymer, a polystyrene, a cellulose ether, a polylactic acid, a polyvinyl chloride, a polymethylmethacrylate or a combination thereof, and
   wherein said embrittling agent is independently selected from the group consisting of organoclay, talc or a combination thereof.

In one embodiment the present invention provides a biocide-composite obtainable by a process comprising the following steps
a) Contacting at least one insecticide with at least one thermoplastic and at least one embrittling agent,
b) Mixing and melting the mixture from step a) to form a biocide-composite,
c) Cooling said biocide-composite from step b) to form a solid biocide-composite, and
d) Optionally comminution of said solid biocide-composite to obtain said biocide-composite in particulate form,
   wherein said insecticide is independently selected from the group consisting of imidacloprid, bifenthrin, fipronil, etofenprox, permethrin, buprofezin, emamectin benzoate, or a combination thereof,
   wherein said thermoplastic is independently selected from the group consisting of a styrene acrylonitrile copolymer, a polystyrene, a cellulose ether, a polylactic acid, a polyvinyl chloride, a polymethylmethacrylate or a combination thereof,
   wherein said embrittling agent is independently selected from the group consisting of organoclay, talc or a combination thereof, and
   wherein said biocide-composite comprises from about 6 to about 40 wt. % biocide (insecticide), from about 45 wt. % to about 60 wt. % thermoplastic, and from about 5 wt. % to about 40 wt. % embrittling agent, based on the combined weight of the biocide, the thermoplastic and the embrittling agent.

In one embodiment the present invention provides a biocide-composite obtainable by a process comprising the following steps
a) Contacting at least one insecticide with at least one thermoplastic and at least one embrittling agent,
b) Mixing and melting the mixture from step a) to form a biocide-composite,
c) Cooling said biocide-composite from step b) to form a solid biocide-composite, and
d) Optionally comminution of said solid biocide-composite to obtain said biocide-composite in particulate form,
   wherein said insecticide is independently selected from the group consisting of imidacloprid, bifenthrin, fipronil, etofenprox, permethrin, buprofezin, emamectin benzoate, or a combination thereof,
   wherein said thermoplastic is independently selected from the group consisting of a styrene acrylonitrile copolymer, a polystyrene, a cellulose ether, a polylactic acid, a polyvinyl chloride, a polymethylmethacrylate or a combination thereof,
   wherein said embrittling agent is independently selected from the group consisting of organoclay, talc or a combination thereof, and
   wherein said biocide-composite comprises from about 1 to about 90 wt. % biocide (insecticide), from about 25 wt. % to about 95 wt. % thermoplastic, and from about 2 wt. % to about 75 wt. % embrittling agent, based on the combined weight of the biocide, the thermoplastic and the embrittling agent.

In one embodiment the present invention provides a biocide-composite obtainable by a process comprising the following steps
a) Contacting at least one insecticide with at least one thermoplastic and at least one embrittling agent,
b) Mixing and melting the mixture from step a) to form a biocide-composite,
c) Cooling said biocide-composite from step b) to form a solid biocide-composite, and
d) Optionally comminution of said solid biocide-composite to obtain said biocide-composite in particulate form,
   wherein said insecticide is independently selected from the group consisting of imidacloprid, bifenthrin, fipronil, etofenprox, permethrin, buprofezin, emamectin benzoate, or a combination thereof,
   wherein said thermoplastic is independently selected from the group consisting of a styrene acrylonitrile copolymer, a polystyrene, a cellulose ether, a polylactic acid, a polyvinyl chloride, a polymethylmethacrylate or a combination thereof,
   wherein said embrittling agent is independently selected from the group consisting of organoclay, talc or a combination thereof, and
   wherein said biocide-composite comprises from about 8 to about 25 wt. % biocide (insecticide), from about 45 wt. % to about 80 wt. % thermoplastic, and from about 5 wt. % to about 40 wt. % embrittling agent, based on the combined weight of the biocide, the thermoplastic and the embrittling agent.

In one embodiment the present invention provides a biocide-composite obtainable by a process comprising the following steps
a) Contacting at least one insecticide with at least one thermoplastic and at least one embrittling agent,
b) Mixing and melting the mixture from step a) to form a biocide-composite,
c) Cooling said biocide-composite from step b) to form a solid biocide-composite, and
d) Optionally comminution of said solid biocide-composite to obtain said biocide-composite in particulate form,
   wherein said insecticide is imidacloprid,
   wherein said thermoplastic is a styrene acrylonitrile copolymer, and
   wherein said embrittling agent is an organoclay.

In one embodiment the present invention provides a biocide-composite obtainable by a process comprising the following steps
a) Contacting at least one insecticide with at least one thermoplastic and at least one embrittling agent,
b) Mixing and melting the mixture from step a) to form a biocide-composite,
c) Cooling said biocide-composite from step b) to form a solid biocide-composite, and
d) Optionally comminution of said solid biocide-composite to obtain said biocide-composite in particulate form,
   wherein said insecticide is imidacloprid,
   wherein said thermoplastic is a styrene acrylonitrile copolymer, and
   wherein said embrittling agent is an organoclay,
   wherein said biocide-composite comprises from about 6 to about 40 wt. % imidacloprid, from about 45 wt. % to about 60 wt. % styrene acrylonitrile copolymer, and from about 5 wt. % to about 40 wt. % organoclay, based on the combined weight of the biocide, the thermoplastic and the embrittling agent.

In one embodiment the present invention provides a biocide-composite obtainable by a process comprising the following steps
a) Contacting at least one insecticide with at least one thermoplastic and at least one embrittling agent,
b) Mixing and melting the mixture from step a) to form a biocide-composite,
c) Cooling said biocide-composite from step b) to form a solid biocide-composite, and
d) Optionally comminution of said solid biocide-composite to obtain said biocide-composite in particulate form,
   wherein said insecticide is imidacloprid,
   wherein said thermoplastic is a styrene acrylonitrile copolymer, and
   wherein said embrittling agent is an organoclay,
   wherein said biocide-composite comprises from about 1 to about 90 wt. % imidacloprid, from about 25 wt. % to about 95 wt. % styrene acrylonitrile copolymer, and from about 2 wt. % to about 75 wt. % organoclay, based on the combined weight of the biocide, the thermoplastic and the embrittling agent.

In one embodiment the present invention provides a biocide-composite obtainable by a process comprising the following steps
a) Contacting at least one insecticide with at least one thermoplastic and at least one embrittling agent,
b) Mixing and melting the mixture from step a) to form a biocide-composite,
c) Cooling said biocide-composite from step b) to form a solid biocide-composite, and
d) Optionally comminution of said solid biocide-composite to obtain said biocide-composite in particulate form,
   wherein said insecticide is imidacloprid,
   wherein said thermoplastic is a styrene acrylonitrile copolymer, and
   wherein said embrittling agent is an organoclay,
   wherein said biocide-composite comprises from about 8 to about 25 wt. % imidacloprid, from about 45 wt. % to about 80 wt. % styrene acrylonitrile copolymer, and from about 5 wt. % to about 40 wt. % organoclay, based on the combined weight of the biocide, the thermoplastic and the embrittling agent.

In another aspect, the present invention provides a formulation comprising the biocide-composite according to the present invention, wherein said formulation is a solid formulation selected from a powder and granules, or a liquid formulation selected from a suspension and a dispersion, preferably an aqueous suspension or dispersion.

In another aspect, the present invention provides a glue for glueline treatment of glued-wood products comprising the biocide-composite or the formulation according to the present invention.

In one embodiment, the glue can be independently selected from the group consisting of phenolic resins including phenol-formaldehyde resins, resorcinol-formaldehyde resins and phenol-resorcinol-formaldehyde resins, amino resins including hydroxymethyl or alkoxymethyl derivatives of urea, melamine, benzoguanamine, glycoluril, urea-formaldehyde, melamine-formaldehyde, melamine-urea formaldehyde resins, isocyanate resins including pMDI, thermoset epoxy and polyurethane resins, PVAs, and adhesives based on biomaterials including proteins, starches and lignocellulosic extractives including lignins.

In one embodiment the glue can be independently selected from the group consisting of phenol-formaldehyde resins, resorcinol-formaldehyde resins, phenol-resorcinol-formaldehyde resins or combinations thereof.

In another aspect, the present invention provides a process for preparing a biocide-composite according to the present invention comprising the steps of
a) Contacting at least one biocide with at least one non-biocide solid,
b) Mixing and melting the mixture from step a) to form the biocide-composite
c) Cooling said biocide-composite obtained in step b) to form a solid biocide-composite, and
d) Optionally comminution of said solid biocide-composite to obtain said biocide-composite in particulate form.

In another aspect, the present invention provides a process for preparing a biocide-composite according to the present invention comprising the steps of
a) Contacting at least one biocide with at least one non-biocide solid,
b) Hot melt extrusion of the mixture from step a) to form the biocide-composite
c) Cooling said biocide-composite obtained in step b) to form a solid biocide-composite, and
d) Optionally comminution of said solid biocide-composite to obtain said biocide-composite in particulate form.

In one embodiment, the at least one non-biocide solid is a thermoplastic, and wherein in step a) said at least one biocide and/or said thermoplastic are present in the form of a melt. In another embodiment in step a) said at least one thermoplastic is present in the form of a melt, and said at least one biocide is present in the form of a powder.

In one embodiment, the at least one non-biocide solid is an embrittling agent, and wherein in step a) said at least one biocide is present in the form of a melt, and said embrittling agent has a Dv90 of about 100 μm or less

In one embodiment, the at least one non-biocide solid is a thermoplastic and an embrittling agent, and wherein in step a) said at least one biocide and said thermoplastic are present in the form of a melt and said embrittling agent has a Dv90 of about 100 μm or less, or wherein in step a) said thermoplastic is present in the form of a melt, and said at least one biocide and said embrittling agent are present in the form of a powder, wherein said embrittling agent has a Dv90 of about 100 μm or less

In another aspect, the present invention provides a biocide-composite according to the present invention, comprising the steps of
a) Dissolving said at least one biocide and said at least one non-biocide solid in a non-aqueous solvent, wherein said at least one non-biocide solid is a thermoplastic,
b) Optionally adding an embrittling agent, and
c) Removing said non-aqueous solvent to obtain said biocide-composite in the form of a solid, and
d) Optionally comminution of said solid biocide-composite to obtain said biocide-composite in particulate form.

In another aspect, the present invention provides a biocide-composite according to the present invention, comprising the steps of
a) Dissolving said at least one biocide in a non-aqueous solvent,
b) Mixing said solution with said at least one non-biocide solid, which is an embrittling agent, and
c) Removing the said non-aqueous solvent to obtain said biocide-composite in the form of a solid, and
d) Optionally comminution of said solid biocide-composite to obtain said biocide-composite in particulate form.

In another aspect, the present invention provides a biocide-composite for increasing the retention of at least one biocide in a glueline-treated glued-wood product that has been hot pressed or hot-pressed and block-stacked during manufacture, comprising applying a biocide-composite according to the present invention.

In another aspect, the present invention provides a method for increasing the retention of at least one biocide in a glueline-treated glued-wood product that has been hot pressed or hot-pressed and block-stacked during manufacture, comprising applying a biocide-composite according to the present invention.

In another aspect, the present invention provides the use of an embrittling agent as defined herein for increasing the friability of a biocide-composite comprising at least one biocide and a water-insoluble thermoplastic having a glass transition temperature (Tg) of 45° C. or more, or a Vicat softening temperature (VST) of 45° C. or more.

In another aspect, the present invention provides the use of a biocide-composite according to the present invention for increasing the retention of at least one biocide in a glueline-treated glued-wood product that has been hot-pressed or hot-pressed and block-stacked during manufacture.

In another aspect, the present invention provides a method for producing a glueline-treated glued-wood product comprising applying a biocide-composite according to the present invention during glueline treatment.

In one embodiment, the biocide-composite according to the present invention is blended directly into the glue, or wherein said biocide-composite is applied indirectly to the glue by application to the wood component prior to, at the same time as, or after introduction of the glue during manufacture of the glued-wood product.

In another aspect, the present invention provides a glueline-treated glued-wood product comprising a biocide-composite according to the present invention.

In one embodiment, the glued-wood product referred to herein is selected from engineered wood products, including glued veneer products such as plywood and LVL, and products comprising glued-wood flakes, chips, strands, particles, fibres, flour, dusts and nanofibrils, such as flakeboard, chipboard, strandboard, OSB, parallel strand lumber, particleboard, MDF, high density fibreboard and hardboard.

In one embodiment the glued-wood product is independently selected from the group consisting of plywood, LVL, flakeboard, chipboard, strandboard, OSB, parallel strand lumber, particleboard, MDF, high density fibreboard, hardboard, or any combination thereof.

In one embodiment, the glued-wood product is selected from plywood and LVL.

In another aspect, the present invention provides a glueline-treated glued-wood product manufactured according to the method according to the present invention.

### BRIEF DESCRIPTION OF THE DRAWINGS

FIG. 1 shows Thermogravimetric Analysis (TGA) thermograms of imidacloprid, cyproconazole, bifenthrin and triadimefon.

FIG. 2 illustrates the effect of composite sieve fraction on imidacloprid retentions in glueline-treated plywood after hot pressing (hot pressed) and after hot pressing and simulated block stacking

FIG. 3 shows imidacloprid retentions in glueline-treated plywood after hot pressing and simulated block stacking

FIG. 4 Diagram demonstrating retention analysis sampling points from block-stacked LVL.

FIG. 5 illustrates imidacloprid retentions in LVL sampled after hot pressing and after block stack cooling for four days in a typical commercial block stack.

FIG. 6 illustrates bifenthrin retentions in glueline-treated plywood after hot pressing and simulated block stacking

FIG. 7 illustrates a TGA thermogram of Tixogel MP 100.

FIG. 8 illustrates the effect of Tixogel 1VIP 100 content on composite particle size distribution after milling.

FIG. 9 illustrates imidacloprid retentions in plywood glueline-treated with friable biocide-composites containing varying proportions of styrene acrylonitrile and Tixogel MP 100 after hot pressing and simulated block stacking 100° C. for 72 hours.

FIG. 10 illustrates retentions of bifenthrin and cyproconazole in plywood glueline-treated with solidified biocide-composites containing Tixogel after hot pressing and simulated block stacking at 100° C. for 72 hours.

FIG. 11 illustrates bifenthrin and etofenprox retentions in plywood glueline-treated with friable biocide-composites of bifenthrin and etofenprox after hot pressing and simulated block stacking (100° C. for 72 h).

FIG. 12 illustrates fipronil and trifloxystrobin retentions in plywood glueline-treated with friable biocide-composites of fipronil and trifloxystrobin after hot pressing and after hot-pressing and simulated block stacking (100° C. for 72 h)

FIG. 13 illustrated pyraclostrobin, buprofezin and emamectin benzoate retentions in plywood glueline-treated with friable biocide-composites of pyraclostrobin, buprofezin and emamectin benzoate after hot pressing and after hot pressing and simulated block stacking (100° C. for 72 h).

### DEFINITIONS

As used herein, the terms “about,” “approximately,” or “generally,” when used to modify a value, indicates that the value can be raised or lowered by 10% and remains within the disclosed embodiment.

The term “retention” as used in this disclosure refers to the concentration of biocide active ingredient extracted from the finished glued-wood product and measured by an analytical procedure. Terms such as “active ingredient retention”, “preservative retention”, “insecticide retention” or “fungicide retention” are often used in the art. Retentions are typically expressed as grams of active ingredient per cubic metre of dried wood product (gai/m³) or mass of active ingredient/mass of dried wood product (% m/m). When a glued-wood product is treated with two or more active ingredients, e.g. one or two fungicidal ingredients and an insecticide, the retention of each ingredient is measured. When comparing different biocide formulations, it is also convenient to express biocide retentions as a percentage of the nominal biocide loading or application rate and use the term “recovery”, i.e. how much of the dose applied was recovered at the completion of manufacture.

The term “biocide” as used herein refers to a compound that renders the material to which it is applied resistant to insect, fungal and microbial attack than the same material without having the compound applied. The term “biocide”, “active ingredient” and “preservative” are used interchangeably.

As used herein, the term “friable” refers to the tendency for the biocide-composite the present invention to disintegrate, break, rupture or crumble during processing, milling or handling.

The term “glued-wood product” as used herein refers to glued-wood products whose production includes at least a glue addition step, a hot pressing step and, optionally, a block stacking step. Glued-wood products include glued veneer products (sometimes called engineered wood products) such as plywood and LVL, products comprising glued-wood flakes, chips, strands, particles, fibres, flour, dusts or nanofibrils (sometimes called reconstituted wood-based products) such as flake boards, chip boards, strand boards, oriented strand boards (OSB), parallel strand lumber, particle board, medium density fibreboard (MDF), high density fibreboard, hard board, etc., and products containing combinations of different layers such as glued strands and glued fibres within the one product. Glued lignocellulosic products based on bamboo, rattan, bagasse, straw, hemp, jute sticks, flax shives and the like are also included within the definition of glued-wood product.

The term “glue” as used herein refers to the non-wood component of the glued-wood product that adheres or bonds the wood components to produce a mechanically stable finished product. The term “glue” and “adhesive” are used interchangeably. The term glue includes “native resins” such as isocyanate resins like polymeric diphenylmethane diisocyanate (pMDI), which can be used as is. Generally, native resins are not single chemicals but rather a plurality of chemicals or different polymeric forms resulting from the syntheses in commercial use. Apart from isocyanates, most native resins can be used in combination with water, wetting agents, fillers, catalysts, etc., and such mixtures are referred to as a “glue”, “glue mixture” or a “glue mix” in the art and throughout this disclosure. Notwithstanding this distinction, the term “glue” encompasses all forms of adhesive used in the manufacture of hot-pressed or hot-pressed and block-stacked glued-wood products.

The term “glueline treatment” as used herein refers to the delivery of the biocide to a glued-wood product via the glueline, either by direct addition whereby the biocide is added to the glue component before it meets the wood component, or by indirect addition whereby the biocide is added to the wood component before, during or after the wood meets the glue. Glueline treatment is distinct from pressure treatment of wood components before manufacture or pressure treatment of a glued-wood product after manufacture.

The term “hot pressing” as used herein refers to the application of heat and mechanical pressure to compress the assembled constituents of a glued wood products into its final form and to cure or set the glue. The equipment used is called a hot press. The term “hot pressed” and “hot-pressing” are used interchangeably.

The term “block-stacked” as used herein refers to a common process applied in the manufacturing of glued-wood products. The glued-wood products are stacked post-press to retain heat to allow further glue polymerisation and promote slow cooling to obtain stable flat boards that won't bow or twist post manufacture. The term “block stacked” and “block-stacking” are used interchangeably.

The terms “hot pressed and block-stacked” and “simulated block stacking” are used interchangeably.

The term “water-insoluble” as used herein means that the solubility in water at ambient temperature does not exceed 5% by weight, preferably 2% by weight, more preferably 1% by weight of the ingredient in question. Excluded are ingredients capable of forming a colloidal suspension in water at any temperatures between ambient and 100° C.

The terms “melt”, “melting” or “melted” are used herein in reference to a reduction in the viscosity of a biocide and/or a thermoplastic by application of sufficient heat and/or shear force and/or compression to enable intimate mixing. For example, many thermoplastics display shear thinning, i.e. a reduction in viscosity with increasing applied shear force, with the result that the ingredients, once “melted”, may be mixed at temperatures below the glass transition temperatures (Tg) or Vicat softening temperature (VST) of the thermoplastic.

The term “melt” should not be confused with “melting point”, abbreviated M.p. and used herein in reference to the melting temperature of the biocide. M.p. values are taken from The Pesticide Manual (17th Edition, British Crop Protection Council).

The term “glass transition temperature” (Tg) as used herein is applied to the thermoplastic of the composition and refers to the temperature (range) over which the thermoplastic undergoes a glass transition, i.e. a transition from hard and brittle to soft and deformable. Tg may be determined by means of differential scanning calorimetry (DSC), preferably at a heating rate of 10 K/min, wherein Tg is the mid-point temperature in the glass transition. The glass transition temperatures (Tg) referred to herein can be determined according to ISO 11357-2:2020.

The term “Vicat softening temperature” as used herein refers is the determination of the softening point for materials that have no definite melting point, such as plastics. VST is an engineering term and is generally determined as the temperature at which a flat-ended needle of 1 mm² circular cross-section will penetrate a thermoplastic specimen to a depth of 1 mm under a given load (e.g. 10 or 50 N) when the plastic is subjected to heating at a specified rate (e.g. 50 or 120° C./h). The VST values referred to herein can be determined according to ISO 306:2013. The term “Vicat softening temperature” and “Vicat softening point” are used interchangebably.

The term “mixing” as used herein refers to intimate mixing of a biocide, thermoplastic and/or embrittling agent, which leads to the formation of a composite; it can be achieved, e.g., by “hot melt mixing” after melting of one or more ingredients, or by “solvent precipitation” or “solvent casting” after dissolving of one or more ingredients in a separate organic solvent. Hence, the term “mixing” is different from the terms “blending” and “mingling”, which are used herein to refer to other means of combining and intermingling ingredients, generally in dry form, but that do not result in the formation of a composite.

The term “composite” as used herein refers to a material formed from two or more constituent materials (individual ingredients) after “hot melt mixing” or “solvent precipitation” or “solvent casting”, in case of this invention i.e. a biocide and a thermoplastic, a biocide and a thermoplastic and an embrittling agent (“friable biocide-composite”), or a biocide and an embrittling agent (“solidified biocide-composite”). Within the finished composite, the individual ingredients are associated together in a unified form.

The term “solid biocide-composite” as used herein refers to the state of matter of the biocide-composite.

The term “particle” as used herein refers to discrete sub-portion of a biocide-composite or an ingredient thereof when present in a solid physical state. The terms “particle” or “particles” and “particulate form” are used interchangeably.

The particle size “Dv90” as used herein refers to the maximum particle diameter below which 90% of the sample volume exists. Similarly, the particle size “Dv10” as used herein refers to the maximum particle diameter below which 10% of the sample volume exists. Other equivalent values can be used, e.g. Dv50 referring to 50% of the sample volume.

Methods of determining the particle size are commonly known. An introduction to particle size measurements and the abovementioned values is provided in the technical document “A basic guide to particle characterisation”, published by Malvern Instruments Limited in 2015, and incorporated herein.

### DETAILED DESCRIPTION OF THE INVENTION

Biocide-Composite (Biocide+Thermoplastic and/or Embrittling Agent)

The present invention provides a biocide-composite comprising a) at least one biocide and b) at least one non-biocidal solid independently selected from the group consisting of a thermoplastic, an embrittling agent, or combinations thereof.

Surprisingly, the inventors have found that the biocide-composites of the invention are able to achieve very high biocide retentions in a glueline-treated glued-wood product after hot-pressing or hot-pressing and block-stacking. In particular, the biocide retention is significantly increased compared to conventional wood protectant compositions comprising one or more biocide alone. Moreover, the biocide-composites of the invention allow that the biocide application rates and/or loadings may be reduced and/or more consistent biocide retentions may be obtained in the different regions of hot-pressed or hot-pressed and block-stacked glued-wood products.

In one embodiment, the biocide-composite according to the present invention comprises from about 1 to about 98 wt. % biocide, or from about 1 to about 90 wt. % biocide, or from about 2 to about 80 wt. % biocide, or from about 3 to about 75 wt. % biocide, or from about 4 to about 60 wt. % biocide, or from about 5 to about 50 wt. % biocide, or from about 6 to about 40 wt. % biocide, or from about 7 to about 30 wt. % biocide, or from about 8 to about 25 wt. % biocide; from about 1 wt. % to about 98 wt. % thermoplastic, or from about 25 wt. % to about 95 wt. % thermoplastic, or from about 30 wt. % to about 90 wt. % thermoplastic, or from about 40 wt. % to about 89 wt. % thermoplastic, or from about 45 wt. % to about 85 wt. % thermoplastic, or from about 45 wt. % to about 80 wt. % thermoplastic, or from about 45 wt. % to about 70 wt. % thermoplastic, or from about 45 wt. % to about 60 wt. % thermoplastic, and from about 1 wt. % to about 98 wt. % embrittling agent, or from about 2 wt. % to about 75 wt. % embrittling agent, or from about 3 wt. % to about 50 wt. % embrittling agent, or from about 4 wt. % to about 45 wt. % embrittling agent, or from about 5 wt. % to about 40 wt. % embrittling agent, based on the combined weight of the biocide, the thermoplastic and the embrittling agent.

### Biocide

The at least one biocide can be independently selected from group consisting of insecticides, fungicides, or a combination thereof. In one embodiment the at least one biocide is a non-metallic, organic insecticide or fungicide. Suitable insecticides and fungicides are known to the skilled person, such as for example the following.

### Insecticides

The following insecticides grouped by mode of action according to the Insecticide Resistance Action Committee (IRAC) are suitable for the invention.

The insecticides used in the composition of the present invention are known and include but are not limited to, for example GABA-gated chloride channel blockers comprising phenylpyrazoles, sodium channel modulators comprising pyrethroids, nicotinic acetylcholine receptor (nAChR) competitive modulators comprising neonicotinoids, uncouplers of oxidative phosphorylation, inhibitors of chitin synthesis type 0 and type 1, voltage-dependent sodium channel blockers, and ryanodine receptor modulators.

GABA-gated chloride channel blockers comprising phenylpyrazoles (IRAC code 2B) including acetoprole, ethiprole, fipronil, flufiprole, pyrafluprole, pyriprole, vaniliprole.

Sodium channel modulators comprising pyrethroids (IRAC code 3A) including acrinathrin, allethrin, bifenthrin, chloroprallethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, dimefluthrin, esfenvalerate, etofenprox, fenpropathrin, fenvalerate, esfenvalerate, flucythrinate, flumethrin, fluvalinate, tau-fluvalinate, halfenprox, imiprothrin, kadethrin, metofluthrin, permethrin, phenothrin, prallethrin, profluthrin, protrifenbute, pyrethrins I and II, resmethrin, silafluofen, tefluthrin, tetramethrin, tralomethrin, transfluthrin, valerate, and enantiomers thereof.

Nicotinic acetylcholine receptor (nAChR) competitive modulators comprising neonicotinoids (IRAC code 4A) including acetamiprid, clothianidin, dinotefuran, imidacloprid, imidaclothiz, nitenpyram, nithiazine, paichongding, thiacloprid and thiamethoxam; and other (nAChR) competitive modulators (IRAC codes 4A-4E) including nicotine, sulfoxaflor, flupyradifurone and triflumezopyrim.

nAChR Allosteric modulators (IRAC code 5) including spinetoram, spinosad.

Glutamate-gated chloride channel allosteric modulators (IRAC code 6) including abamectin, emamectin benzoate, lepimectin and milbemectin, collectively known as avermectins.

Juvenile hormone mimics (IRAC code 7) including hydroprene, kinoprene, methoprene, fenoxycarb and pyriproxyfen.

Chordotonal organ TRPV channel modulators (IRAC code 9B) including pymetrozine and pyrifluquinazon and (IRAC code 9D) including afidopyropen.

Mite growth inhibitors (IRAC code 10) including clofentezine, diflovidazin, hexythiazox and etoxazole.

Inhibitors of mitochondrial ATP synthase (IRAC code 12) including diafenthiuron, azocyclotin, cyhexatin, fenbutatin oxide, propargite, and tetradifon.

Uncouplers of oxidative phosphorylation (IRAC code 13) including chlorfenapyr, DNOC and sulfluramid.

nAChR Channel blockers (IRAC code 14) including bensultap, cartap hydrochloride, thiocyclam and thiosultap-sodium.

Inhibitors of chitin biosynthesis, type 0 (IRAC code 15) including bistrifluron, chlorfluazuron, diflubenzuron, flucycloxuron, flufenoxuron, hexaflumuron, lufenuron, novaluron, noviflumuron, teflubenzuron, and triflumuron; and type 1 (IRAC code 16) including buprofezin.

Moulting disruptors (IRAC code 17) including cyromazine.

Ecdysone receptor agonists (IRAC code 18) including chromafenozide, halofenozide, methoxyfenozide and tebufenozide.

IRAC classes 15-18 are known collectively as insect growth regulators.

Octopamine receptor agonists (IRAC code 19) including amitraz.

Mitochondrial complex III electron transport inhibitors (IRAC code 20) including hydramethylnon, acequinocyl, fluacrypyrim and bifenazate.

Mitochondrial complex I electron transport inhibitors (IRAC code 21) including fenazaquin, fenpyroximate, pyridaben, pyrimidifen, tebufenpyrad, tolfenpyrad and rotenone.

Voltage-dependent sodium channel blockers (IRAC code 22) including indoxacarb and metaflumizone.

Inhibitors of acetyl CoA carboxylase (IRAC code 23) including spirodiclofen, spiromesifen, spiropidion and spirotetramat.

Mitochondrial complex II electron transport inhibitors (IRAC code 24) including cyenopyrafen, cyflumetofen and pyflubumide.

Ryanodine receptor modulators (IRAC code 28) including chlorantraniliprole, cyantraniliprole, cyclaniliprole, flubendiamide and tetraniliprole.

Chordotonal organ modulators (IRAC code 29) including flonicamid.

GABA-gated chloride channel allosteric modulators (IRAC code 30) including broflanilide, fluxametamide and isocycloseram.

Also included are insecticides of unknown or uncertain mode of action including acynonapyr, benzpyrimoxan, cyhalodiamide, dimpropyridaz, oxazosulfyl and pyridalyl.

In one embodiment, the insecticide can be independently selected from the group consisting of GABA-gated chloride channel blockers, pyrethroids, neonicotinoids, uncouplers of oxidative phosphorylation, inhibitors of chitin synthesis type 0 and 1, voltage-dependent sodium channel blockers, ryanodine receptor modulators, or combinations thereof.

In one embodiment, the at least one biocide may comprise a GABA-gated chloride channel blocker comprising a phenylpyrazole.

The phenylpyrazole compounds used in the composition of the present invention are known and include but are not limited to, for example acetoprole, ethiprole (5-amino-1-[2,6-dichloro-4-(trifluoromethyl)phenyl]-4-(ethylsulfinyl)-1H-pyrazole-3-carbonitrile), fipronil (5-amino-1-[2,6-dichloro-4-(trifluoromethyl)phenyl]-4-[(trifluoromethyl)sulfinyl]-1H-pyrazole-3-carbonitrile), flufiprole, pyrafluprole, pyriprole, and vaniliprole.

In one embodiment, the phenylpyrazole can be independently selected from the group consisting of ethiprole and fipronil, or combinations thereof.

In one embodiment, the phenylpyrazole can be selected from fipronil.

In one embodiment, the at least one biocide may comprise a sodium channel modulators comprising a pyrethroid.

The pyrethroid compounds used in the composition of the present invention are known and include but are not limited to, for example acrinathrin, allethrin, bifenthrin ((2-methyl[1,1¹-biphenyl]-3-yl)methyl (1R,3R)-rel-3-[(1Z)-2-chloro-3,3,3-trifluoro-1-propen-1-yl]-2,2-dimethylcyclopropanecarboxylate), chloroprallethrin, cycloprothrin, cyfluthrin, beta-cyfluthrin, cyhalothrin, lambda-cyhalothrin, gamma-cyhalothrin, cypermethrin (cyano(3-phenoxyphenyl)methyl 3-(2,2-dichloroethenyl)-2,2-dimethylcyclopropanecarboxylate), alpha-cypermethrin, beta-cypermethrin, theta-cypermethrin, zeta-cypermethrin, cyphenothrin, deltamethrin ((S)-cyano(3-phenoxyphenyl)methyl (1R,3R)-3-(2,2-dibromoethenyl)-2,2-dimethylcyclopropanecarboxylate), dimefluthrin, esfenvalerate, etofenprox ((1-[[2-(4-ethoxyphenyl)-2-methylpropoxy]methyl]-3-phenoxybenzene), fenpropathrin, fenvalerate, esfenvalerate, flucythrinate, flumethrin, fluvalinate, tau-fluvalinate, halfenprox, imiprothrin, kadethrin, metofluthrin, permethrin ((3-phenoxyphenyl)methyl 3-(2,2-dichloroethenyl)-2,2-dimethylcyclopropanecarboxylate), phenothrin, prallethrin, profluthrin, protrifenbute, pyrethrins I and II, resmethrin, silafluofen, tefluthrin, tetramethrin, tralomethrin, transfluthrin, valerate, and enantiomers thereof.

In one embodiment, the pyrethroid compound can be independently selected from the group consisting of bifenthrin, cypermethrin, deltamethrin, etofenprox and permethrin, or a mixture thereof.

In one embodiment, the pyrethroid compound can be independently selected from the group consisting of bifenthrin, etofenprox and permethrin, or a mixture thereof.

In one embodiment, the pyrethroid compound may be etofenprox.

In one embodiment, the pyrethroid compound may be bifenthrin.

In one embodiment, the pyrethroid compound may be permethrin.

In one embodiment, the at least one biocide may comprise a nicotinic acetylcholine receptor (nAChR) competitive modulator comprising a neonicotinoid.

The neonicotinoid compounds used in the composition of the present invention are known and include but are not limited to, for example acetamiprid ((1E)-N-[(6-chloro-3-pyridinyl)methyl]-N′-cyano-N-methylethanimidamide), clothianidin ((E)-1-[(2-chlorothiazol-5-yl)methyl]-3-methyl-2-nitroguanidine), dinotefuran (N-methyl-N′-nitro-N″-[(tetrahydro-3-furanyl)methyl]guanidine), imidacloprid ((2E)-1-[(6-chloro-3-pyridinyl)methyl]-N-nitro-2-imidazolidinimin), imidaclothiz, nitenpyram, nithiazine, paichongding, thiacloprid ((Z)-[3-[(6-chloro-3-pyridinyl)methyl]-2-thiazolidinylidene]cyanamide) and thiamethoxam (3-[(2-chloro-5-thiazolyl)methyl]tetrahydro-5-methyl-N-nitro-4H-1,3,5-oxadiazin-4-imine).

In one embodiment, the neonicotinoid compound can be independently selected from the group consisting of acetamiprid, clothianidin, dinotefuran, imidacloprid, thiacloprid and thiamethoxam, or a mixture thereof.

In one embodiment, the neonicotinoid compound can be independently selected from the group consisting of dinotefuran, imidacloprid and thiacloprid, or a mixture thereof.

In one embodiment, the neonicotinoid compound may be acetamiprid.

In one embodiment, the neonicotinoid compound may be clothianidin.

In one embodiment, the neonicotinoid compound may be thiamethoxam.

In one embodiment, the neonicotinoid compound may be dinotefuran.

In one embodiment, the neonicotinoid compound may be thiacloprid.

In one embodiment, the neonicotinoid compound may be imidacloprid.

In one embodiment, the at least one insecticide may comprise an uncoupler of oxidative phosphorylation.

The uncouplers of oxidative phosphorylation used in the composition of the present invention are known and include but are not limited to, for example chlorfenapyr (4-bromo-2-(4-chlorophenyl)-1-(ethoxymethyl)-5-(trifluoromethyl)-1H-pyrrole-3-carbonitrile), DNOC and sulfluramid.

In one embodiment, the uncouplers of oxidative phosphorylation can be independently selected from the group consisting of chlorfenapyr, DNOC and sulfluramid, or a mixture thereof.

In one embodiment, the uncoupler of oxidative phosphorylation can be chlorfenapyr.

In one embodiment, the at least one insecticide may comprise an inhibitors of chitin synthesis type 0 and type 1.

The chitin synthesis inhibitors used in the composition of the present invention are known and include but are not limited to, for example bistrifluron, chlorfluazuron (N-[[[3,5-dichloro-4-[[3-chloro-5-(trifluoromethyl)-2-pyridinyl]oxy]phenyl]amino]carbonyl]-2,6-difluorobenzamide), diflubenzuron, flucycloxuron, flufenoxuron, hexaflumuron (N-[[[3,5-dichloro-4-(1,1,2,2-tetrafluoroethoxy)phenyl]amino]carbonyl]-2,6-difluorobenzamide), lufenuron, novaluron, noviflumuron, teflubenzuron, triflumuron; and buprofezin ((Z)-2-[(1,1-dimethylethyl)imino]tetrahydro-3-(1-methylethyl)-5-phenyl-4H-1,3,5-thiadiazin-4-one).

In one embodiment, the chitin synthesis inhibitors can be independently selected from the group consisting of chlorfluazuron, hexaflumuron and buprofezin, or a mixture thereof.

In one embodiment, the chitin synthesis inhibitors may be chlorfluazuron.

In one embodiment, the chitin synthesis inhibitors may be hexaflumuron.

In one embodiment, the chitin synthesis inhibitors may be buprofezin.

In one embodiment, the at least one insecticide may comprise a voltage-dependent sodium channel blocker.

The voltage-dependent sodium channel blockers used in the composition of the present invention are known and include but are not limited to, for example indoxacarb (methyl (4aS)-7-chloro-2,5-dihydro-24 [(methoxycarbonyl)[4-(trifluoromethoxy)phenyl]amino]carbonyl] indeno[1,2-e][1,3,4]oxadiazine-4a(3H)-carboxylate) and metaflumizone.

In one embodiment, the voltage-dependent sodium channel blocker can be independently selected from the group consisting of indoxacarb and metaflumizone, or mixtures thereof.

In one embodiment, the voltage-dependent sodium channel blocker may be indoxacarb.

In one embodiment, the at least one insecticide may comprise a ryanodine receptor modulator.

The ryanodine receptor modulators used in the composition of the present invention are known and include but are not limited to chlorantraniliprole (3-bromo-N44-chloro-2-methyl-6-[(methylamino)carbonyl]phenyl]-1-(3-chloro-2-pyridinyl)-1H-pyrazole-5-carboxamide), cyantraniliprole (3-bromo-1-(3-chloro-2-pyridinyl)-N-[4-cyano-2-methyl-6-[(methylamino)carbonyl]phenyl]-1H-pyrazole-5-carboxamide), cyclaniliprole, flubendiamide and tetraniliprole.

In one embodiment, the ryanodine receptor modulator can be independently selected from the group consisting of chlorantraniliprole and cyantraniliprole, or mixtures thereof.

In one embodiment, the ryanodine receptor modulator may be chlorantraniliprole.

In one embodiment, the at least one insecticide may comprise an avermectin.

The avermectins used in the composition of the present invention are known and include but are not limited to, for example abamectin, emamectin benzoate, lepimectin and milbemectin.

In one embodiment, avermectins can be independently selected from the group consisting of abamectin, emamectin benzoate, lepimectin and milbemectin, or mixtures thereof.

In one embodiment, the avermectin may be emamectin benzoate.

### Fungicides

The fungicides used in the composition of the present invention are known and include but are not limited to demethylation inhibitor fungicides, quinone outside inhibitor fungicides, amine or morpholine fungicides, and quinone outside inhibitor fungicides.

In one embodiment, the fungicide can be independently selected from the group consisting of demethylation inhibitor fungicides, quinone outside inhibitor fungicides, amine or morpholine fungicides, or combinations thereof.

The demethylation inhibitor fungicides used in the composition of the present invention are known and include but are not limited to, for example clotrimazole, imazalil, oxpoconazole, prochloraz, pefurazoate, triflumizole, triforine, buthiobate, pyrifenox, fenarimol, nuarimol, triarimol, azaconazole, bitertanol, bromuconazole, cyproconazole (α-(4-chlorophenyl)-α-(1-cyclopropylethyl)-1H-1,2,4-triazole-1-ethanol), diclobutrazole, difenoconazole, diniconazole, diniconazole-M, epoxiconazole (rel-1-[[(2R,3 S)-3-(2-chlorophenyl)-2-(4-fluorophenyl)-2-oxiranyl]methyl]-1H-1,2,4-triazole), etaconazole, fenbuconazole, fluquinconazole, flusilazole, flutriafol, (α-butyl-α-(2,4-dichlorophenyl)-1H-1,2,4-triazole-1-ethanol), imibenconazole, ipconazole, ipfentrifluconazole, mefentrifluconazole, metconazole, myclobutanil, penconazole (1-[2-(2,4-dichlorophenyl)pentyl]-1H-1,2,4-triazole), propiconazole (1-[[2-(2,4-dichlorophenyl)-4-propyl-1,3-dioxolan-2-yl]methyl]-1H-1,2,4-triazole), prothioconazole, quinconazole, simeconazole, tebuconazole (α-[2-(4-chlorophenyl)ethyl]-α-(1,1-dimethylethyl)-1H-1,2,4-triazole-1-ethanol), tetraconazole, triadimefon (1-(4-chlorophenoxy)-3,3-dimethyl-1-(1H-1,2,4-triazol-1-yl)-2-butanone) triadimenol (β-(4-chlorophenoxy)-α-(1,1-dimethylethyl)-1H-1,2,4-triazole-1-ethanol), triticonazole and uniconazole.

In one embodiment, the demethylation inhibitor fungicide can be independently selected from the group consisting of cyproconazole, epoxiconazole, penconazole, propiconazole, tebuconazole, triadimefon, triadimenol, or mixtures thereof.

In one embodiment, the demethylation inhibitor fungicide can be independently selected from the group consisting of tebuconazole, propiconazole, or combinations thereof.

In one embodiment, the demethylation inhibitor fungicide may be epoxiconazole.

In one embodiment, the demethylation inhibitor fungicide may be triadimenol.

In one embodiment, the demethylation inhibitor fungicide may be propiconazole.

In one embodiment, the demethylation inhibitor fungicide may be tebuconazole.

In one embodiment, the demethylation inhibitor fungicide may be cyproconazole.

In one embodiment, the demethylation inhibitor fungicide may be triadimefon.

In one embodiment, the demethylation inhibitor fungicide may be penconazole.

The quinone outside inhibitor fungicides used in the composition of the present invention are known and include but are not limited to pyribencarb, fluoxastrobin, fenamidone, mandestrobin, azoxystrobin, coumoxystrobin, enoxastrobin, flufenoxystrobin, metyltetraprole picoxystrobin, pyraoxystrobin, pyraclostrobin (methyl N-[2-[[[1-(4-chlorophenyl)-1H-pyrazol-3-yl]oxy]methyl]phenyl]-N-methoxycarbamate), pyrametostrobin, triclopyricarb, famoxadone, dimoxystrobin, fenaminostrobin, metominostrobin, orysastrobin, kresoxim-methyl and trifloxystrobin (methyl (αE)-α-(methoxyimino)-2-[[[[(1E)-1-[3-(trifluoromethyl)phenyl]ethylidene]amino]oxy]methyl]benzeneacetate).

In one embodiment, the quinone outside inhibitor fungicide can be independently selected from the group consisting of pyraclostrobin, trifloxystrobin or combinations thereof.

In one embodiment, the quinone outside inhibitor fungicide may be pyraclostrobin.

In one embodiment, the quinone outside inhibitor fungicide may be trifloxystrobin.

The amine or morpholine fungicides used in the composition of the present invention are known and include but are not limited to aldimorph, dodemorph, fenpropimorph (2R,6S)-rel-4-[3-[4-(1,1-dimethylethyl)phenyl]-2-methylpropyl]-2,6-dimethylmorpholine), tridemorph, trimorphamide, fenpropidin, piperalin and spiroxamine.

In one embodiment, the amine or morpholine fungicide may be fenpropimorph.

The following fungicides grouped by mode of action according to the Fungicide Resistance Action Committee (FRAC) are suitable for the invention.

Methyl benzimidazole carbamate fungicides (FRAC code 1) including benomyl, carbendazim, fuberidazole, thiabendazole, thiophanate and thiophanate-methyl.

Dicarboximide fungicides (FRAC code 2) including chlozolinate, dimetachlone, iprodione, procymidone and vinclozolin.

Demethylation inhibitor fungicides (FRAC code 3) including clotrimazole, imazalil, oxpoconazole, prochloraz, pefurazoate, triflumizole, triforine, buthiobate, pyrifenox, fenarimol, nuarimol, triarimol, azaconazole, bitertanol, bromuconazole, cyproconazole, diclobutrazole, difenoconazole, diniconazole, diniconazole-M, epoxiconazole, etaconazole, fenbuconazole, fluquinconazole, flusilazole, flutriafol, hexaconazole, imibenconazole, ipconazole, ipfentrifluconazole, mefentrifluconazole, metconazole, myclobutanil, penconazole, propiconazole, prothioconazole, quinconazole, simeconazole, tebuconazole, tetraconazole, triadimefon, triadimenol, triticonazole and uniconazole.

Phenylamide fungicides (FRAC code 4) including benalaxyl, benalaxyl-M, furalaxyl, metalaxyl, metalaxyl-M, ofurace and oxadixyl.

Amine or morpholine fungicides (FRAC code 5) including aldimorph, dodemorph, fenpropimorph, tridemorph, trimorphamide, fenpropidin, piperalin and spiroxamine.

Phospholipid biosynthesis inhibitors (FRAC code 6) including fenfuram, isoprothiolane, edifenphos, iprobenfos and pyrazophos.

Succinate dehydrogenase inhibitors (FRAC code 7) including fenfuram, pydiflumetofen, carboxin, oxycarboxin, benodanil, flutolanil, mepronil, isofetamid, isoflucypram, benzovindiflupyr, bixafen, fluindapyr, fluxapyroxad, furametpyr, inpyrfluxam, isopyrazam, penflufen, penthiopyrad, sedaxane, boscalid, fluopyram, thifluzamide and pyrazaflumid.

Hydroxy(2-amino-)pyrimidine fungicides (FRAC code 8) including bupirimate, dimethirimol and ethirimol.

Anilinopyrimidine fungicides (FRAC code 9) including cyprodinil, mepanipyrim and pyrimethanil.

N-Phenyl carbamate fungicides (FRAC code 10) including diethofencarb.

Quinone outside inhibitor fungicides (FRAC code 11) including pyribencarb, fluoxastrobin, fenamidone, mandestrobin, azoxystrobin, coumoxystrobin, enoxastrobin, flufenoxystrobin, metyltetraprole picoxystrobin, pyraoxystrobin, pyraclostrobin, pyrametostrobin, triclopyricarb, famoxadone, dimoxystrobin, fenaminostrobin, metominostrobin, orysastrobin, kresoxim-methyl and trifloxystrobin.

Phenylpyrrole fungicides (FRAC code 12) including penpiclonil and fludioxonil.

Aza-naphthalene fungicides (FRAC code 13) including proquinazid and quinoxyfen.

Lipid peroxidation inhibitors (FRAC code 14) including biphenyl, chloroneb, dicloran, quintozene, tecnazene, tolclofos-methyl and etridiazole.

Melanin biosynthesis inhibitors (FRAC codes 16.1, 16.2 and 16.3) including fthalide, pyroquilon, tricyclazole, carpropamid, diclocymet, fenoxanil and tolprocarb.

Hydroxyanilide fungicides (FRAC code 17) including fenpyrazamine and fenhexamid.

Squalene-epoxidase inhibitors (FRAC code 18) including pyributicarb, naftifine and terbinafine.

Polyoxin fungicides (FRAC code 19) including polyoxins.

Phenylurea fungicides (FRAC code 20) including pencycuron.

Quinone inside inhibitor fungicides (FRAC code 21) including cyazofamid, amisulbrom and fenpicoxamid.

Inhibitors of β-tubulin assembly (FRAC code 22) including zoxamide and ethaboxam.

Enopyranuronic acid antibiotic fungicides (FRAC code 23) including blasticidin-S.

Hexopyranosyl antibiotic fungicides (FRAC code 24) including kasugamycin.

Glucopyranosyl antibiotic inhibiting protein synthesis (FRAC code 25) including streptomycin.

Cyanoacetamideoxime fungicides (FRAC code 27) including cymoxanil.

Carbamate fungicides (FRAC code 28) including iodocarb, propamacarb and prothiocarb.

Oxidative phosphorylation uncoupling fungicides (FRAC code 29) including fluazinam, ferimzone, binapacryl, dinocap and meptyldinocap.

Carboxylic acid fungicides (FRAC code 31) including oxolinic acid.

Heteroaromatic fungicides (FRAC code 32) including hymexazole and octylisothiazolinone.

Also included are benzisothiazolinone, butylbenzisothiazolinone, chloroethylisothiazolinone, chloromethyl-isothiazolinone, dichloromethylisothiazolinone, dichlorooctylisothiazolinone, ethylisothiazolinone, methy-lisothiazolinone and methyltrimethyleneisothiazolinone.

Phthalamic acid fungicides (FRAC code 34) including tecloftalam.

Benzotriazine fungicides (FRAC code 35) including triazoxide.

Benzene-sulfonamide fungicides (FRAC code 36) including flusulfamide.

Pyridazinone fungicides (FRAC code 37) including diclomezine.

Thiophene-carboxamide fungicides (FRAC code 38) including silthiofam.

Complex I NADH oxido-reductase inhibitors (FRAC code 39) including tolfenpyrad and diflumetorim.

Carboxylic acid amide fungicides (FRAC code 40) including dimethomorph, flumorph, pyrimorph, mandipropamid, benthiavalicarb, benthiavalicarb-isopropyl, iprovalicarb and valifenalate.

Tetracycline antibiotic fungicides (FRAC code 41) including oxytetracycline.

Thiocarbamate fungicides (FRAC code 42) including methasulfocarb.

Benzamide fungicides (FRAC code 43) including fluopicolide and fluopimomide.

Triazolopyrimidylamine fungicides (FRAC code 45) including ametoctradin.

Cyanoacrylate fungicides (FRAC code 47) including phenamacril.

Phthalimide fungicides (FRAC code M4) including captafol, captan and folpet.

Chloronitrile fungicides (FRAC code M5) including chlorothalonil.

Sulfamide fungicides (FRAC code M6) including dichlofluanid and tolylfluanid

Guanidine fungicides (FRAC code M7) including dodine, guazatine and iminoctadine.

Triazine fungicides (FRAC code M8) including anilazine.

Quinone fungicides (FRAC code M9) including dithianon.

Quinoxaline fungicides (FRAC code M10) including quinomethionate

Also included are fungicides of unknown or uncertain mode of action including aminopyrifen, bethoxazin, cyflufenamid, dichlobentiazox, ferimzone, florylpicoxamid, flutianil, ipflufenoquin, metrafenone, picarbutrazox, dipymetitrone, pyriofenone, pyridachlometyl, quinofumelin, tebufloquin and validamycin.

In one embodiment, the at least one biocide comprises one or more insecticides, or one or more fungicides, or a combination thereof.

### Thermoplastics

In one embodiment, the at least one non-biocidal solid is a thermoplastic.

A wide range of related polymers are suitable for the invention and may be categorised in various ways as known in the art. Copolymers may also be formed from the constituent monomers of the preferred thermoplastic polymers and are also suitable for use in the invention. Table 1 provides non-limiting examples of the major families of water-insoluble thermoplastics suitable for the invention with Tg and VST values for a representative homopolymer from each family (excepting ABS which is a copolymer).

TABLE 1
Representative ingredients for families of
water-insoluble thermoplastic polymers
suitable for the invention.

| | | Vicat |
|---|---|---|
| | | softening |
| | | temperature |
| Thermoplastic polymer | Tg (° C.)* | (° C.)* |
| Acetal (Polyoxymethylene) | 166-189 | 185 |
| Polyamide, e.g. Nylon 12 | 43-54 | |
| Polyacrylonitrile | 70-105 | |
| Polycarbonate (bisphenol A polycarbonate) | 140-150 | 157 |
| Polyetherimide (PEI) | 215 | 219 |
| Polyethersulfone | 220 | 220 |
| Polyethylene (High density, HDPE) | | 124-130 |
| Polyethylene (Low density, LDPE) | | 86-102 |
| Polyethylene terphthalate (PET) | 70-80 | |
| Polymethyl methacrylate (PMMA) | 85-105 | 86-94 |
| Polyphenylene sulphide | 83-90 | |
| Polypropylene (PP) | | 138-155 |
| Polystyrene (PS) | 85-110 | 88-108 |
| Polysulfone (PSU) | 185 | 188 |
| Polyvinyl chloride (PVC) | 81 | 70-80 |
| Acrylonitrile butadiene styrene (ABS, | 100 | 93-100 |
| general purpose) | | |

*Data from Polymers: A Property Database″, 2^{nd} edition, B. Ellis and R. Smyth (eds.), CRC Press, Boca Raton (2009)

Within the thermoplastic polymer families exemplified in Table 1 and within other suitable families there exist many suitable homopolymers.

For example, many suitable grades of polyethylene and polypropylene are homopolymers exhibiting a broad range of properties arising from differences in density, molecular weight, crystallinity, branching and stereospecificity derived from different methods of synthesis.

As another example methacrylate homopolymers including polymethyl methacrylate, polyethyl methacrylate, polyisopropyl methacrylate, polyisobutyl methacrylate, poly(sec-butyl methacrylate) and poly(tert-butyl methacrylate) are all suitable for the invention. Poly (tert-butyl acrylate) and related acrylate homopolymers with a Tg of 45° C. or more or a VST of 45° C. or more are also suitable. Polymethyl methacrylate is a preferred member of the poly(meth)acrylate family for the purposes of the invention but other family members are also suitable. Suitable homopolymers may be linear or branched and of widely varying molecular weights.

Beyond the basic homopolymers exemplified in Table 1, there are many related water-insoluble copolymers of widely varying degrees of complexity suitable for the invention. In general, suitable copolymers may comprise monomers from the same chemical family (e.g., polyethylene polymerised with propylene and higher α-olefin comonomers, polymethacrylates containing different methacrylate monomers), or they may comprise monomers from different chemical families including monomers from polymer families exemplified in Table 1 (e.g. styrene acrylonitrile). Two, three or more different monomers in varying ratios may be used depending on the particular properties required. Copolymers of varying monomer distribution (i.e. random, alternating, block, graft) are also suitable for the invention. For example, acrylonitrile butadiene styrene (ABS, Table 1) is a ternary graft copolymer based on the styrene and acrylonitrile monomers, which impart stiffness, and polybutadiene which imparts flexibility to the copolymer.

Also suitable for the invention are sidechain modified polymers such as polyvinyl butyral (Tg 60-63° C.).

In addition, the water-insoluble thermoplastic may include a biopolymer comprising a cellulose ether such as ethyl cellulose (VST 152-162° C.), a cellulose ester such cellulose acetate (VST 70° C.) and derivatives thereof including cellulose acetate butyrate (VST 70° C.), cellulose acetate propionate (VST 100° C.) and the like, polylactide or polylactic acid (PLA, VST 55-63° C.), and a water-insoluble protein like zein (Tg 139° C.), or a high melting point wax such as bees wax (Tg 64° C.) and Carnauba wax (Tg 82° C.), and biopolymer blends.

Also suitable for the invention are thermoplastic aliphatic and aromatic hydrocarbon resins which have Tg values ranging from about 85° C. to about 170° C. depending on their composition and molecular weight.

Further thermoplastic polymers suitable for the invention are included in US EPA polymer exemptions for pesticide chemical formulations in CFR document “§ 180.960 Polymers; exemptions from the requirement of a tolerance” published by a number of websites including https://www.law.cornell.edu/cfr/text/40/180.960.

In one embodiment, the thermoplastic can be independently selected from the group consisting of is a styrene acrylonitrile copolymer, a polystyrene, a cellulose ether, a polymethylmethacrylate a polylactic acid or a combination thereof.

In one embodiment, the thermoplastic can be independently selected from the group consisting of a styrene acrylonitrile copolymer, a polystyrene, a cellulose ether, a polylactic acid, a polymethylmethacrylate, or a combination thereof.

In one embodiment, the thermoplastic can be independently selected from the group consisting of a styrene acrylonitrile copolymer, a polymethylmethacrylate or a combination thereof.

In one embodiment, the thermoplastic is a styrene acrylonitrile copolymer.

The cellulose ether used in the composition of the present invention are known and include but are not limited to, for example ethyl cellulose, methyl cellulose, methylethyl cellulose, hydroxyethyl cellulose, hydroxypropyl cellulose, hydroxyethylmethyl cellulose, hydroxypropyl methyl cellulose, carboxymethyl cellulose.

In one embodiment the cellulose ether may be independently selected from ethyl cellulose A, ethyl cellulose N, or a combination thereof.

The composite may comprise said at least one biocide and said thermoplastic in a wide range of relative quantities. The composite may comprise from about 1 wt. % to about 99 wt. % biocide and about 1 to about 99 wt. % thermoplastic based on the combined weight of biocide and thermoplastic.

In one embodiment the composite may comprise from about 3 wt. % to about 75 wt. % biocide and about 25 wt. % to about 97 wt. % thermoplastic based on the combined weight of biocide and thermoplastic.

In one embodiment the composite may comprise from about 6 wt. % to about 50 wt. % biocide and about 50 wt. % to about 94 wt. % thermoplastic based on the combined weight of biocide and thermoplastic.

In one embodiment the composite may comprise from about 6 wt. % to about 40 wt. % biocide and about 60 wt. % to about 94 wt. % thermoplastic based on the combined weight of biocide and thermoplastic.

A wide range of thermoplastics are suitable for use in forming the composites of the invention. In one embodiment the thermoplastic is water-insoluble.

In one embodiment, the thermoplastic has a glass transition temperature (Tg) of 45° C. or more, or a Vicat softening temperature (VST) of 45° C. or more.

In one embodiment the thermoplastic is a water-insoluble polymer having a glass transition temperature (Tg) of from 45° C. to 300° C., or having a Vicat softening temperature (VST) of from 45° C. to 300° C.

In one embodiment the glass transition temperature (Tg) is from 45° C. to 250° C., or the Vicat softening temperature (VST) is from 45° C. to 250° C.

### Embrittling Agent

The particle size of the biocide-composites of the invention is critical in order to obtain optimal results in terms of biocide retention and biocide distribution in glued-wood products. Therefore, it is important that the biocide-composites can be accurately milled into the desired particle size.

The present inventors have surprisingly found that the inclusion of an embrittling agent into a biocide-composite of the invention comprising said biocide, either alone or together with said thermoplastic, results in a significant increase in the friability of the biocide-composite of the invention. A higher friability is advantageous since less milling steps are necessary to move from coarse to fine particles, accompanied by reduced heat generation and/or less need for cryomilling. It also facilitates the production of finer particles, allows wet milling in place of dry milling, reduced milling equipment and ultimately operational costs.

A wide range of embrittling agents are suitable for forming biocide composites with said at least one biocidal compound. In one embodiment the embrittling agent is a water-insoluble solid.

The embrittling agents used in the composition of the present invention are known and include but are not limited to, for example ground or crushed minerals, natural products and synthetic materials.

Suitable particulate minerals include clays (silicates) such as montmorillonites, bentonites, kaolinites, attapulgite clays, talcs, sericites, vermiculites, micas, etc, and modified derivatives thereof.

Suitable modified clays include clays chemically modified using inorganic acids, bases and salts, exfoliated clays, calcined clays and organoclays. In organoclays, the original interlayer cations are exchanged for organocations such as quaternary alkylammonium ions so that an organophilic surface is generated, consisting of covalently linked organic moieties. The lamellar structure remains analogous to the parent phyllosilicate. Organoclays can be manufactured, e.g., using organic surfactants—besides a wide range of different alkyl ammonium ions, also various organic acids, amines, amides and other compounds with charged or reactive groups including polymerisation precursors such as vinyl monomers can be used.

Further suitable minerals include other silicates, diatomaceous earth, pumice, limestone, chalks, calcium carbonate, calcite, dolomite, gypsum, feldspar, alumina, perlite, powdered coal or sulphur, ground ceramic, ground glass and ground volcanic rock.

Suitable natural products include fine sawdust, wood flour, wood pulp, ground bark, powdered lignin, ground nut shells and the like. Various dry forms of lignocellulosic biomass, agricultural waste products such as straw, stalks, leaves, cobs, husks, coconut kernel, etc. may also be used. Other suitable products include charcoal, activated carbon, synthetic minerals and the like.

In one embodiment the embrittling agent is independently selected from the group consisting of an organoclay, a talc or combinations thereof.

In one embodiment, the embrittling agent is an organoclay.

In one embodiment the embrittling agent is a talc.

The embrittling agent is typically stable at all temperatures encountered during manufacture of the composite and in its use during manufacture of the glued-wood product, in particular under the harsh conditions that occur during hot-pressing or block-stacking of the glued-wood product.

In one embodiment the thermal degradation temperature of the embrittling agent is about 300° C. or less, more preferably about 250° C. or less.

The embrittling agent is present in the form of a powder and has preferably a Dv90 of about 100 μm or less, preferably 50 μm or less, more preferably about 20 μm or less and most preferably about 10 μm or less and, if necessary, should be milled accordingly before use. The Dv10 of the embrittling agent is preferably 1 μm or more.

In one embodiment the embrittling agent is independently selected from the group consisting of an organoclay, a talc or combinations thereof, and has a Dv90 of about 100 μm or less, preferably 50 μm or less, more preferably about 20 μm or less and most preferably about 10 μm or less and, if necessary, should be milled accordingly before use. The Dv10 of the embrittling agent is preferably 1 μm or more.

### Solidified Biocide-Composites (Biocide+Embrittling Agent)

In one embodiment, the at least one non-biocidal solid is an embrittling agent. This type of biocide-composite is sometimes referred to herein as a “solidified biocide-composite”. In this type of biocide-composite, the biocide itself effectively acts as a binder or bridging agent in and around fragments of the embrittling agent—but it is not a requirement that the biocide becomes incorporated within the pores and/or interstices of the embrittling agent. It is a combination that readily crumbles when milled.

The solidified biocide-composite according to this embodiment may comprise said at least one biocide and said embrittling agent in a wide range of relative quantities ranging from about 5 wt. % to about 95 wt. % biocide and from about 95 wt. % to about 5 wt. % embrittling agent, preferably from about 10 wt. % to about 90 wt. % biocide and from about 90 wt. % to about 10 wt. % embrittling agent, and more preferably from about 15 wt. % to about 85 wt. % biocide and from about 85 wt. % to about 15 wt. % embrittling agent, from about 20 wt. % to about 80 wt. % biocide and from about 85 wt. % to about 20 wt. % embrittling agent based on the combined weight of the biocide and the embrittling agent.

In one embodiment the solidified biocide-composite may comprise from about 5 wt. % to about 95 wt. % biocide and from about 95 wt. % to about 5 wt. % embrittling agent, wherein the biocide can be independently selected from the group consisting neonicotinoids, pyrethroids, phenylpyrazoles, avermectins, chitin synthesis inhibitors, uncouplers of oxidative phosphorylation, insect growth regulators, azoles, quinone outside inhibitor fungicides or combinations thereof, and

wherein the embrittling agent can be independently selected from the group consisting of a talc, an organoclay or a combination thereof.

In one embodiment the solidified biocide-composite may comprise from about 5 wt. % to about 95 wt. % biocide and from about 95 wt. % to about 5 wt. % embrittling agent, wherein the biocide can be independently selected from the group consisting of imidacloprid, bifenthrin, fipronil, etofenprox, permethrin, buprofezin, emamectin benzoate, cyproconazole, penconazole, triadimefon, pyraclostrobin, trifloxystrobin or combinations thereof, and wherein the embrittling agent is an organoclay.

In one embodiment the solidified biocide-composite may comprise from about 10 wt. % to about 90 wt. % biocide and from about 90 wt. % to about 10 wt. % embrittling agent, wherein the biocide can be independently selected from the group consisting of imidacloprid, bifenthrin, fipronil, etofenprox, permethrin, buprofezin, emamectin benzoate, cyproconazole, penconazole, triadimefon, pyraclostrobin, trifloxystrobin or combinations thereof, and

wherein the embrittling agent is an organoclay.

In one embodiment the solidified biocide-composite may comprise from about 15 wt. % to about 85 wt. % biocide and from about 85 wt. % to about 15 wt. % embrittling agent,

wherein the biocide can be independently selected from the group consisting of imidacloprid, bifenthrin, fipronil, etofenprox, permethrin, buprofezin, emamectin benzoate, cyproconazole, penconazole, triadimefon, pyraclostrobin, trifloxystrobin or combinations thereof, and
wherein the embrittling agent is an organoclay.

In one embodiment the solidified biocide-composite may comprise from about 20 wt. % to about 80 wt. % biocide and from about 80 wt. % to about 20 wt. % embrittling agent,

wherein the biocide can be independently selected from the group consisting of imidacloprid, bifenthrin, fipronil, etofenprox, permethrin, buprofezin, emamectin benzoate, cyproconazole, penconazole, triadimefon, pyraclostrobin, trifloxystrobin or combinations thereof, and
wherein the embrittling agent is an organoclay.

### Friable Biocide-Composites (Biocide+Thermoplastic+Embrittling Agent)

In one embodiment, the at least one non-biocidal solid in the biocide-composite of the invention is a thermoplastic and an embrittling agent. Biocide-composites of the invention comprising both a thermoplastic and an embrittling agent are also referred to as “friable biocide-composites” as it is a combination that is more readily milled than biocide-composites without an embrittling agent.

In one embodiment the biocide-composite is a friable biocide-composite and comprises at least one biocide, a thermoplastic and an embrittling agent in a wide range of relative quantities. The composite may comprise from about 1 wt. % to about 98 wt. % biocide, from about 1 wt. % to about 98 wt. % thermoplastic, and from about 1 wt. % to about 98 wt. % embrittling agent, based on the combined weight of the biocide, the thermoplastic and the embrittling agent.

In one embodiment the biocide-composite is a friable biocide-composite and may comprise from about 3 wt. % to about 72 wt. % biocide, from about 25 wt. % to about 94 wt. % thermoplastic, and from about 3 wt. % to about 72 wt. % embrittling agent, based on the combined weight of the biocide, the thermoplastic and the embrittling agent.

In another embodiment the biocide-composite is a friable biocide-composite and may comprise from about 6 wt. % to about 50 wt. % biocide, from about 45 wt. % to about 89 wt. % thermoplastic, and from about 5 wt. % to about 49 wt. % embrittling agent, based on the combined weight of the biocide, the thermoplastic and the embrittling agent.

In another embodiment the biocide-composite is a friable biocide-composite and may comprise from about 6 to about 40 wt. % biocide, from about 45 wt. % to about 60 wt. % thermoplastic, and from about 5 wt. % to about 40 wt. % embrittling agent, based on the combined weight of the biocide, the thermoplastic and the embrittling agent.

In one embodiment the biocide-composite is a friable biocide-composite and may comprise from about 1 wt. % to about 98 wt. % biocide, from about 1 wt. % to about 98 wt. % thermoplastic, and from about 1 wt. % to about 98 wt. % embrittling agent, based on the combined weight of the biocide, the thermoplastic and the embrittling agent

In one embodiment, the biocide-composite according to the present invention comprises from about 7 to about 30 wt. % biocide; from about 45 wt. % to about 85 wt. % thermoplastic; and from about 4 wt. % to about 45 wt. % embrittling agent, based on the combined weight of the biocide, the thermoplastic and the embrittling agent.

In one embodiment, the biocide-composite according to the present invention comprises from about 8 to about 25 wt. % biocide; from about 45 wt. % to about 80 wt. % thermoplastic, and from about 5 wt. % to about 40 wt. % embrittling agent, based on the combined weight of the biocide, the thermoplastic and the embrittling agent.

In one embodiment the biocide-composite is a friable biocide-composite and may comprise from about 1 wt. % to about 90 wt. % biocide, from about 25 wt. % to about 95 wt. % thermoplastic, and from about 5 wt. % to about 75 wt. % embrittling agent, based on the combined weight of the biocide, the thermoplastic and the embrittling agent, wherein the biocide can be independently selected from the group consisting of neonicotinoids, pyrethroids, phenylpyrazoles, avermectins, chitin synthesis inhibitors, uncouplers of oxidative phosphorylation, insect growth regulators, azoles, quinone outside inhibitor fungicides or combinations thereof,

wherein the thermoplastic can be independently selected from the group consisting of styrene acrylonitrile copolymer, polystyrene, cellulose ether, polylactic acid, polyvinyl chloride, polymethylmethacrylate or a combination thereof, having a glass transition temperature (Tg) of 45° C. or more, or a Vicat softening temperature (VST) of 45° C. or more, and
wherein the embrittling agent can be independently selected from the group consisting of a talc, an organoclay or a combination thereof.

In one embodiment the biocide-composite is a friable biocide-composite and may comprise from about 8 wt. % to about 25 wt. % biocide, from about 45 wt. % to about 80 wt. % thermoplastic, and from about 5 wt. % to about 40 wt. % embrittling agent, based on the combined weight of the biocide, the thermoplastic and the embrittling agent,

wherein the biocide can be independently selected from the group consisting of neonicotinoids, pyrethroids, phenylpyrazoles, avermectins, chitin synthesis inhibitors, uncouplers of oxidative phosphorylation, insect growth regulators, azoles, quinone outside inhibitor fungicides or combinations thereof,
wherein the thermoplastic can be independently selected from the group consisting of styrene acrylonitrile copolymer, polystyrene, cellulose ether, polylactic acid, polyvinyl chloride, polymethylmethacrylate or a combination thereof, having a glass transition temperature (Tg) of 45° C. or more, or a Vicat softening temperature (VST) of 45° C. or more, and
wherein the embrittling agent can be independently selected from the group consisting of a talc, an organoclay or a combination thereof.

In one embodiment the biocide-composite is a friable biocide-composite and may comprise from about 1 wt. % to about 90 wt. % biocide, from about 25 wt. % to about 95 wt. % thermoplastic, and from about 2 wt. % to about 75 wt. % embrittling agent, based on the combined weight of the biocide, the thermoplastic and the embrittling agent,

wherein the biocide can be independently selected from the group consisting of imidacloprid, bifenthrin, fipronil, etofenprox, permethrin, buprofezin, emamectin benzoate, cyproconazole, penconazole, triadimefon, pyraclostrobin, trifloxystrobin or combinations thereof,
wherein the thermoplastic can be independently selected from the group consisting of styrene acrylonitrile copolymer, polystyrene, cellulose ether, polylactic acid, polyvinyl chloride, polymethylmethacrylate or a combination thereof, having a glass transition temperature (Tg) of 45° C. or more, or a Vicat softening temperature (VST) of 45° C. or more, and
wherein the embrittling agent can be independently selected from the group consisting of a talc, an organoclay or a combination thereof.

In another embodiment the biocide-composite is a friable biocide-composite and may comprise from about 6 to about 40 wt. % biocide, from about 45 wt. % to about 60 wt. % thermoplastic, and from about 5 wt. % to about 40 wt. % embrittling agent, based on the combined weight of the biocide, the thermoplastic and the embrittling agent,

wherein the biocide can be independently selected from the group consisting of imidacloprid, bifenthrin, fipronil, etofenprox, permethrin, buprofezin, emamectin benzoate, cyproconazole, penconazole, triadimefon, pyraclostrobin, trifloxystrobin or combinations thereof,
wherein the thermoplastic can be independently selected from the group consisting of styrene acrylonitrile copolymer, polystyrene, cellulose ether, polylactic acid, polyvinyl chloride, polymethylmethacrylate or a combination thereof, having a glass transition temperature (Tg) of 45° C. or more, or a Vicat softening temperature (VST) of 45° C. or more, and
wherein the embrittling agent can be independently selected from the group consisting of a talc, an organoclay or a combination thereof.

In another embodiment the biocide-composite is a friable biocide-composite and may comprise from about 8 to about 25 wt. % biocide, from about 45 wt. % to about 80 wt. % thermoplastic, and from about 5 wt. % to about 40 wt. % embrittling agent, based on the combined weight of the biocide, the thermoplastic and the embrittling agent,

wherein the biocide can be independently selected from the group consisting of imidacloprid, bifenthrin, fipronil, etofenprox, permethrin, buprofezin, emamectin benzoate, cyproconazole, penconazole, triadimefon, pyraclostrobin, trifloxystrobin or combinations thereof,
wherein the thermoplastic can be independently selected from the group consisting of styrene acrylonitrile copolymer, polystyrene, cellulose ether, polylactic acid, polyvinyl chloride, polymethylmethacrylate or a combination thereof, having a glass transition temperature (Tg) of 45° C. or more, or a Vicat softening temperature (VST) of 45° C. or more, and
wherein the embrittling agent can be independently selected from the group consisting of a talc, an organoclay or a combination thereof.

### Plasticiser

The biocide-composites of the invention may further comprise a plasticiser, or one or more non-aqueous solvents.

The plasticiser can be any ingredient capable of reducing the Tg or VST of the thermoplastic and/or biocide, increasing the workability of the thermoplastic and/or biocide when melted.

Suitable plasticisers for a given thermoplastic/biocide combination can include one or more additional thermoplastics generally having a lower Tg or a lower VST than the primary thermoplastic, or a higher melt flow index than the primary thermoplastic at a given temperature, one or more additional biocides, or a solvent for the thermoplastic when used in quantities less than the quantity required to fully dissolve the thermoplastic. Some surfactants also may act as plasticisers.

### Preparation of Biocide-Composites by Hot Melt Mixing

Various methods can be used to prepare the biocide-composite of the present invention. The methods used in the present invention are known and include but are not limited to, for example thermomechanical processes broadly categorized as hot melt mixing and including heated batch mixing, solid dispersion kneading, heat compounding, hot melt extrusion, etc., as well as solvent based processes including solvent-casting and solvent precipitation.

In one embodiment, the biocide-composite of the present invention is prepared by a thermomechanical process.

Thermomechanical processes are known and include but are not limited to, for example heated batch mixing, solid dispersion kneading, heat compounding, hot melt extrusion.

In one embodiment, the biocide-composite of the invention is formed by hot melt mixing.

In one embodiment, the biocide-composite of the invention is formed by a thermomechanical process.

In another embodiment, the thermomechanical process of the invention is hot melt extrusion performed in an extruder.

The present invention provides a process for preparing a biocide-composite according to the invention comprising the steps of
a) Contacting at least one biocide with at least one thermoplastic and at least one embrittling agent,
b) Melting and Mixing said at least one biocide with said at least one thermoplastic and said at least one embrittling agent to form the biocide-composite,
c) Cooling said biocide-composite obtained in step b) to form a solid biocide-composite, and
d) Optionally comminution of said solid to obtain said biocide-composite in particulate form.

The present invention further provides a process for preparing a biocide-composite according to the invention comprising the steps of
a) Contacting at least one biocide with at least one thermoplastic and at least one embrittling agent,
b) Hot melt extrusion of said at least one biocide with said at least one thermoplastic and said at least one embrittling agent to form the biocide-composite,
c) Cooling said biocide-composite obtained in step b) to form a solid biocide-composite, and
d) Optionally comminution of said solid to obtain said biocide-composite in particulate form.

The biocide-composite according to the present invention may be formed by melting and mixing said at least one biocide and said at least one non-biocidal solid, then cooling to form the biocide-composite in the form of a solid, and optionally comminution of the solid biocide-composite to obtain said biocide-composite in particulate form. Hot melt mixing requires the input of energy (heating and mechanical energy) and is a thermomechanical process.

When forming the biocide-composites of the invention by hot melt mixing, the thermoplastic or the biocide is melted to provide at the end of processing a solid medium within which the other ingredients are incorporated.

In the case of a “biocide-composite” comprising biocide and thermoplastic, or a “friable biocide-composite” (biocide+thermoplastic+embrittling agent), the temperature is increased to equal to or greater than the Tg or VST of the thermoplastic to enable intimate mixing with the biocide (and embrittling agent). The temperature does not need to be greater than the M.p. of the biocide to form a biocide-composite but melting of the biocide is generally likely to be beneficial.

In the case of a “solidified biocide-composite” (biocide+embrittling agent), the temperature is increased to equal to or greater than the M.p. of the biocide, which forms the solid medium within which the embrittling agent is incorporated when it has cooled.

Generally, there is no limitation as to the nature of the association between the biocide and the thermoplastic and/or embrittling agent of the composite at a molecular or phase level. For example, the thermoplastic may be crystalline or amorphous, and the biocide may be crystalline, amorphous or molecularly dispersed within the thermoplastic. Accordingly, the composite can include, but is not limited to, a range of solid dispersions including eutectic mixtures, amorphous precipitates within a crystalline matrix of thermoplastic, solid solutions of various kinds in which the biocide is molecularly dispersed within a crystalline thermoplastic, glass suspensions of crystalline or amorphous biocide in amorphous thermoplastic, as well as glass solutions of molecularly dispersed biocide within an amorphous thermoplastic. These forms are well described in the literature, for example in Laitinen et al., “Theoretical Considerations in Developing Amorphous Solid Dispersions,” Amorphous Solid Dispersions, N. Shah ed., Springer-Verlag New York (2014), pp. 35-90.

The biocide and the thermoplastic starting materials may be presented in any form prior to processing.

In one embodiment, the thermoplastic polymer may be used in the form of dry pellets, flakes, powders and the like.

In one embodiment, the biocide may be added in the form of a powder. Biocides in solid form may be air milled to reduce particle size before use.

In one embodiment, biocides that are liquids at ambient temperature may be used. In another embodiment the liquid biocide may be mixed with a further biocide that is a solid at ambient temperature provided the liquid biocide does not act as a solvent for the solid biocide.

In one embodiment, the embrittling agent may be added in powdered form.

In one embodiment, the embrittling agent has a Dv90 of about 100 μm or less,

For the hot melt mixing process, the ingredients may be combined in any order. For example, the thermoplastic and/or the biocide may be melted before or after combining these ingredients.

In one embodiment of the process for preparing a biocide-composite according to the invention, said at least one non-biocide solid is a thermoplastic, wherein in step a) said at least one biocide and/or said thermoplastic are present in the form of a melt.

In another embodiment of the process for preparing a biocide-composite according to the invention, said thermoplastic is present in the form of a melt, and said at least one biocide is present in the form of a powder in step a).

In one embodiment, said at least one non-biocide solid is a thermoplastic and an embrittling agent, wherein in step a) said at least one biocide and/or said thermoplastic are present in the form of a melt and said embrittling agent is present in the form of a powder.

In another embodiment in step a) said thermoplastic is present in the form of a melt, and said at least one biocide and said embrittling agent are present in the form of a powder, or said at least one biocide and said thermoplastic are present in the form of a melt, and said embrittling agent is present in the form of a powder.

While it is generally convenient to melt the (pelletized) thermoplastic first to facilitate subsequent mixing with biocide and embrittling agent, the biocide and the thermoplastic in the form of pellets, flakes, powders and the like can also be blended together before melting and mixing. A good blend of this type can be achieved when the ingredients are first reduced to a similar particle size.

In one embodiment, the thermoplastic in pellet form may be melted first, the biocide may be introduced into the melted thermoplastic and the two ingredients are then mixed. The biocide may or may not melt when mixed into melted thermoplastic.

It may also be convenient to blend the biocide and the powdered embrittling agent before combining with the melted thermoplastic, typically when using a continuous process like extrusion. The biocide may or may not melt when mixed along with the embrittling agent into the melted thermoplastic.

“Solidified biocide-composites” of the invention comprising at least one biocide and an embrittling agent may likewise be formed by mixing said biocide in a molten state with the embrittling agent, then cooling to form a solid biocide-composite.

In one embodiment of the process for preparing a biocide-composite according to the invention, said at least one non-biocide solid is an embrittling agent, wherein in step a) said at least one biocide and/or said embrittling are present in the form of a powder, preferably a blend.

In another embodiment said at least one biocide is present in the form of a melt, and said embrittling agent is present in the form of a powder in step a).

The resulting solid biocide-composite of step c) is milled to obtain said biocide-composite in particulate form, and is milled to a particle size suitable for glueline addition as described below.

Melting, mixing and cooling may be performed using any of the hot melt mixing equipment and processes described herein. For example, melting, mixing (and cooling) may be performed in a batch process, for example using heated mixing devices ranging from laboratory equipment such as a Rheomixer to process equipment including heated batch mixers, kettles, reactors, and blenders including for example a heated ribbon blender. Preferably the process is performed in a continuous operation using equipment capable of one or more of metering, heating, mixing, cooling and conveying, including for example metered heated paddle mixers, co-kneaders, dispersion kneaders and extruders. The melt-mixed material may then be solidified on a belt cooler for example and formed into flakes, granules, etc.

Extruders can include ram extruders or, more typically, screw extruders. Suitable screw extruders generally comprise one or more feed mechanisms, each including a hopper or some form of metering device, a heated barrel which may be divided into zones operating at different temperatures, one or more screws within the barrel to apply shear forces to convey and mix the materials being processed, and a die or port at the barrel exit through which the material is formed into sheets or stands. Single screw extruders are widely used to manufacture pelletized plastics and for injection moulding. A twin screw extruder generally provides better mixing when combining different ingredients and may be more suitable for use in the present invention. Processing carried out using an extruder is known by various terms including hot melt extrusion (HME), compounding or melt compounding. The term “hot melt extrusion” is used herein to describe hot melt mixing performed using an extruder.

Hot melt-mixed materials may be reprocessed one or more times to improve composite homogeneity or for other reasons such as introduction of additional ingredients. The end point of extrusion is cooled strands or, more typically, cooled pellets produced using a die cutter or pelletiser. Other methods produce flakes, granules, etc. Generally, all of these materials need further size reduction for use in the invention.

The suitability of a particular biocide and thermoplastic for producing a composite by hot melt extrusion (HME) may be assessed principally by examining their calorimetric and solubility properties.

The principle calorimetric properties determining suitability of a given thermoplastic for hot melt mixing include the glass transition temperature (Tg), which is characteristic of thermoplastic polymers that generally may be described as amorphous, and the Vicat softening temperature (VST) which is applicable to all suitable thermoplastic polymers including amorphous, crystalline and semi-crystalline polymers.

Another very useful property known in the art is the melt flow index (MFI) which indicates the ease of flow of a thermoplastic melted at a specific temperature and measured as the mass passed through a capillary in 10 minutes. These data may be found in various publications including “Polymers: A Property Database”, 2^{nd} edition, B. Ellis and R. Smyth (eds.), CRC Press, Boca Raton (2009) as well as in manufacturers' product data sheets.

A given thermoplastic by itself may be extruded at about 20-140° C. or more above the Tg or VST of the thermoplastic. In one embodiment the given thermoplastic by itself may be extruded at about 20° C. above the Tg or VST of the thermoplastic. In another embodiment the given thermoplastic by itself may be extruded at about 140° C. above the Tg or VST of the thermoplastic. The processing temperatures for HME can be reduced by various means such as the addition of processing aids including solvents and plasticisers, and less commonly by blending polymers (thermoplastics) with different calorimetric properties prior to HME. The biocide itself can act as a plasticiser enabling lower processing temperatures. In some instances, a biocide may have the opposite effect thereby increasing the brittleness of the compounded material. While this may necessitate higher extrusion temperatures and/or torques, increased brittleness can also facilitate subsequent milling of the cooled extrudate.

The choice of suitable thermoplastics must also account for the biocide degradation temperature. The temperature of the melted thermoplastic at the point of biocide addition can be any temperature up to the biocide degradation temperature, preferably at least 20° C., and more preferably at least 40° C. below the biocide degradation temperature. Biocide degradation temperatures are most conveniently determined by thermogravimetric analysis (TGA). Unless hot melt mixing is to be performed in an inert atmosphere, TGA should be performed in air to account for oxidative degradation. TGA can be performed according to ISO 11358-1:2014.

A further consideration is the chemical compatibility of biocide and thermoplastic. While not wishing to be bound by theory, it is believed that solubility parameters of biocide and thermoplastic can indicate suitable matches based on mutual affinity. A number of solubility theories known in the art (Hildebrand, Hansen) can provide guidance following the general principle that like dissolves like or, more particularly, like seeks like. As an example, when considering the polar component of each material the following basic model provides a good indication of suitable (soluble and miscible) and unsuitable mixtures.

| | Non-polar | Mid-Polar | Polar |
|---|---|---|---|
| Non-polar | Soluble | Miscible | Immiscible |
| Mid-Polar | Miscible | Soluble | Miscible |
| Polar | Immiscible | Miscible | Soluble |

Further relevant parameters include dispersion forces, hydrogen bonding, acid/base properties, molecular weight, etc. Solubility parameters may be found in publications such as “CRC Handbook of Solubility Parameters and Other Cohesion Parameters, Second Edition,” A.F.M. Barton ed., CRC Press Boca Raton (1991). Hansen solubility parameters (HSP) for a wide range of chemicals and polymers as well as suitable methods for determining HSPs can be found in “Hansen Solubility Parameters: A User's handbook”, 2^{nd} edition, Charles M. Hansen (ed.), CRC Press Boca Raton (2007). Solubility parameters can be used to identify mixtures of non-solvent thermoplastics that together will act as solvent for particular biocides as known in the art. Other predictive methods are known in the art.

When processed using extrusion equipment, some mixtures may be formed into tough extruded stands, other mixtures may be formed simply into agglomerated lumps. Both of these crude states can be wet or dry milled into readily dispersible materials suitable for the invention.

Comminution may be achieved as described herein below, e.g., by wet or dry milling. Comminution of the solid biocide-composite is generally required to form readily dispersible mixtures suitable for glueline addition as described herein.

When hot melt mixing with an extruder, the various temperatures occurring in the extruder may vary within a large temperature range; in general, in a range from 45° C. to 300° C. Depending on the thermoplastic and the biocide used, a temperature of from 45° C. to 260° C. is preferably employed.

In one embodiment, the temperature during the hot melt extrusion process does not exceed 260° C.

In another embodiment, the temperature of at least one of the extruder heating zones during the hot-melt extrusion process exceeds the Tg or VST of the thermoplastic by at least 10° C.

In another embodiment, the temperature of at least one of the extruder heating zones during the hot melt extrusion process is at least equal to the M.p. of the biocide.

The present invention further provides a biocide-composite obtainable by said process, i.e., by a process comprising the steps of
a) contacting at least one biocide with at least one non-biocide solid,
b) the mixture from step a) is processed by hot-melt extrusion to form the biocide-composite,
c) cooling said biocide-composite obtained in step b) to form a solid biocide-composite, and
d) optionally comminution of said solid biocide-composite to obtain said biocide-composite in particulate form
   and all embodiments of this process as outlined above.

### Composites Formed by Solvent Precipitation or Solvent Casting

In one embodiment, the biocide-composite of the invention may be formed by dissolving the at least one biocide in a non-aqueous solvent, mixing the obtained solution with said at least one non-biocidal solid, and then removing the solvent from the mixture to form said biocide-composite in the form of a solid.

The non-aqueous solvent should be used in sufficient quantity to dissolve biocide and thermoplastic components and enable thorough mixing and integration of embrittling agents before precipitation or casting of the composites of the invention. Preferably, the solvent is volatile in this instance.

In one embodiment, the biocide-composites of the invention comprising at least one biocide and at least one thermoplastic are formed in the ratios outlined above by dissolving a biocidal active ingredient and a thermoplastic in a non-aqueous solvent, mixing to homogeneity, followed by precipitation or casting.

The present invention further provides a process for preparing a biocide-composite comprising at least one biocide, a water-insoluble thermoplastic having a glass transition temperature (Tg) of 45° C. or more, or a Vicat softening temperature (VST) of 45° C. or more and/or an embrittling agent according to the invention comprising the steps of
a) Dissolving said at least one biocide and said at least one non-biocide solid in a non-aqueous solvent, wherein said at least one non-biocide solid is a thermoplastic,
b) Optionally adding said embrittling agent, and
c) Removing the said non-aqueous solvent to obtain said biocide-composite in the form of a solid, and
d) Optionally comminution of said solid biocide-composite to obtain said biocide-composite in particulate form.

A wide range of non-aqueous solvents may be used depending on the chosen biocide and thermoplastic. Ingredients may be combined in any order but generally a minimal volume of solvent is provided first in order to facilitate agitation during solids addition. Heat may be applied to increase the rate and degree of dissolution.

Once the biocide and thermoplastic have fully dissolved and mixed, the temperature may be reduced to bring about co-precipitation of dissolved material.

In one embodiment, the mixture may be combined with a poor solvent or a non-solvent to initiate precipitation (sometimes called coacervation).

Solvent casting is performed by dissolution of ingredients in a highly volatile solvent, optional partial evaporation of the solvent then pouring a film, generally on a moving belt, to maximise evaporation of remaining solvent. One consideration in choosing suitable (initial) solvents for either method is to ensure a consistent mutual solubility of biocide and thermoplastic, i.e. to avoid partitioning the biocide into the liquid phase during precipitation or solvent evaporation. As discussed above solubility theories will assist in choosing appropriate matches for biocide and thermoplastic with the additional consideration being the liquid solvent in which both solids must be dissolved at the start of the precipitation and casting processes.

Solidified biocide-composites of the invention comprising at least one biocide and an embrittling agent may likewise be formed by dissolving the at least one biocide in a non-aqueous solvent and mixing with the embrittling agent then removing the solvent from the mixture. The resulting material is generally milled to a particle size suitable for glueline addition as described below.

Solidified biocide-composites may also be formed without heat by using a non-aqueous solvent in sufficient quantity to dissolve the biocide and enable thorough mixing with embrittling agents. The liquid suspension is then cast as a thin layer to expedite solvent evaporation, fragmented and milled to a powder and, optionally, formulated as described below before use.

Thus, the present invention also provides a process for preparing a solidified biocide-composite comprising at least one biocide, a water-insoluble thermoplastic having a glass transition temperature (Tg) of 45° C. or more, or a Vicat softening temperature (VST) of 45° C. or more and an embrittling agent according to the invention comprising the steps of
a) Dissolving said at least one biocide in a non-aqueous solvent,
b) Mixing said solution with said embrittling agent, and
c) Removing the said non-aqueous solvent to obtain said biocide-composite in the form of a solid,
d) optionally comminution of said solid biocide-composite to obtain said biocide-composite in particulate form.

### Comminution and Classification

Irrespective of whether the biocide-composite of the invention is formed by a hot melt mixing process, or by solvent precipitation or solvent casting, all forms of the previously described biocide-composites according to the invention, including the friable and solidified biocide-composites, are generally reduced to smaller particles by some form of milling action based on grinding, cutting, shearing, etc., followed by screening and, where necessary, reprocessing of oversized particles. This may be done before or after combining the composite with other ingredients during formulation.

Approximate particle sizes in any range suitable for the invention can be prepared from milled material using commercially available sieves, including for example sieves ranging from a US Standard Mesh No. 500 (25 μm nominal sieve opening) to a No. 30 (500 μm nominal sieve opening). A range of sizes with an approximate lower limit and an approximate upper limit may be prepared using two different commercially available sieves and keeping the fraction retained by the sieve with the smaller sieve opening. Various size ranges may also be produced during the milling operation using classifier mills, and gravitational and centrifugal air classification equipment, etc., as known in the art. Further size ranges may be produced by wet milling a suspension until the desired range is achieved. Particle sizes suitable for the present invention may be measured by microscopic examination and image analysis, or laser diffraction, etc. Laser diffraction is a preferred method of particle size analysis. Relevant ISO methods of measurement and presentation of particle size distributions include, for example, ISO 13320:2020 Particle size analysis—Laser diffraction methods, and ISO 9276:2014 Representation of results of particle size analysis, which is split into multiple parts.

The material may be milled dry or in the presence of a solvent that does not dissolve the thermoplastic or the biocide (non-solvent liquid), preferably water.

Particle size reduction is required to ensure particles can be dispersed readily and evenly during formulation. Importantly, individual particles must be small enough to pass through any filters used in the mill during glue application. These filters can range in aperture size from about 250 to 500 μm. Thus a practical upper limit for the composite particle size is a Dv90 of 500 μm. Further suitable Dv90 values include 475, μm, 450 μm, 425 μm, 400 μm, 375 μm, 350 μm, 325 μm, 300 μm, 275 μm, 250 μm, 225 μm and 200 μm.

A wide variety of dry milling equipment can be used including a hammer mill, pin mill, cutting mill, ball mill, disk mill, jet mill, classifier mill, and the like. Where necessary a cryomill operating with liquid nitrogen, dry ice, or other coolants may be used to increase brittleness. Suitable wet milling equipment may include a bead mill, shear pump, colloid mill, etc.

In one embodiment the biocide-composite may be milled dry or in the presence of a non-solvent liquid.

In one embodiment the biocide-composite may be milled in the presence of water.

The particle size of the biocide-composites of the invention may vary.

In one embodiment, more than 80% of particles of the biocide-composite by weight fall in the range from about 1 μm to about 500 μm.

In one embodiment the biocide-composite has a Dv10 of at least about 1 μm and the Dv90 is about 500 μm or less.

In one embodiment the biocide-composite has a Dv10 of at least about 1 μm and the Dv90 is about 500 μm or less, as determined, e.g., by laser diffraction in water.

In one embodiment, the Dv10 of the biocide-composite is at least about 5 μm and the Dv90 is about 500 μm or less.

In one embodiment, the Dv10 of the biocide-composite is at least about 10 μm and the Dv90 is about 500 μm or less.

In one embodiment, the Dv10 of the biocide-composite is at least about 20 μm and the Dv90 is about 400 μm or less.

In one embodiment, the Dv10 of the biocide-composite values include at least about 30 μm, at least about 50 μm, at least about 100 μm, and at least about 150 μm.

In one embodiment, the biocide-composite particle size ranges include from about 5 μm to about 500 μm, from about 50 μm to about 500 μm, from about 100 μm to about 500 μm, from about 200 μm to about 500 μm, from about 300 μm to about 500 μm, from about 300 μm to about 400 μm, or from about 400 μm to about 500 μm.

In one embodiment, the biocide-composite particle sizes ranges include from about 1 μm to about 50 μm, from about 1 μm to about 100 μm, from about 1 μm to about 200 μm, from about 1 μm to about 300 μm, from about 5 μm to about 20 μm, from about 5 μm to about 50 μm, from about 5 μm to about 100 μm, from about 5 μm to about 200 μm, from about 5 μm to about 300 μm, from about 20 μm to about 50 μm, from about 20 μm to about 100 μm, from about 20 μm to about 200 μm, from about 20 μm to about 250 μm, from about 20 μm to about 300 μm, from about 50 μm to about 100 μm, from about 50 μm to about 200 μm, from about 50 μm to about 300 μm, from about 100 μm to about 150 μm, from about 100 μm to about 200 μm, from about 100 μm to about 300 μm, from about 150 μm to about 200 μm, from about 150 about 300 μm, from about 200 μm to about 250 μm, from about 200 μm to about 300 μm and from about 250 μm to about 300 μm.

The biocide-composite in particulate form can be included in a glue, a native resin or in any other suitable form of adhesive.

In one embodiment the biocide-composite in particulate form can thereafter be included in a glue for use in glueline preservation of glued wood products.

In one embodiment the embodiment the biocide-composite having a Dv10 of at least about 1 μm and the Dv90 is about 500 μm or less can thereafter be included in a glue.

In one embodiment the embodiment the biocide-composite having a Dv10 of at least about 5 μm and the Dv90 is about 500 μm or less can thereafter be included in a glue.

In one embodiment the embodiment the biocide-composite having a Dv10 of at least about 10 μm and the Dv90 is about 500 μm or less can thereafter be included in a glue.

In one embodiment the embodiment the biocide-composite having a Dv10 of at least about 20 μm and the Dv90 is 400 μm or less can thereafter be included in a glue.

### Formulations

The biocide-composites according to the present invention may be formulated into any suitable formulation that facilitates their handling, storage and incorporation into the glue during glue-line treatment.

All forms of the previously described composite according to the invention, including the friable and solidified biocide-composites, may be used in powdered form without addition of further ingredients, or may be combined with further ingredients and formulated according to known methods. In one embodiment, more than one composite, each comprising a different biocide, may be formulated together. In one embodiment, two or more biocides may be combined within a single composite and optionally formulated.

Formulation types and methods of formulating biocidal active ingredients in their native form are described, for example, in “Chemistry and Technology of Agrochemical Formulations,” D. A. Knowles ed., Kluwer Academic Publishers, Dordrecht (1998), and “Pesticide Formulation and Adjuvant Technology,” C. L. Foy and D. W. Pritchard eds., CRC Press, Boca Raton (1996), and “Formulation Technology: Emulsions, Suspensions, Solid Forms,” H. Mollet and A. Grubenmann, Wiley-VCH, New York (2001).

The above mentioned methods of formulating may be adapted to the present invention by taking into account the chemical properties of the particular non-biocidal solids in use.

In one embodiment, the biocide-composites according to the present invention are formulated into storage-stable liquid formulations for convenient use. Suitable liquid formulation types include suspensions and dispersions. In this case, suitable formulation media are limited to solvents and oils which are not a solvent for the thermoplastic or biocide components of the composite. Water is particularly suitable.

In another embodiment, the biocide-composites according to the present invention are provided as solid powders or granules.

The choice of formulation type depends on the properties of the glue or native resin used as the adhesive.

The formulation may contain customary formulation additives, the functions of which are described in the previously mentioned publications. Such additives may include one or more fluids including water, non-solvent organic liquids and oils, surfactants, dispersants, emulsifiers, penetrants, spreaders, wetting agents, inerts, colloids, suspending agents, thickeners, thixotropic agents, polymers, glidants, acids, bases, salts, organic and inorganic solid matrices of various kinds, preservatives, anti-foam agents, anti-freeze agents, anti-caking agents, lubricants, stickers, binders, dyes, pigments, and the like.

Formulations can be prepared using known methods involving blending and further processing of the composite and suitable customary formulation additives by means of dispersing, finely dividing, slurring, emulsifying, homogenizing, stirring, wet and dry milling, stabilising, drying, granulating, etc, in order to formulate for glueline addition.

The formulated biocide-composite may be combined with conventional formulations comprising one or more biocides in a non-composite form as in a suspension concentrate (SC), an emulsifiable concentrate (EC), etc. Thus, for example, one or more fungicides may be presented as a conventional formulation such as a SC, and an insecticide may be presented as a formulated biocide-composite of the invention, both combined to provide a single product ready for use.

In one embodiment, the composite is readily and evenly dispersible within the glue mixture.

Further details of suitable formulation methods are provided in the examples.

### Glueline Treatments

The biocide-composites of the invention and formulations thereof are particularly suited for use in glueline treatment of glued-wood products.

The biocide-composite of the invention may be incorporated directly into the glue or native resin component of hot pressed or hot-pressed and block-stacked glued-wood products. In this case, the biocide-composite of the invention may be blended directly into the native resin or the glue mixture at any time from resin production to use in the mill manufacturing the glued-wood product. It is a blend of glue and biocide that is then added to the wood component. For example, the composite may be added directly to the native resin or to the glue mixture at the resin plant and shipped as part of a ready-to-use glue mixture. In one embodiment, the composite may be added to the glue or native resin in the mill at any time before glue or native resin application during the layup operation.

Direct glue addition may be performed by blending the biocide-composite into glue or native resin in the form of dry milled particulates, a powdered formulation or a liquid formulation of the milled particles. Dry forms of the composite may be added to dry resins or glue mixtures. Dry and liquid forms of the composite may be added to liquid resins or glue mixtures. Generally speaking, a liquid formulation of milled particles is more readily blended into liquid resins or glue mixtures.

Hence, the present invention provides a glue for glueline treatment of glued-wood products comprising the biocide-composite of the invention, which is in the form of a powder, or in the form of a formulation as defined above.

Direct glue addition is common in the manufacture of glueline-treated engineered wood products where the biocide-composite is blended into the glue or native resin before it is used. The glue-composite combination may be applied to constituent veneers by pumping, blending, extruding, soaking, dipping, spinning, atomising, spraying, pouring, rolling, foaming, or curtain coating, etc. Direct glue addition may also be used with reconstituted wood-based products.

The biocide-composite of the invention may also be added to the wood via indirect glue addition. In this case the biocide-composite is added to the wood in a stream separate from the glue.

When the biocide-composite is added before the glue, the biocide-composite is typically coated onto the wood component. When added concomitantly with the glue, both the glue and biocide will coat the wood component more or less together. When the biocide-composite is added after the glue, the biocide generally first encounters the glue, then merges into the glue and meets the underlying wood component.

The three relative addition steps may be conveniently accomplished, for example, by the relative positioning of spray jets or spinning disks in a typical chip or strand tumbler where various ingredients are added to the wood component to provide a “furnish” which is spread onto a forming belt before hot pressing.

Indirect glue addition may be practiced in the manufacture of engineered wood products by spraying, misting or otherwise coating the composite onto veneers before the layup operation.

Indirect glue addition may be more common in the manufacture of reconstituted wood-based products where the composite may be applied to the wood raw material (“furnish”) by injection into a refiner, blow line, strand or chip tumbler, sometimes in mixture with waxes and other agents, prior to, at the same time as or after introduction of the glue mixture or native resin. This method of manufacture is widely used with isocyanate resins where it is necessary to minimise the extent and duration of exposure to water. It is also widely practiced with a range of other resin types where blending of a number of ingredients is required to provide a homogeneous mat prior to hot pressing.

Direct and indirect glue addition of the biocide-composite of the invention result in distribution of biocide throughout the glueline during manufacture of a glued-wood product. The glueline may be planar as in an engineered wood product such as plywood or LVL, or it may be a complex network structure following the multifaceted surfaces of the wood flakes, strands, and fibres, etc., that make up reconstituted wood-based products. Due to the unique beneficial properties of the biocide-composites of the invention, direct and indirect glue addition techniques as described above both result in dispersion of the composite throughout the glue zone of the glued-wood product.

Glues and native resins within the scope of the invention include thermoset polymers including phenolic resins comprising novolac-type and resole-type phenol-formaldehyde (PF) resins, resorcinol-formaldehyde resins and phenol-resorcinol-formaldehyde resins, and amino resins including hydroxymethyl or alkoxymethyl derivatives of urea, melamine, benzoguanamine, and glycoluril, chiefly urea-formaldehyde, melamine-formaldehyde, and melamine-urea formaldehyde resins. Also included are isocyanate resins based on (partially) polymerised diisocyanates, mainly polymeric diphenylmethane diisocyanate (pMDI), thermoset epoxy and polyurethane resins, PVAs, as well as adhesives based on biomaterials including proteins, starches and lignocellulosic extractives such as lignins. The thermoset resins comprising the glue component are to be distinguished from the thermoplastic polymers used to prepare the biocide-composite described herein.

Native resins such as isocyanate resins like polymeric diphenylmethane diisocyanate (pMDI), can be used as is, but most resins are applied to the wood component in mixture with water, wetting agents, inorganic and organic fillers and extenders (generally lignocellulosic residues), catalysts, plasticisers and additives with various other functions. As such they are termed “glue mixtures” or simply glues. The native resins and derived glue mixtures may be in a liquid or powdered state when combined with the biocide-composite of the invention.

Glued-wood products wherein the glue is treated using the biocide-composites of the invention are manufactured by conventional means using standard manufacturing equipment. No changes in methods of hot pressing or hot pressing and block stacking are required to practice the invention.

The biocide-composites of the invention are applied to the resin, glue mixture or furnish, in sufficient quantities to achieve the desired retentions of biocidal ingredients in the glued-wood product taking into account the relative amounts of glue and wood component, and any analytical losses that may occur during hot pressing or hot pressing and block stacking. The biocide loading is generally determined by calculation and is therefore a nominal value.

Minimum retentions of biocidal ingredients are generally specified with reference to a particular “hazard class” for the finished product, i.e. a category relating to the durability of the product in a defined geographical area, the location of the product in a building or structure, its exposure to moisture, proximity to the ground, etc.

Minimum retentions, methods of extraction and analysis as well as other requirement are set by standards or code marks and by organisations such as Australasian Wood Preservation Committee, American Wood Preservers Association, Japanese Industrial Standards, EN Standards, etc. Relevant standards include AS/NZS 1604.4:2006 “Specification for preservative treatment Laminated veneer lumber (LVL)” and AS/NZS 1605.3:2006 “Methods for sampling and analysing timber preservatives and preservative-treated timber.”

### EXAMPLES

The following Examples are illustrative of the invention and the scope of the invention is not intended to be limited thereto.

### Abbreviations

| | |
|---|---|
| AS/NZ S | Australia and New Zealand Standard ™ |
| 1605.3:2006 | Methods for sampling and analysing |
| | timber preservatives and preservative- |
| | treated timber Part 3: Analysis methods |
| | for determination of preservative |
| | retention |
| BIT | Benzisothiazoline-3-one (CAS 2634-33-5) |
| cP | Centipoise, unit of dynamic viscosity |
| DSC | Differential scanning calorimetry |
| EC | Emulsifiable concentrate |
| FID | Flame ionization detector for GC |
| g/m² | Grams of glue per square metre of veneer |
| gai/m³ | Grams of biocide active ingredient per |
| | cubic metre of finished plywood |
| GC | Gas chromatography |
| HME | Hot melt extrusion (a method for |
| | compounding or mixing meltable ingredients, |
| | particularly thermoplastics) |
| HPLC | High performance liquid chromatography |
| LVL | Laminated veneer lumber |
| MCIT | Methylchloroisothiazolinone (CAS 26172-55-4) |
| MDF | Medium density fibreboard |
| OSB | Oriented strand board |
| MFI | Melt flow index |
| M.p. | Melting point |
| MPa | Megapascal (unit of pressure) |
| PF | Phenol-formaldehyde |
| PLA | Polylactic acid (also called polylactide) |
| PMMA | Polymethyl methacrylate |
| PS | Polystyrene |
| PVC | Polyvinyl chloride |
| PTFE | Polytetrafluoroethylen (Teflon ®) |
| SAN | Styrene acrylonitrile copolymer |
| SC | Suspension concentrate |
| TGA | Thermogravimetric analysis |
| Tg | Glass transition temperature |
| VST | Vicat softening temperature |
| Wt % | Weight as a percentage of the weight of the total mixture |
| % m/m | % mass/mass based on the oven-dried |
| | mass of the wood test sample (unit of |
| | biocide retention) |

### Materials

| | |
|---|---|
| Bifenthrin | CAS 82657-04-3, 98% tech, supplied by DVA AGRO GmbH |
| Imidacloprid | CAS 138261-41-3, 97% tech, supplied by Agrolex Pte Ltd |
| Triadimefon | CAS 43121-43-3, 97% tech, supplied by DVA AGRO GmbH |
| Cyproconazole | CAS 94361-06-5, 96% tech supplied by DVA AGRO GmbH |
| Etofenprox | CAS 80844-07-1, 96% tech, supplied by Mitsubishi Chemical Corp |
| Fipronil | CAS 120068-37-3, 96% tech, supplied by Gharda Chemicals Ltd |
| Trifloxystobin | CAS 141517-21-7, 97% tech, supplied by DVA AGRO GmbH |
| Pyraclostrobin | CAS 175013-18-0, 98% tech, supplied by Shanghai Jinsheng |
| Emamectin | CAS 155569-91-8, 95% tech, supplied by Agrolex Pte Ltd |
| benzoate | |
| Buprofezin | CAS 69327-76-0, 98% tech, supplied by Agrolex Pte Ltd |
| Penconazole | CAS 66246-88-6, 97% tech, supplied by Agrolex Pte Ltd |
| Prefere ® PF resin | Ready to use phenol-formaldehyde (PF) resin, tradename: Prefere ®), |
| | supplied by AICA NZ Ltd, CAS 9003-35-4 |
| Ethyl cellulose A | Product 19096, Acros Organics ™, ethoxyl content 48%, 10 cP (5% in |
| | 80/20 toluene/ethanol, 25° C.), Tg 133° C., CAS 9004-57-3 |
| Aqualon ™ EC N- | Tradename: Aqualon ™ EC N-22, ethyl cellulose, ethoxyl content 48- |
| 22 | 49.5%, 18-24 cP (5% in 80/20 toluene/ethanol, 25° C.), Tg 131.5° C., |
| | Ashland Specialty Ingredients, CAS 9004-57-3 |
| Ingeo ™ 406D | Polylactic acid (PLA), tradename: Ingeo ™ 4060D, Tg 55-60° C. supplied |
| | by NatureWorks LLC, CAS 26100-51-6 |
| KIBISAN ® PN- | Styrene acrylonitrile (SAN) copolymer, available from ChiMei |
| 117C | Corporation, Taiwan, VST 104° C., MFI 5 g/10 min, 200° C., 5 kg, CAS |
| | 9003-54-7 |
| TALC A325 | Talc (93%), available from Omya, CAS 14807-96-6 |
| Tixogel MP 100 | Organoclay, available from BYK-Chemie GmbH, CAS 68953-58-2 |
| Talstar ® 80 SC | Talstar ® 80 SC from FMC Corp, commercially available suspension |
| | concentrate containing 80 g/L bifenthrin |
| Talstar ® 100 EC | Talstar ® 100 EC from FMC Corp, commercially available emulsion |
| | concentrate containing 100 g/L bifenthrin and 30-60% w/w liquid |
| | hydrocarbon (CAS 64742-94-8) |
| STYRON ™ | General purpose polystyrene, available from Trinseo, USA, VST 108° C., |
| 685D | MFI 1.5 g/10 min, 200° C., 5kg load, CAS 9003-53-6 |
| Chemvin PVC RE | Polyvinyl chloride (PVC), available from Chemvin Plastics Ltd, Shore |
| 55 | hardness D 80, B52782 pt 365B @ 23° C., CAS 9002-86-2 |
| ACRYREX ® | Polymethyl methacrylate (PMMA), available from ChiMei Corp., |
| CM-207 | Taiwan, VST 107° C., MFI 8.5 ml/10 min, 230° C., 3.8 Kg load, |
| | CAS 9011-14-7 |
| Permatek ® IM 30 | Imidacloprid as a 30 g/L Sc, available from Lonza NZ Ltd |
| Velcloprid 200SC | Imidacloprid as a 200 g/L SC, available from Lonza NZ Ltd. |
| Azotek ® GL 2918 | A suspensible emulsion containing 375 g/L triadimefon, 37.5 g/L |
| | cyproconazole and 16.7 g/L bifenthrin. |
| Gensil 2000 | Silicon Anti-Foam suspension, CAS 63148-62-9 |

### Methods

AS/NZS 1604.3:2021 “Preservative-treated wood-based products—Part 3: Test methods.” Standard specifies requirements for testing and analysing preservatives and preservative-treated wood-based products. Includes penetration spot tests, retention tests and solution analysis.

AS/NZS 1604.4:2006 “Specification for preservative treatment Laminated veneer lumber (LVL)”, Sets out a specification for preservative treatment of laminated veneer lumber (LVL). It specifies the bond type, preservative penetration pattern, and the preservative retention requirements suitable for each hazard class.

AS/NZS 1605.3:2006 “Methods for sampling and analysing timber preservatives and preservative-treated timber.” Analysis methods for determination of preservative retention. Specifies the analysis methods for determination of preservative retention in treated timber.

### Methods for Analysis of Biocide Retentions

| | Extraction | |
|---|---|---|
| Biocide | solvent & method | Analysis method |
| Imidacloprid | Methanol, high | ELISA according to AS/NZS |
| | shear, 3 min | 1605.3:2006, Section 18 |
| Bifenthrin | Methanol, | GC according to AS/NZS |
| | sonication, 16 h | 1605.3:2006, section 14 |
| Triadimefon/ | Methanol, soxhlet | GC according to AS/NZS |
| cyproconazole | extraction, 30 min | 1605.3:2006, section 19 |
| | | (amendment proposed) |
| Permethrin | Ethanol, | HPLC according to AS/NZS |
| | sonication, 90 min | 1605.3:2006, section 16. |
| Etofenprox | Methanol, | HPLC. Detection: 220 nm. |
| | sonication, 16 h | Mobile phase: 100% |
| | | methanol. Internal standard: |
| | | diphenyl sulfone. |
| Fipronil | Acetonitrile, | HPLC. Detection: 280 nm. |
| | sonication, 16 h | Mobile phase: water: |
| | | acetonitrile 35:65. Internal |
| | | standard: diphenyl |
| | | sulfone. |
| Trifloxystrobin | Methanol, | GC. Detection: FID. Column temp.: |
| | sonication, 16 h | 150° C. for 1 min, |
| | | ramp to 280° C. at 15° C./min, |
| | | 280° C. for 5 min. |
| | | Internal standard: dibutyl phthalate. |
| Pyraclostrobin | Acetonitrile, | HPLC. Detection: 260 nm. Mobile |
| | sonication, 16 h | phase: water pH 3 |
| | | (H₃PO₄) : acetonitrile 20:80. |
| | | Internal standard: |
| | | hexazinone. |
| Emamectin | Methanol, | HPLC. Detection: 245 nm. |
| benzoate | sonication, 16 h | Mobile phase: water: |
| | | acetonitrile 10:90. Internal |
| | | standard: diphenyl |
| | | sulfone. |

### Accelerated Storage Procedure

Accelerated storage was performed according to MT 46.3 Accelerated Storage Procedure, CIPAC Method 1999, Prepared by the German Formulation Panel (DAPF).

### Measurement of Particle Size by Laser Diffraction

Dv10 and Dv90 values were determined by laser diffraction in water using a Malvern Mastersizer 3000 instrument with the following analysis settings: Particle Refractive Index, 1.596; Particle Absorption Index, 0.010; Dispersant Name, Water; Dispersant Refractive Index, 1.330; Scattering Model, Mie; Analysis Model, General Purpose.

Samples (100-300 mg) were dispersed into 5 ml of water containing 5 g/litre tristyryl phenol-polyethylene glycol-phosphoric acid ester and 2 g/L polyethylene-polypropylene glycol, monobutyl ether. This dispersion was then added dropwise into 500 ml water circulating through the Mastersizer 3000 until the laser obscuration was within the range 1-20% before conducting the measurement.

### Example 1: Preparation of Biocide-Composite Samples 1-5 (Solvent Casting and Solvent Precipitation)

### Preparation of Biocide-Composite Sample 1

Imidacloprid, ethyl cellulose A (see Table 2a) and 1½ drops of paraffin oil were stirred into cyclohexane at a temperature of 60° C. The mixture was heated to 80° C. and kept at this temperature for 1 h to dissolve the ethyl cellulose, then the mixture was cooled to 55° C. for a period of 40 min, and was finally kept at ambient temperature for 2 days. The precipitated solids were filtered, air dried and ground to obtain a fine powder using a mortar and pestle.

### Preparation of Biocide-Composite Samples 2-5

The active ingredients as indicated in Table 2a were dissolved in dichloromethane at ambient temperature. The thermoplastic ethyl cellulose was added to these mixtures and the resulting mixtures stirred vigorously while allowing the solvent to evaporate. The resulting gelled mass was cast as a thin film on a PTFE-coated Aluminium Block and air dried for 2 days. The solidified films were ground to a fine powder and sieved using a 75 μm sieve (Biocide-Composite Sample 2) or a 300 μm sieve (Biocide-Composite Samples 3 to 5).

TABLE 2a
Composition of Biocide-Composite Samples 1 to 5

| Sample | 1 | 2 | 3 | 4 | 5 |
|---|---|---|---|---|---|
| Imidacloprid [g] | 10.31 | 10.8 | | | |
| Bifenthrin [g] | | | 5.48 | | |
| Triadimefon [g] | | | | 30.54 | |
| Cyproconazole [g] | | | | | 10.89 |
| Cyclohexane [g] | 212.1 | | | | |
| Dichloromethane [g] | | 358.7 | 64.4 | 191 | 95.3 |
| Ethyl cellulose A [g] | 50.29 | 51.7 | | | |
| AqualonTM EC N-22 [g] | | | 21.6 | 63.01 | 20.78 |
| Total [g] | 272.7 | 421.2 | 91.48 | 284.55 | 126.97 |

TABLE 2b
Method for preparation of Biocide-
Composite Samples 1 to 5

| Sample | Method | Sieve fraction |
|---|---|---|
| 1 | Precipitation/ | Not sieved, |
| | coacervation | fine powder |
| 2 | Solvent casting | <75 μm |
| 3 | Solvent casting | <300 μm |
| 5 | Solvent casting | <300 μm |
| 4 | Solvent casting | <300 μm |

### Example 2: Preparation of Plywood Containing Biocide-Composite Samples 1-5

### Preparation of Biocide-Composite Containing Glues

The powders of Biocide-Composite Samples 1-5 were blended into Prefere® PF resin resulting in glue samples 1, 2 and 3.

TABLE 3
Composition of Biocide-Composite-containing Glues 1-3

| | Biocide-composite 1 | Biocide-composite 2 | Biocide-composite 3 | Biocide-composite 4 | Biocide-composite 5 | |
|---|---|---|---|---|---|---|
| Glue sample | “Imidacloprid” | “Imidacloprid” | “Bifenthrin” | “Triadimefon” | “Cyproconazole” | Prefere ® PF resin |
| Glue 1 | x | | | | | x |
| Glue 2 | | x | | | | x |
| Glue 3 | | | x | x | x | x |

Preparation of Hot-Pressed or Hot-Pressed and Block-Stacked Plywood with Biocide-Composite Containing Glues

The biocide-composite containing glues were applied to seven rotary peeled veneers (wood species: Pinus radiata, 300 mm×300 mm×3.2 mm). The glue spread rate was 200 grams of glue per square metre of veneer (200 g/m²). Nominal biocide loadings in the finished plywood, expressed as grams of active ingredient per cubic metre of plywood (gai/m³), are provided in Table 4. After cold pressing, the plywood layups were sawn into quarters or into halves and hot-pressed for 20 minutes at 140° C. and approx. 16 MPa. After hot-pressing, the plywood portions were subjected either to:

a) “hot-pressed” conditions only: allowed to cool to ambient temperature, or
b) “hot-pressed” and simulated “block stacked” conditions: wrapped in aluminium foil and held in an oven at 100° C. for the times indicated (see Table 4), before allowing to cool to ambient temperature.
Preparation of Comparative Hot-Pressed and/or Block-Stacked Plywood Examples

Plywood samples were prepared as described above with either a commercially available imidacloprid SC (Permatek® IM30) or with a commercially available suspensible emulsion containing triadimefon, cyproconazole and bifenthrin (Azotek® GL).

| Comparative | |
|---|---|
| sample | Containing biocide |
| Comp 1 | Permatek ® IM30 (imidacloprid) |
| Comp 2 | Azotek ® GL (bifenthrin, |
| | triadimefon, cyproconazole) |

### Analysis Method for Determining Preservative Retention in Treated Plywood

Plywood specimens were then cut into 20 mm×20 mm squares, ground in a Wiley® Mill and analyzed. The analytical procedures used are presented in the Methods section above.

Retention data produced by the methods, as specified, are expressed as % m/m, i.e. the mass of biocide as a percentage of the oven-dried mass of the wood test sample.

Data in this form can be more readily evaluated as a percentage of the nominal loading, i.e. how much of the applied biocide is “recovered” after hot pressing or hot pressing and simulated block stacking. Data expressed as percentages of nominal loading also facilitates comparisons among different application rates. To calculate such recoveries for plywood, the nominal loading is first converted from gai/m³ to % m/m based on a plywood oven dry density of 450 kg/m³ according to the following formula:

% m/m=gai/m³/450 kg/m³/10

The recovery is then calculated according to the formula:

Percentage nominal loading=retention/loading×100%

When imidacloprid was applied to the glueline of plywood as a suspension concentrate (Comp 1), the retention after hot pressing was acceptable (72.1% of the nominal loading) but dropped nearly 10-fold to 8.7% after simulated block stacking for 72 h (Table 4). This result clearly demonstrates one aspect of the problem to be solved by the present invention.

When imidacloprid was applied as a composite containing Ethyl cellulose A (Glue 1) or Aqualon™ EC N-22 (Glue 2) rather than as a SC, the retentions were again acceptable after hot pressing but there were only small further reductions after simulated block stacking, i.e. the large reductions in retention after block stacking were overcome. This would enable a significant reduction in the imidacloprid application rate to achieve the same retention at the end of the manufacturing process.

Bifenthin, triadimefon and cyproconazole gave retentions ranging from 55% to 63% of the nominal loading when applied as a suspensible emulsion (Comp 2), and these values dropped by a further 15-26% after block stacking. When these actives were applied as biocide-composites containing Aqualon™ EC N-22 (Glue 3), the bifenthrin and cyproconazole retentions were higher (70-81%) after hot pressing and the retentions after block stacking for 48 h either remained unchanged (cyproconazole) or dropped by less than 7% (bifenthrin and triadimefon).

TABLE 4
Biocide retentions in hot-pressed or hot-pressed and block-stacked plywood presented
as percentage of nominal loadings.

| | | | Retention as % of nominal loading | | | |
|---|---|---|---|---|---|---|
| | | Nominal | | Hot-pressed and block stacked at | | |
| | | loading | Hot- | 100° C. | | |
| | | [gai/m³] | pressed | 24 h | 48 h | 72 h |
| Glue 1 | Imidacloprid | 80 | 49.5% | 39.9% | | 46.1% |
| Glue 2 | Imidacloprid | 20 | 78.8% | 45.0% | | 36.0% |
| Glue 3 | Bifenthrin | 40 | 81.0% | | 77.6% | |
| | Triadimefon | 900 | 61.1% | | 54.3% | |
| | Cyproconazole | 90 | 70.0% | | 70.5% | |
| Comp 1 | Imidacloprid | 40 | 72.1% | 10.8% | 8.7% | |
| Comp 2 | Bifenthrin | 40 | 58.5% | | 32.6% | |
| | Triadimefon | 900 | 62.5% | | 47.5% | |
| | Cyproconazole | 90 | 55.5% | | 40.0% | |

### Example 3: Biocide-Composite Samples 6-9 (HME)

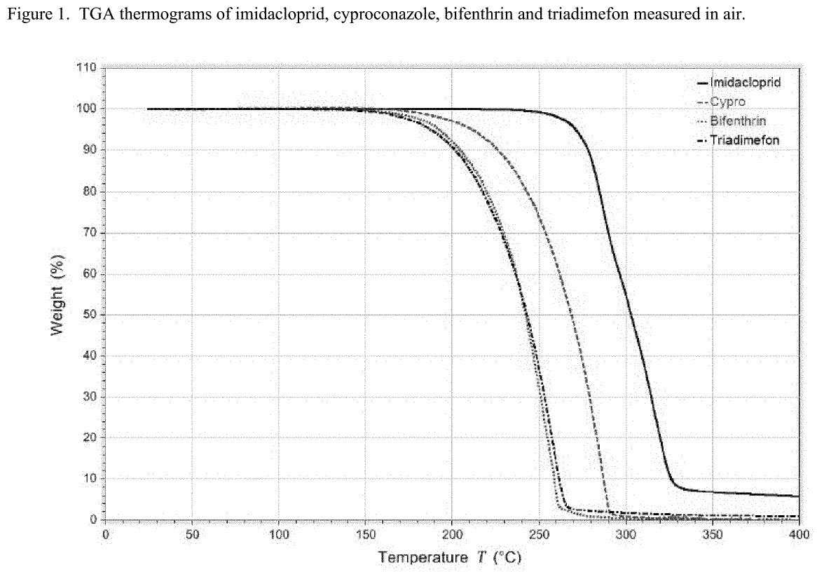

Imidacloprid has a degradation temperature of about 274° C. (onset of weight loss, see the thermogravimetric analysis data in FIG. 1). Accordingly, the mixing of imidacloprid with any thermoplastic by hot melt extrusion (HME) should be performed at temperatures less than about 270° C.

### Preparation of Biocide-Composite Samples 6-9 by HME

Imidacloprid (M.p. 145.3° C.) was mixed with KIBISAN® PN-117C to produce biocide composites. HME was performed using a Labtech LTE 26-40 co-rotating twin screw extruder fitted with 26 mm general purpose screws operating at 300 rpm. Table 5 provides a list of extrusion parameters including the set temperatures for each zone of the extruder barrel proceeding from the main product inlet point (Feed zone) in the direction of product movement to the exit point at the die. In all experiments a circular die was used which gives rise to an extrudate in the form a thread. Imidacloprid and KIBISAN® PN-117C pellets were introduced at the rates shown in Table 5 using gravimetric feeders. KIBISAN® was introduced at the Feed zone while imidacloprid was introduced at zone 5 where the set temperature (200° C.) was well below the insecticide's thermal degradation temperature. The extruded strands were cooled with water to ambient temperature, cut to pellet lengths of 1.3 mm (Biocide-Composite Samples 6-8) and 1.6 mm (Biocide-Composite Sample 9), cryomilled, sieved through a 106 μm screen, then further formulated to yield aqueous suspensions (see Example 4).

TABLE 5
Composition and extrusion parameters for
Biocide-Composite Samples 6-9

| Biocide-Composite Sample | 6 | 7 | 8 | 9 |
|---|---|---|---|---|
| Imidacloprid feed rate kg/h | 0.49 | 0.79 | 1.58 | 2.37 |
| KIBISAN feed rate kg/h | 6.29 | 6.00 | 5.21 | 4.42 |
| Feed set temp (° C.) | 240 | 240 | 240 | 220 |
| Zone 2 set temp (° C.) | 240 | 240 | 240 | 220 |
| Zone 3 set temp (° C.) | 220 | 220 | 220 | 210 |
| Zone 4 set temp (° C.) | 200 | 200 | 200 | 190 |
| Zone 5 set temp (° C.) | 200 | 200 | 180 | 200 |
| Zone 6 set temp (° C.) | 180 | 180 | 180 | 160 |
| Zone 7 set temp (° C.) | 180 | 180 | 180 | 110 |
| Zone 8 set temp (° C.) | 170 | 170 | 170 | 60 |
| Zone 9 set temp (° C.) | 170 | 170 | 165 | 110 |
| Die set temp (° C.) | 150 | 150 | 140 | 100 |
| Die pressure (bar) | 60 | 52 | 45 | 40 |

Preparation of Hot-Pressed or Hot-Pressed and Block-Stacked Plywood with Biocide-Composite Containing Glues (Effect of Sieve Fraction)

The pellets of Biocide-Composite Sample 8 were embrittled in liquid nitrogen, milled at 18,000 rpm using a Retsch ZM 200 Ultra-Centrifugal Mill fitted with a twelve tooth rotor and 0.50 mm mill ring sieve, then fractionated on a sieve shaker. Sieve fractions were prepared using Retsch 300 mm diameter sieves assembled using the following pan and nominal sieve openings: pan, 106 μm, 150 μm, 212 μm, 300 μm, 500 μm. A portion of Sample 8 weighing about 100 g was placed on the 500 μm sieve and the sieve assembly was shaken on a Endecott EFL 2000 sieve shaker for 10 minutes. The resulting sieve fractions (<106 μm, 106-150 μm, 150-212 μm, 212-300 μm and 300-500 μm) were blended in Prefere® PF resin and evaluated as biocide-composite containing glue (glueline treatment) in plywood at a nominal imidacloprid application rate of 1,000 gai/m³. As a comparison plywood was also glueline treated at 1,000 gai/m³ using Velcloprid 200SC (Comp 3, Imidacloprid SC). The hot-pressed or hot-pressed and block-stacked plywood was prepared and analysed to determine imidacloprid retentions as described above.

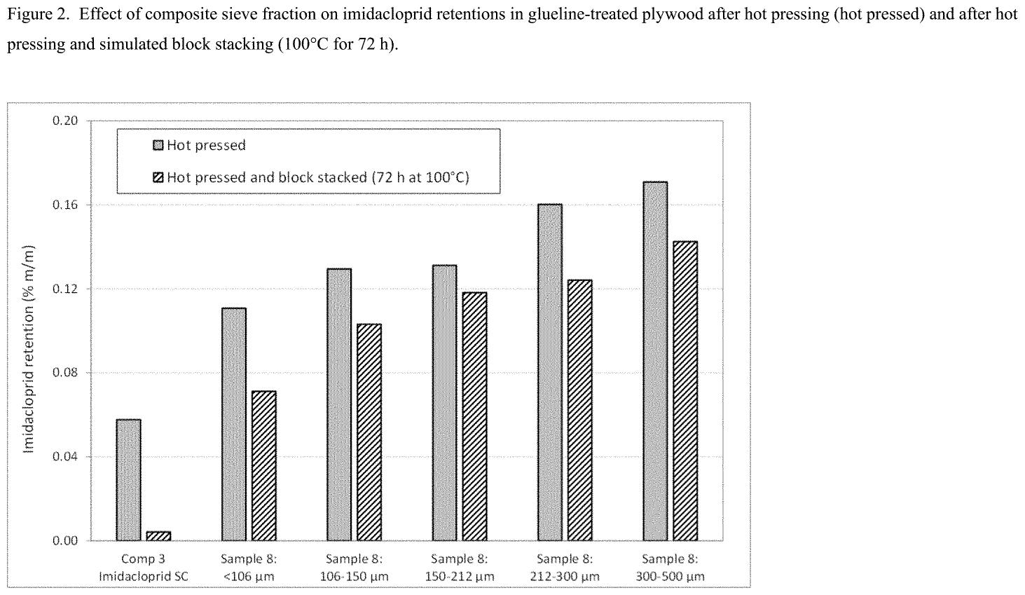

Imidacloprid retentions after hot pressing and after holding at 100° C. for 72 h (simulated block stacking) were markedly higher in plywood specimens that were glueline treated with the biocide-composites than in plywood treated with the imidacloprid suspension concentrate (Comp 3, see FIG. 2). Moreover, the retentions increased in sieve fractions containing larger particles, thus providing beneficial ranges suitable for a wide variety of manufacturing conditions, e.g. glue filters at plywood mills can range in aperture size from about 250 to 500 μm.

### Example 4: Aqueous Biocide-Composite Suspensions 6A-9A

### Preparation of Aqueous Biocide-Composite Suspensions of Samples 6-9

Aqueous biocide-composite suspensions were prepared as follows (see Table 6): Magnesium aluminum silicate was dispersed into about 40 volumes of water with high shear agitation, then combined with antifoam and dispersants/wetting agents to form a base mixture into which Biocide-Composite Samples 6-9 were dispersed with low shear agitation. The Surfactant pre-mix, comprising dispersants and wetting agents, is a 2:1 mixture by weight of tristyryl phenol-polyethylene glycol-phosphoric acid ester and polyethylene-polypropylene glycol, monobutyl ether. Xanthan gum was then added as a 1.5% dispersion in water, along with glycerol, potassium hydroxide and preservatives (BIT and MCIT) (Table 6). The ingredient quantities in Table 6 are expressed as weight % (wt %) based on the total weight of the aqueous suspension.

TABLE 6
Ingredients of aqueous Biocide-
Composite Suspensions 6A-9A

| Suspension | 6A | 7A | 8A | 9A |
|---|---|---|---|---|
| Biocide-Composite Sample No. | 6 | 7 | 8 | 9 |
| wt % | 50.00 | 33.00 | 15.00 | 10.23 |
| Water | 38.89 | 56.89 | 67.75 | 69.95 |
| Magnesium aluminium silicate | 0.43 | 0.43 | 0.64 | 0.61 |
| Gensil 2000 antifoam emulsion | 0.13 | 0.13 | 0.20 | 0.20 |
| Surfactant pre-mix | 1.57 | 1.57 | 2.09 | 3.03 |
| Xanthan gum | 0.09 | 0.09 | 0.15 | 0.16 |
| Glycerol | 7.67 | 7.67 | 13.90 | 15.51 |
| Potassium hydroxide | 0.07 | 0.07 | 0.10 | 0.15 |
| BIT (Preservative) | 0.13 | 0.13 | 0.14 | 0.13 |
| MCIT (preservative) | 0.02 | 0.02 | 0.02 | 0.02 |

Preparation of Hot-Pressed or Hot-Pressed and Block-Stacked Plywood with Glues Containing Aqueous Biocide-Composite Suspensions 6A-9A

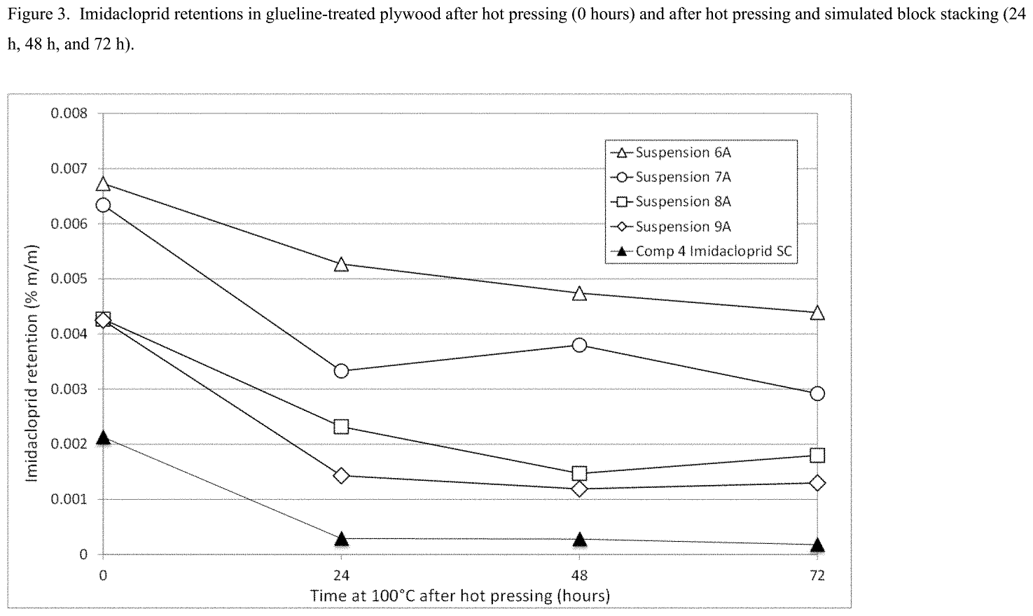

Aqueous Biocide-Composite Suspensions 6A to 9A were blended with Prefere® PF resin and tested as glueline treatments in plywood at a nominal imidacloprid application rate of 20 gai/m³ and subjected to simulated block stacking conditions as described above (Example 2). As a comparison plywood was also glueline treated at 20 gai/m³ with Permatek® IM 30 (Comp 4). FIG. 3 and Table 7 illustrate imidacloprid retentions in the treated plywood that were cooled immediately after hot pressing (0 hours) or held for 24 to 72 hours at 100° C.

TABLE 7
Imidacloprid retentions in hot-pressed or
hot-pressed and block-stacked plywood

| | | Imidacloprid retention (% m/m) | | | |
|---|---|---|---|---|---|
| | | | Hot-pressed and | | |
| | Nominal | | block stacked at | | |
| | loading | | 100° C. | | |
| Suspension | [gai/m3] | Hot-pressed | 24 h | 48 h | 72 h |
| 6A | 20 | 0.0067 | 0.0053 | 0.0047 | 0.0044 |
| 7A | 20 | 0.0063 | 0.0033 | 0.0038 | 0.0029 |
| 8A | 20 | 0.0043 | 0.0023 | 0.0015 | 0.0018 |
| 9A | 20 | 0.0043 | 0.0014 | 0.0012 | 0.0013 |
| Comp 4 | 20 | 0.0021 | 0.0003 | 0.0003 | 0.0002 |

The treated plywood containing Biocide-Composite Suspension 6A gave the highest retention immediately after hot pressing (0.0067% m/m) and the imidacloprid retentions only declined by 35% to 0.0044% m/m after 72 hours in the block stack simulation. Aqueous Biocide-Composite Suspension 6A is made of Biocide-Composite 6 which contains about 6 wt % imidacloprid and 94 wt % KIBISAN® PN-117C.

Increasing the percentage of imidacloprid to approximately 10%, 20% and 30% in the biocide-composites diminished insecticide retentions after hot pressing and diminished the resistance to further reductions when held at 100° C. (FIG. 3). In all cases, the final values were well above the 0.0006% m/m minimum retention specified in AS/NZS 1604.3 and AS/NZS 1604.4.

By comparison, imidacloprid formulated as a conventional suspension concentrate (Comp 4) produced a lower retention after hot pressing and this was further reduced when held at 100° C. (FIG. 3). Loadings considerably higher than 20 gai/m³ would be needed to meet the minimum retention when using an imidacloprid suspension concentrate (SC) under hot press and block stacking conditions such as these.

### Stability of Aqueous Biocide-Composite Suspensions

Aqueous Biocide-Composite Suspension 8A was divided in two parts, one part was stored at ambient temperature, the other in a sealed vessel for 14 days at 54° C., which is an accelerated storage procedure (see Methods) equivalent to 2 years storage at ambient temperature. Both suspensions were then used to manufacture glueline treated plywood as described above (Example 2). The imidacloprid application rate was 30 gai/m³.

TABLE 8
Imidacloprid retentions in plywood
treated with glue containing aqueous
Biocide-Composite Suspension 8A

| | | Hot pressed and “block | | |
|---|---|---|---|---|
| Imidacloprid retention | Hot- | stacking” at 100° C. | | |
| (% m/m) | pressed | 24 h | 48 h | 72 h |
| 8A at ambient temperature | 0.0030 | 0.0014 | 0.0011 | 0.0016 |
| 8A for 14 days at 54° C. | 0.0036 | 0.0015 | 0.0011 | 0.0012 |

The measured imidacloprid retentions in the treated plywood demonstrate a similar performance in the fresh and “stored” sample after hot pressing and simulated block stacking (Table 8), demonstrating that the Biocide-Composite Suspension 8A had good storage stability properties.

LVL Mill Trial with Aqueous Biocide-Composite Suspension 8A

The performance of the aqueous Biocide-Composite Suspension 8A was compared with a commercially available imidacloprid SC (Permatek® IM30) (Comp 5, Imidacloprid SC) in a laminated veneer lumber (LVL) mill trial in order to assess the effect of the biocide-composite on imidacloprid retentions in different regions of the LVL billet after hot pressing and block stacking.

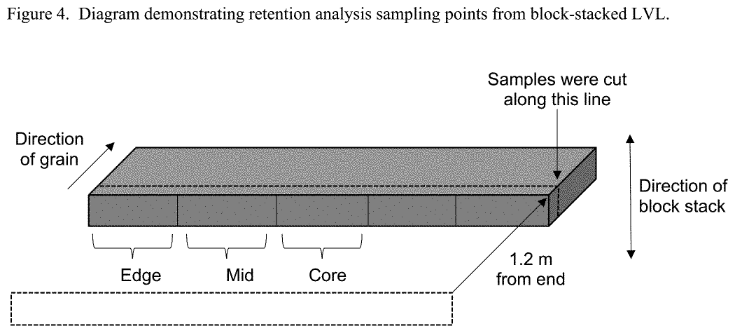

LVL comprising 15 veneers and measuring 1.25 m×4.5 cm (W×T) was manufactured from 3.2 mm peeled Douglas Fir veneers using PF resin applied at a glue spread rate of 160 g/m². Permatek® IM30 (Comp 5, Imidacloprid SC) and aqueous Biocide-Composite Suspension 8A were each combined with the PF resin to give a final imidacloprid application rate of 30 gai/m³. The LVL was hot-pressed in a continuous press. LVL was sampled as full width pieces immediately after exiting the press (“hot-pressed”) or after cooling for four days in a typical commercial block stack comprising 11 billets of LVL cut to 16 m lengths. Billets 5 and 6 or 6 and 7 from the bottom of the stack were sampled 1.2 m in from the end of the stack, and from “edge”, “mid” or “core” positions in relation to the edge of the stack as shown in FIG. 4. Note billets 5 and 7 are equivalent in relation to the bottom or top of the stack.

TABLE 9
Imidacloprid retentions in LVL mill trial

| | | Imidacloprid retention (% m/m) | | | |
|---|---|---|---|---|---|
| | | Hot- | Block stacked | | |
| Sample | | Pressed | Edge | Middle | Core |
| Billet 5 | Comp 5, | 0.0028 | 0.0016 | 0.0005 | 0.0006 |
| | Imidacloprid SC | | | | |
| Billet 6 | Comp 5, | 0.0028 | 0.0024 | 0.0006 | 0.0005 |
| | Imidacloprid SC | | | | |
| Billet 6 | Suspension 8A | 0.0038 | 0.0029 | 0.0021 | 0.0030 |
| Billet 7 | Suspension 8A | 0.0038 | 0.0029 | 0.0023 | 0.0025 |

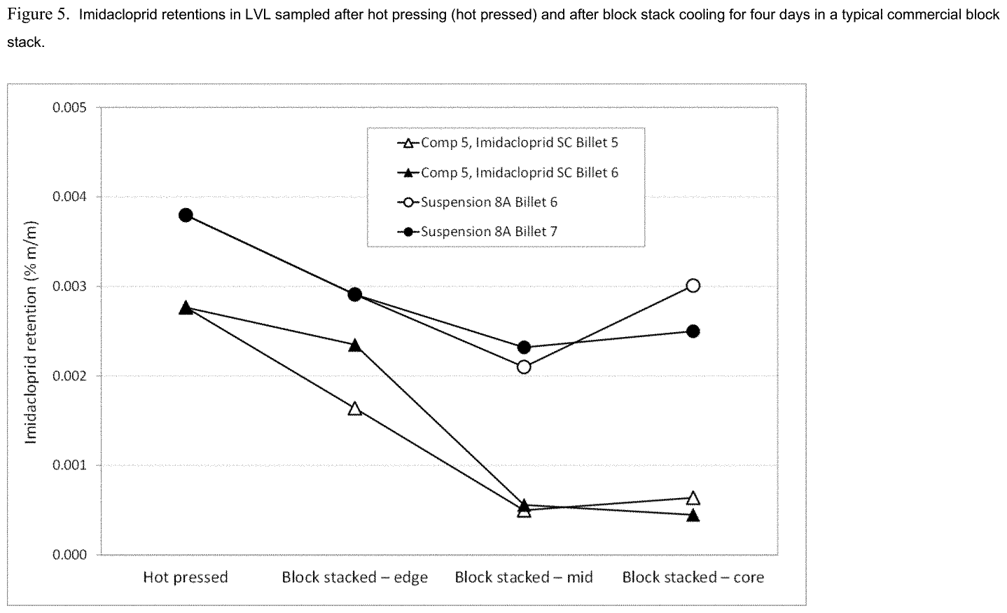

As shown in FIG. 5 and Table 9, LVL manufactured with glue containing aqueous Biocide-Composite Suspension 8A gave a 37% increase in the imidacloprid retention compared to LVL treated with glue containing the conventional imidacloprid SC (Comp 5) when sampled immediately after hot pressing.

The difference in imidacloprid retentions in the differently treated LVL samples increased further after cooling in a block stack, particularly in the mid and core positions of the stack, such that average retentions in the mid and core positions were 460% higher using aqueous Biocide-Composite Suspension 8A than when using the suspension concentrate (Comp 5, Imidacloprid SC).

### Example 5: Biocide-Composite Samples 10 to 12 (HME)

Degradation temperatures were established by thermogravimetric analysis (TGA, see FIG. 1) with the following results: bifenthrin 195° C., triadimefon 195° C., and cyproconazole 205° C. These temperatures indicate upper limits for processing these biocides by HME. The melting points for these biocides are: bifenthrin 57-64.6° C., triadimefon 82.3° C., and cyproconazole 106.2-106.9° C.).

### Preparation of Biocide-Composite Samples 10-12 by HME

Each biocide (bifenthrin, triadimefon, cyproconazole) was mixed with KIBISAN® PN-117C to produce a biocide-composite by hot melt extrusion (HME). HME was performed using a Labtech LTE 26-40 co-rotating twin screw extruder fitted with 26 mm general purpose screws operating at 300 rpm. Said biocides and KIBISAN® PN-117C pellets were fed into the extruder at the rates shown in Table 10 using gravimetric feeders. The biocide was introduced at zone 5. The extrudates were cooled with water to ambient temperature, pelletized, milled, sieved to <106 μm and analyzed for biocide content, then used directly as plywood glueline treatments at the nominal loadings shown in Table 11 and subjected to simulated block stacking conditions as described above.

TABLE 10
Composition and extrusion parameters
for Biocide-Composite Samples 10 to 12

| Biocide-Composite Sample | 10 | 11 | 12 |
|---|---|---|---|
| Biocide | Bifenthrin | Triadimefon | Cyproconazole |
| Biocide feed rate kg/h | 0.66 | 0.66 | 0.66 |
| KIBISAN feed rate kg/h | 2.34 | 2.34 | 2.34 |
| Feed set temp (° C.) | 230 | 230 | 230 |
| Zone 2 set temp (° C.) | 190 | 190 | 190 |
| Zone 3 set temp (° C.) | 190 | 190 | 190 |
| Zone 4 set temp (° C.) | 190 | 190 | 190 |
| Zone 5 set temp (° C.) | 160 | 160 | 160 |
| Zone 6 set temp (° C.) | 160 | 160 | 160 |
| Zone 7 set temp (° C.) | 150 | 150 | 150 |
| Zone 8 set temp (° C.) | 150 | 150 | 150 |
| Zone 9 set temp (° C.) | 140 | 140 | 140 |
| Die set temp (° C.) | 140 | 140 | 140 |
| Die pressure (bar) | 46 | 30-40 | 56 |
| % Biocide in <105 μm sieve | 15.7 | 19.2 | 14.6 |
| fraction | | | |

Preparation of Comparative Hot-Pressed and/or Block-Stacked Plywood Examples

Plywood samples were been prepared using the following conventional biocide formulations.

| Comparative | |
|---|---|
| sample | Containing biocide |
| Comp 6 | Talstar ® 80 SC (bifenthrin) |
| Comp 7 | Talstar ® 100 EC (bifenthrin) |
| Comp 8 | Triadimefon suspension concentrate (SC) |
| Comp 9 | Cyproconazole suspension concentrate (SC) |
| Comp 10 | Triadimefon SC and cyproconazole SC |

Preparation of hot-pressed or hot-pressed and block-stacked plywood with glues containing Biocide-Composite Samples 10-12

The <106 μm sieve fractions of Biocide-Composite Samples 10-12 were blended with Prefere® PF resin and evaluated as glueline treatments in plywood at the nominal application rates presented in Table 11. Hot-pressed or hot-pressed and block-stacked plywood was prepared and analyzed for biocide retentions as described above.

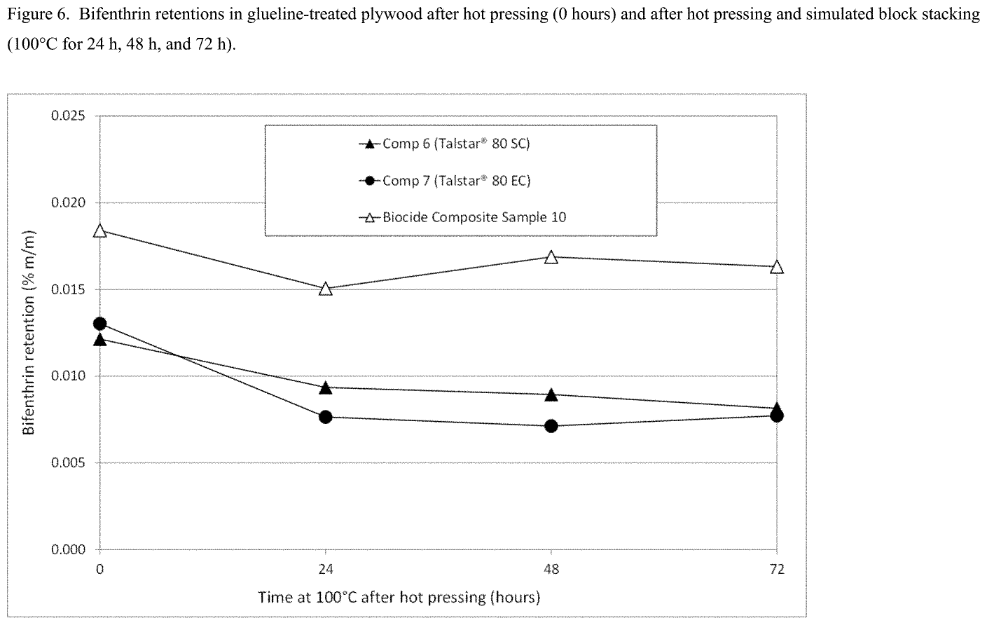

The time course in FIG. 6 shows that when bifenthrin is applied as a conventional SC or EC (Comp 6 and Comp 7), the bifenthrin retentions were 0.012 and 0.013% m/m respectively, after hot pressing (which is denoted at 0 hours on the x axis) and declined significantly after block stacking (denoted as 24, 48 and 72 hours at 100° C.). The greatest reductions occurred during the first 24 hours. In contrast, when bifenthrin was applied as a biocide-composite comprising the thermoplastic KIBISAN® PN-117C (Sample 10), the retention after hot pressing was approx. 46% higher (0.018% m/m) than the SC and EC, and only declined by a small amount during block stacking. The net result was a doubling of the bifenthrin retention at the end of a full simulated manufacturing operation when using the composite rather than a conventional formulation. This would enable about 50% less bifenthrin to be used to achieve the same retentions, if applied as Biocide-Composite Sample 10 when compared to comparative SC and EC.

Table 11 demonstrates how compounding with KIBISAN improved the retentions of bifenthrin, triadimefon and cyproconazole after simulated block stacking for 72 h. The retentions are presented as a percentage of nominal loadings, i.e. as a “recovery”, which is calculated as described above. Application of triadimefon as a biocide-composite (Sample 11) improved recoveries by about 20% compared to a conventional suspension concentrate (Comp 8) whether applied alone or in a 1:1 combination with equivalent cyproconazole formulations. Application of cyproconazole as Sample 12 improved recoveries by 4-5% when applied alone or in a 1:1 combination with equivalent triadimefon formulations (Table 11).

TABLE 11
Recovery of active ingredients when applied as biocide-composites containing
KIBISAN ® PN-117C or as conventional formulations (EC, SC). Data represent retentions
after hot pressing and holding for 72 h at 100° C.

| | | Nominal | | | |
|---|---|---|---|---|---|
| | | loading | Retention as % of nominal loading | | |
| Sample | Biocide | [gai/m³] | Bifenthrin | Triadimefon | Cyproconazole |
| 10 | Bifenthrin | 80 | 68% | | |
| 11 | Triadimefon | 600 | | 63% | |
| 12 | Cyproconazole | 600 | | | 37% |
| 11 + | Triadimefon + | 600 | | 72% | |
| 12 | Cyproconazole | 600 | | | 40% |
| Comp 6 | Bifenthrin SC | 80 | 37% | | |
| Comp 7 | Bifenthrin EC | 80 | 35% | | |
| Comp 8 | Triadimefon | 600 | | 43% | |
| Comp 9 | Cyproconazole | 600 | | | 32% |
| Comp 10 | Triadimefon + | 600 | | 53% | |
| | Cyproconazole | 600 | | | 36% |

### Example 6: Biocide-Composite Sample 13 with Polylactic Acid (PLA) as Thermoplastic

Biocide-Composite Sample 13 comprising 80 wt % Ingeo™ 4060 D (polylactic acid, PLA) and 20 wt % imidacloprid (based on total weight of the composite) was prepared using a Thermofisher Haake PTW16 co-rotating twin screw extruder fitted with 16 mm general purpose screws, operating at 300 rpm and a 190° C. set point for all extruder zones.

PLA was fed at 0.8 kg/h and imidacloprid introduced at zone 5 at 0.2 kg/h. The extrudate was water cooled, pelletized, cryomilled and a 106-212 μm sieve fraction was evaluated as a biocide-composite glueline treatment in plywood at a nominal imidacloprid application rate of 500 gai/m³ as described above.

Plywood was also prepared using an imidacloprid SC (Velcloprid 200SC) applied at the same rate as a comparison (Comp 11). The imidacloprid retention in plywood treated with the composite containing Ingeo™ 4060D was 15% higher than plywood treated with the conventional SC (Comp 11) after hot pressing and was 240% higher after 72 h at 100° C.

### Example 7: Friable Biocide-Composite Samples 14-17 and Solidified Biocide-Composite Sample 18 (HME)

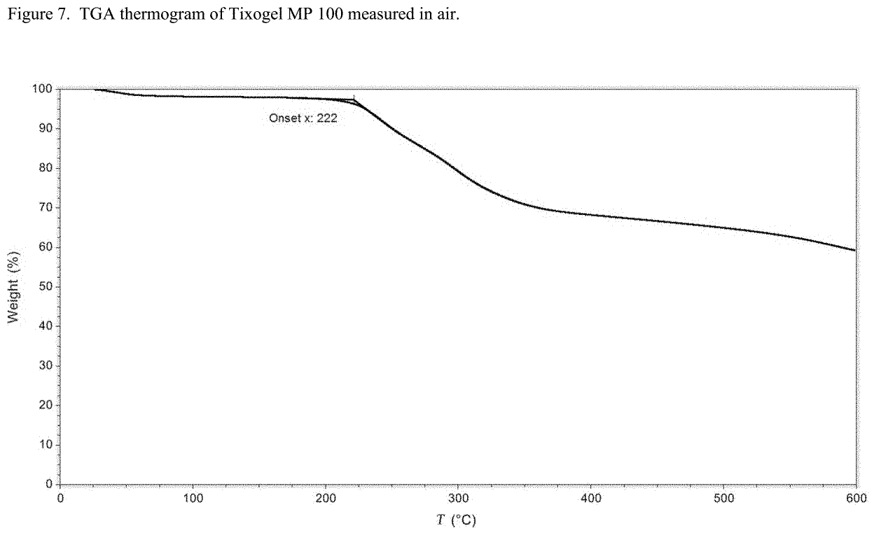

“Friable biocide-composites” comprising a biocide, a thermoplastic and an embrittling agent were formed by HME along with a “solidified biocide-composite” comprising a biocide and an embrittling agent, i.e. no thermoplastic. The organoclay Tixogel MP 100 was used as the embrittling agent. Tixogel MP 100 has a thermal degradation temperature of 222° C. measured as onset of weight loss (FIG. 7, note a slight initial loss of moisture). This temperature represents a practical upper limit for HME when using Tixogel MP 100.

Imidacloprid, coarsely milled KIBISAN® PN-117C (about 0.5 mm average particle size), and Tixogel MP 100 (particle size 1-5 μm) were pre-weighed and blended together, then fed at 1 kg/h into the Feed zone of a Thermofisher Haake PTW16 co-rotating twin screw extruder fitted with 16 mm general purpose screws and operating at 300 rpm (Table 12). The ingredient quantities in Table 12 are expressed as weight % (wt %) based on the total weight of the composition.

TABLE 12
Composition and extrusion parameters for Samples 14-18.

| | 14 | 15 | 16 | 17 | 18 |
|---|---|---|---|---|---|
| Sample | Friable | Friable | Friable | Friable | Solidified |
| Imidacloprid [wt %] | 20 | 20 | 20 | 20 | 2 |
| KIBISAN [wt %] | 75 | 60 | 20 | 5 | — |
| Tixogel [wt %] | 5 | 20 | 60 | 75 | 80 |
| All zones (° C.) | 190 | 190 | 190 | 190 | 160 |
| Average torque (Nm) | 35 | 32 | 25 | 28 | 25 |
| Average die pressure (bar) | 7 | 6 | 7 | 7 | 8 |

### Milling of Samples 14-18

Extrudates were fragmented manually or using a die cutter, then milled at ambient temperature with one pass through a Retsch ZM 200 Ultra-Centrifugal Mill fitted with a twelve tooth rotor and 0.50 mm mill ring sieve, and operating at 18,000 rpm.

For comparison Biocide-Composite Sample 8 was cryomilled in liquid nitrogen using the same mill configuration.

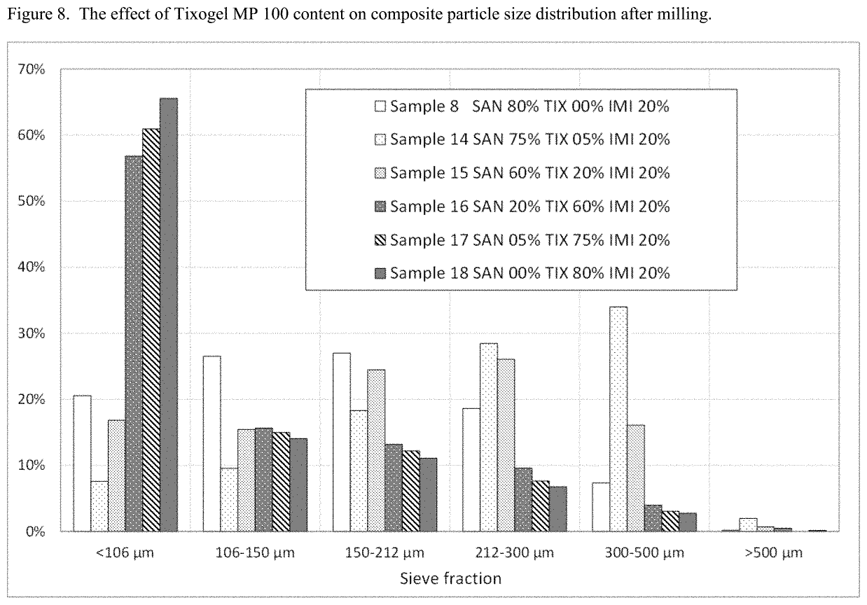

A sieve analysis of each of milled sample was performed using the sieving procedure described in Example 3. The sieve fractions obtained from each friable biocide-composite were weighed. FIG. 8 shows the results of the sieve analyses and demonstrates the effect of addition of an embrittling agent (Tixogel MP 100) on the friability of the composites.

Sample 8, which lacks any embrittling agent, heated quickly, softened and fused to the ring sieve when milled at ambient temperature and could only be milled successfully after pre-embrittlement in liquid nitrogen. The resulting distribution (open bars) was broad with the majority of the particles in the 106-150 μm and 150-212 μm sieve fractions.

Addition of as little as 5 wt % (based on the total amount of the composite) of the embrittling agent Tixogel MP 100 (Sample 14) enabled milling at ambient temperature without significant heating or any ring sieve blockage. Addition of increasing percentages of embrittling agent resulted in redistribution of particles from larger to smaller sieve fractions such that the majority could be milled to <106 μm in a single pass. In the absence of any thermoplastic, Solidified Biocide-Composite 18 (Sample 18) was the most readily milled composite (FIG. 8).

Preparation of Aqueous Suspensions from Samples 14-18

The 106-150 μm and 150-212 μm sieve fractions from each of Samples 14-18 were combined to give a 106-212 μm fraction. Each combined sieve fraction was then formulated as an aqueous suspension by mixing with ingredients in the weight ratios shown above for Biocide-Composite Suspension 8A (Table 12). In addition, a 106-212 μm sieve fraction was prepared from Biocide-Composite Sample 8 (i.e. a biocide-composite with no embrittling agent) and formulated as an aqueous suspension using the same ingredients (Biocide-Composite Suspension 8B).

Each aqueous suspension was divided in two. One half was stored at ambient temperature, the other was stored in a sealed vessel for 14 days at 54° C., an accelerated storage procedure equivalent to 2 years at ambient temperature.

Preparation of Hot-Pressed or Hot-Pressed and Block-Stacked Plywood with Glues Containing Aqueous Suspensions from Samples 8 and 14-18

The suspensions stored at ambient temperature and at 54° C. were then evaluated as glueline treatments in plywood at a nominal imidacloprid application rate of 100 gai/m³ as described above. Comparative plywood was also prepared at the same application rate using Velcloprid 200SC (Comp 12, Imidacloprid SC).

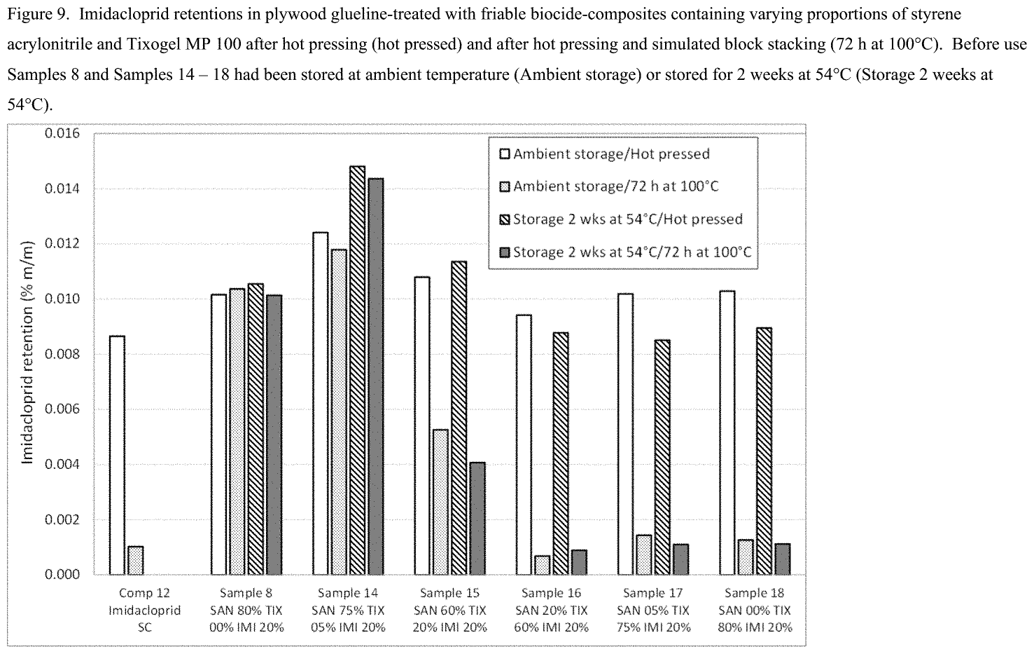

The conventional SC (Comp 12) produced an acceptable retention (0.009% m/m) after hot pressing but this dropped markedly after simulated block stacking for 72 h (FIG. 9). Biocide-Composite Suspension 8B (Sample 8 SAN 80% TIX 00% IMI 20% in FIG. 9) yielded a slightly higher retention after hot pressing and there was no reduction after subsequent block stacking. The same retentions were achieved using the suspensions that had been stored for 2 weeks at ambient temperature or for 2 weeks at 54° C.

Substitution of 5 wt % of the thermoplastic with the Tixogel 1VP 100 embrittling agent (Sample 14 SAN 75% TIX 05% IMI 20% in FIG. 9) produced a further increase in retentions after hot pressing and after hot pressing and holding for 72 h at 100° C. compared to Sample 8. There was no deterioration in performance when Sample 14 was stored for 2 weeks at 54° C. prior to use as a glueline treatment.

Increasing the Tixogel content to 20 wt % (based on the total weight of the composite) (Sample 15 SAN 60% TIX 20% IMI 20% in FIG. 9) gave similar retentions after hot pressing but reduced retentions after block stacking. Using more Tixogel and less KIBISAN (Samples 16-18) did not change the imidacloprid retentions in hot-pressed plywood compared to Comp 12 or Sample 8 (even after storage at 54° C.) but the benefit after simulated block stacking was lost with these samples.

### Example 8: Solidified Biocide-Composite 19 (Hot Helt Mixing)

### Preparation of Solidified Biocide-Composite 19

A solidified biocide-composite was prepared by melting 25 g permethrin (M.p. 34-35° C.) in a beaker at 40° C. and mixing to homogeneity with 75 g Tixogel MP 100 (embrittling agent), cooling overnight to ambient temperature, then milling and sieving to <125 μm. As a comparison a polyurea microcapsule suspension containing 300 g/L permethrin was prepared according to U.S. Pat. No. 3,577,515 (Comp 13).

Preparation of Hot-Pressed or Hot-Pressed and Block-Stacked Plywood with Glue Containing Solidified Biocide-Composite 19

Solidified Biocide-Composite 19 and Comp 13 were blended with Prefere® PF resin and evaluated as glueline treatments in plywood at a nominal application rate of 400 gai/m³. Samples were hot pressed and held at 100° C. for 72 hours, then cut into 20 mm×20 mm squares, ground in a Wiley then analyzed for permethrin retention by HPLC as described under Methods. The permethrin retentions after hot pressing and simulated block stacking indicated a 57.4% recovery of applied permethrin from the Tixogel MP 100-containing material (Solidified Biocide-Composite 19) compared to a 19.1% recovery from the microcapsule reference material (Comp 13).

### Example 9: Solidified Biocide-Composite Samples 20-23 (HME)

### Preparation of Solidified Biocide-Composite Samples 20-23

Solidified biocide-composites were formed by HME. Biocides and Tixogel MP 100 were pre-blended by hand and fed at about 1 kg/hour into the Feed zone of a Thermofisher Haake PTW16 co-rotating twin screw extruder fitted with 16 mm general purpose screws and operating at 300 rpm. Processing conditions are noted in Table 13. The ingredient quantities in Table 13 are expressed as weight % (wt %) based on the total weight of the composition.

TABLE 13
Composition and extrusion parameters for Solidified Biocide-
Composites 20-23.

| Sample | 20 | 21 | 22 | 23 |
|---|---|---|---|---|
| Biocide | Bifenthrin | Bifenthrin | Bifenthrin | Cyproconazole |
| Biocide in [wt %] | 20 | 30 | 40 | 20 |
| Tixogel MP 100 | 80 | 70 | 60 | 80 |
| [wt %] | | | | |
| All zones (° C.) | 100 | 100 | 100 | 130 |
| Av extruder torque | 30 | 16 | 11 | 25 |
| (Nm) | | | | |
| Av die pressure (bar) | 14 | 5 | 3.5 | 9 |
| Biocide <106 μm | 17.8% | 30.7% | 37.9% | 17.3% |
| fraction | | | | |

Extruded strands appeared generally smooth, homogeneous and stable. On cooling Solidified Biocide-Composite Sample 22 contained a trace of surface residue possibly indicating an excess of biocide not intimately mixed with the Tixogel®.

Preparation of Hot-Pressed or Hot-Pressed and Block-Stacked Plywood with Glue Containing Solidified Biocide-Composite Samples 20-23

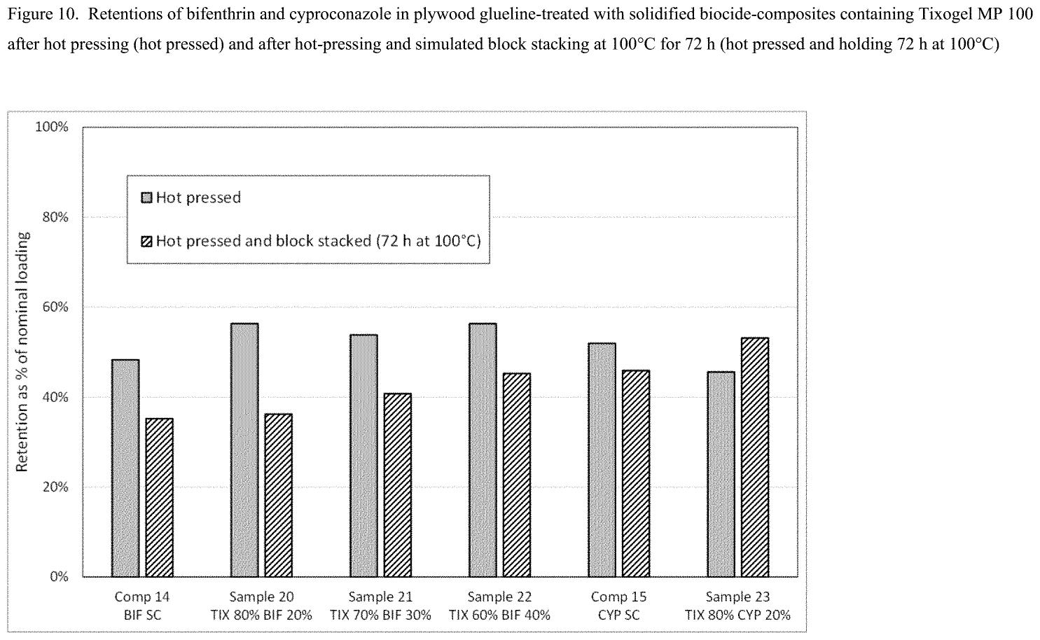

Solidified Biocide-Composite Samples 20-23 were milled, passed through a 106 μm sieve, analyzed for biocide content, and evaluated as glueline treatments in plywood at nominal application rates of 500 gai/m³ (Sample 20, 21 and 22, bifenthrin) and 900 gai/m³ (Sample 23, cyproconazole), as described above. Talstar® 80 SC (Comp 14, “BIF SC”, 500 gai/m³) and a cyproconazole SC (Comp 15, “CYP SC”, 900 gai/m³) were used as conventional formulation reference materials. Treated plywood samples were analyzed in samples cooled immediately after hot pressing and after holding at 100° C. for 72 h (FIG. 10).

The bifenthrin-containing Solidified Biocide-Composite Samples 20-22 showed a small increase in retentions after hot pressing compared to Comp 14 (BIF SC) and there was a progressive increase in retentions after holding at 100° C. for 72 h with increasing bifenthrin content.

Cyproconazole retentions in treated plywood after hot pressing and simulated block stacking were also improved using Solidified Biocide-Composite Sample 23 compared to the conventional formulation (Comp 15, CYP SC) containing the active ingredient alone (FIG. 10).

### Example 10: Friable Biocide-Composite Samples 24-27 (HME)

### Preparation of Friable Biocide-Composite Samples 24-27

Friable Biocide-Composite Samples 24-27 were formed by HME (Labtech LTE 26-40 extruder, 26 mm GP screws) using bifenthrin (M.p. 57-64.6° C.) and etofenprox (M.p. 37.4° C.), four different thermoplastics and Tixogel MP 100 as the embrittling agent (Table 14). Thermoplastic pellets were introduced at the Feed zone and a pre-blend comprising biocide plus embrittling agent was metered into the extruder at Zone 5. Extruded strands were water-cooled, pelletized, dried then milled at 18,000 rpm and ambient temperature using a Retsch ZM 200 Ultra-Centrifugal Mill fitted with a twelve tooth rotor and 0.35 mm mill ring sieve. A<106 μm sieve fraction of each milled composite was prepared with a sieve shaker and, for experimental convenience, used directly in powdered form for glueline treatment of plywood. The ingredient quantities in Table 14 are expressed as weight % (wt %) based on the total weight of the composition.

TABLE 14
Composition and extrusion parameters for Friable Biocide-Composite
Samples 24-27

| Sample | 24 | 25 | 26 | 27 |
|---|---|---|---|---|
| Biocide (wt %) | 20% | 20% | 10% | 10% |
| | Bifenthrin | Bifenthrin | Bifenthrin | Etofenprox |
| Thermoplastic | 75% | 75% | 80% | 50% |
| (wt %) | STYRON | Chemvin | ACRYREX ® | KIBISAN ® |
| | 685D (PS) | PVC RE 55 | CM-207 | PN-117C |
| | | (PVC) | (PMMA) | (SAN) |
| Embrittling | 5% Tixogel | 5% Tixogel | 10% Tixogel | 40% |
| agent (wt %) | | | | Tixogel |
| Total feed rate | 4.38 | 5.00 | 4.38 | 5.0 |
| (kg/h) | | | | |
| Screw speed | 200 | 150 | 200 | 200 |
| (rpm) | | | | |
| Feed set | 215 | 190 | 220 | 190 |
| temp (° C.) | | | | |
| Zone 2 set | 205 | 190 | 220 | 190 |
| temp (° C.) | | | | |
| Zone 3 set | 205 | 190 | 220 | 190 |
| temp (° C.) | | | | |
| Zone 4 set | 205 | 190 | 210 | 190 |
| temp (° C.) | | | | |
| Zone 5 set | 200 | 180 | 200 | 180 |
| temp (° C.) | | | | |
| Zone 6 set | 195 | 180 | 200 | 180 |
| temp (° C.) | | | | |
| Zone 7 set | 190 | 180 | 200 | 180 |
| temp (° C.) | | | | |
| Zone 8 set | 190 | 180 | 200 | 180 |
| temp (° C.) | | | | |
| Zone 9 set | 190 | 170 | 200 | 180 |
| temp (° C.) | | | | |
| Die set | 200 | 170 | 200 | 180 |
| temp (° C.) | | | | |
| Average torque | 42 | 41 | 41 | N/A |
| (%) | | | | |
| Average die | 25 | 30 | 35 | N/A |
| pressure (bar) | | | | |

### Preparation and Analysis of Hot-Pressed or Hot-Pressed and Block-Stacked Plywood

Plywood was manufactured using Prefere® PF resin treated at 200 gai/m³ with Talstar® 80 SC (Comp 16, Bifenthrin SC) or an etofenprox emulsifiable concentrate (Comp 17, Etofenprox EC) as conventional formulation reference samples, along with the <106 μm sieve fractions from Friable Biocide-Composite Samples 24-27. The plywood was manufactured as described in Example 2 except that the dimensions of the veneers were 200 mm×200 mm×3.63 mm thick. The plywood layup comprising 7 veneers was sawn in half and hot pressed for 12 minutes at 145° C. and about 10 MPa. After hot pressing, each half of the plywood was wrapped in aluminium foil, one half was allowed to cool to ambient temperature immediately (“hot-pressed”), while the other was kept at 100° C. in an oven for 72 h before allowing to cool to ambient temperature.

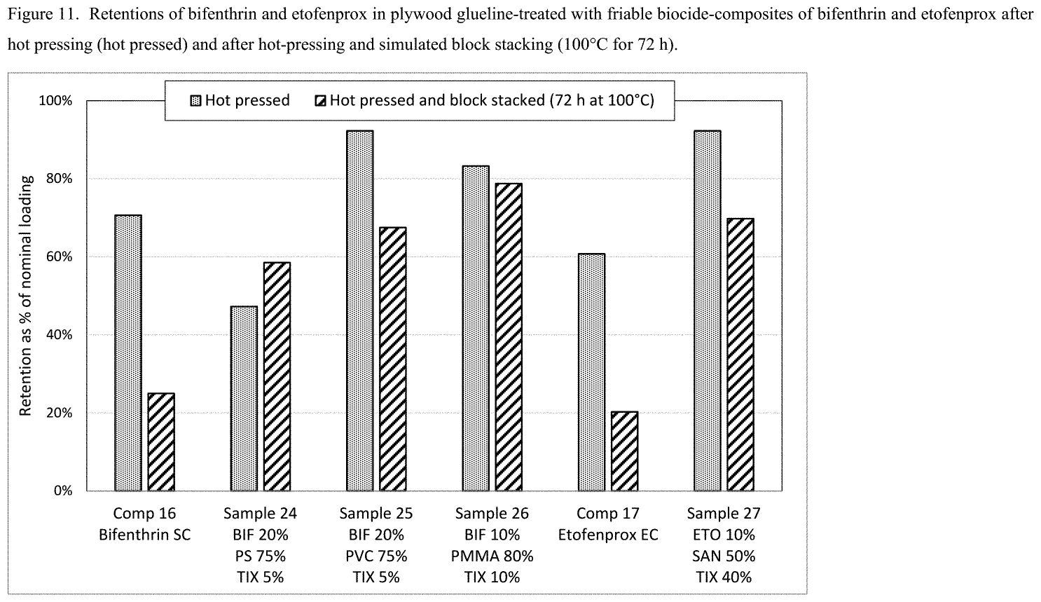

The treated plywood specimens were then cut into 20 mm×20 mm squares, ground in a Wiley® Mill and analyzed for bifenthrin and etofenprox retentions as described under Methods. The biocide retentions are presented as percentage recoveries of the nominal loading as described above (see FIG. 11).

The three bifenthrin-containing friable biocide-composites (Samples 24, 25 and 26) gave large improvements in recoveries compared to Talstar® 80 SC (Comp 16, Bifenthrin SC), especially after simulated block stacking, with the ACRYREX® CM-207-containing material (Sample 26) delivering the best performance (see FIG. 11). Significant losses of etofenprox occurred in plywood containing the conventional formulation (Comp 17, Etofenprox EC), whereas large improvements in etofenprox recoveries were obtained when using KIBISAN-containing Friable Biocide-Composite Sample 27 (FIG. 11).

### Example 11: Friable Biocide-Composite Samples 28-31 (HME)

### Preparation of Friable Biocide-Composite Samples 28-31

HME and milling of friable biocide-composites were performed as described above using fipronil (M.p. 203° C.) and trifloxystrobin (M.p. 72.9° C.) as biocides, three different thermoplastics and Tixogel MP 100 as embrittling agent (see Table 15). The ingredient quantities in Table 15 are expressed as weight % (wt %) based on the total weight of the composition.

TABLE 15
Composition and extrusion parameters for Friable Biocide-Composite Samples
28-31

| Sample | 28 | 29 | 30 | 31 |
|---|---|---|---|---|
| Biocide (wt %) | 10% | 10% | 20% | 20% |
| | Fipronil | Fipronil | Trifloxystrobin | Trifloxystrobin |
| Thermoplastic (wt %) | 70% | 70% | 70% STYRON | 70% |
| | ACRYREX ® | KIBISAN ® | 685D (PS) | KIBISAN ® |
| | CM-207 | PN-117C | | PN-117C |
| | (PMMA) | (SAN) | | (SAN) |
| Embrittling agent | 20% | 20% | 10% Tixogel | 10% Tixogel |
| (wt%) | Tixogel | Tixogel | | |
| Total feed rate (kg/h) | 5.00 | 5.0 | 4.1 | 4.1 |
| Screw speed (rpm) | 200 | 200 | 200 | 200 |
| Feed set temp (° C.) | 220 | 190 | 215 | 190 |
| Zone 2 set temp (° C.) | 220 | 190 | 205 | 190 |
| Zone 3 set temp (° C.) | 220 | 190 | 205 | 190 |
| Zone 4 set temp (° C.) | 210 | 190 | 205 | 190 |
| Zone 5 set temp (° C.) | 200 | 180 | 200 | 180 |
| Zone 6 set temp (° C.) | 200 | 180 | 195 | 180 |
| Zone 7 set temp (° C.) | 200 | 180 | 190 | 190 |
| Zone 8 set temp (° C.) | 195 | 180 | 190 | 190 |
| Zone 9 set temp (° C.) | 190 | 180 | 190 | 190 |
| Die set temp (° C.) | 190 | 180 | 200 | 190 |
| Average torque (%) | 41 | 44 | 41 | 41 |
| Average die pressure | 56 | 31 | 31 | 19 |
| (bar) | | | | |

### Preparation and Analysis of Hot-Pressed or Hot-Pressed and Block-Stacked Plywood

Plywood was manufactured using Prefere® PF resin treated at 200 gai/m³ suspension concentrates of fipronil (Comp 18, Fipronil SC) and trifloxystrobin (Comp 19, Trifloxystrobin SC) as conventional formulation reference samples, alongside the <106 μm sieve fractions from Friable Biocide-Composite Samples 28-31. Plywood was hot pressed and block stacked as described in Example 10, then analysed for fipronil and trifloxystrobin retentions as described in Methods.

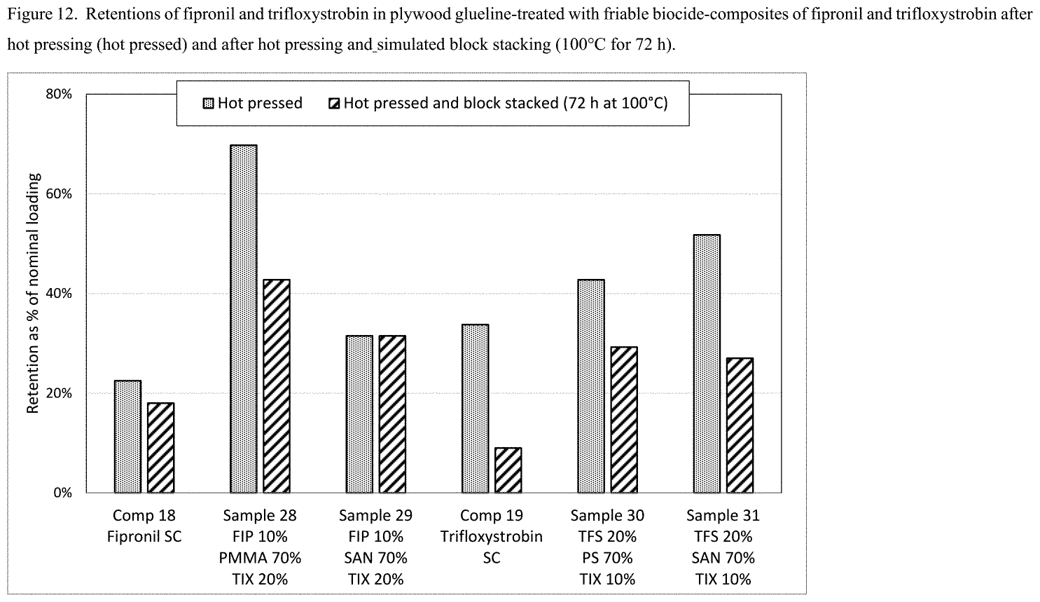

When applied as a conventional SC (Comp 18) only about 20% of the applied fipronil was recovered from treated plywood after hot pressing and simulated block stacking whereas friable biocide-composites prepared with KIBISAN® or ACRYREX® CM-207 delivered significant improvements in fipronil recoveries (Samples 28 and 29, FIG. 12). Large losses of trifloxystrobin when applied as Comp 19 (SC) were very significantly reduced when applied as friable biocide-composites using both STYRON 685D and KIBISAN® as the thermoplastic (Samples 30 and 31, FIG. 12).

### Example 12: Friable Biocide-Composite Samples 32-35 (HME)

### Preparation of Friable Biocide-Composite Samples 32-35

HME and milling of friable biocide-composites were performed as described above using the biocides pyraclostrobin (M.p. 63.7-65.2° C.), buprofezin (M.p. 104.6-105.6° C.), emamectin benzoate (M.p. 141-146° C.) and penconazole (M.p. 60.3-61° C.), two different thermoplastics, along with either Tixogel MP 100 or TALC A325 (talc) as embrittling agent (see Table 16). Sieve fractions (<106 μm) were used directly for plywood glueline treatments with the exception of Sample 34, which was a <300 μm sieve fraction. The ingredient quantities in Table 16 are expressed as weight % (wt %) based on the total weight of the composition.

TABLE 16
Composition and extrusion parameters for Friable Biocide-Composite
Samples 32-36

| Sample | 32 | 33 | 34 | 35 |
|---|---|---|---|---|
| Biocide (wt %) | 20% | 20% | 20% | 20% |
| | Pyraclostrobin | Buprofezin | Emamectin | Pencona- |
| | | | benzoate | zole |
| Thermoplastic | 60% | 70% | 75% | 70% |
| (wt. %) | KIBISAN ® | STYRON | STYRON | STYRON |
| | PN-117C | 685D (PS) | 685D (PS) | 685D (PS) |
| | (SAN) | | | |
| Embrittling | 20% TALC | 10% TALC | 5% Tixogel | 10% TALC |
| agent (wt. %) | A325 | A325 | | A325 |
| Total feed rate | 5.0 | 3.51 | 3.12 | 3.57 |
| (kg/h) | | | | |
| Screw speed | 200 | 150 | 200 | 200 |
| (rpm) | | | | |
| Feed set | 190 | 215 | 215 | 215 |
| temp (° C.) | | | | |
| Zone 2 set | 190 | 205 | 205 | 205 |
| temp (° C.) | | | | |
| Zone 3 set | 190 | 205 | 205 | 205 |
| temp (° C.) | | | | |
| Zone 4 set | 190 | 205 | 205 | 205 |
| temp (° C.) | | | | |
| Zone 5 set | 180 | 200 | 200 | 200 |
| temp (° C.) | | | | |
| Zone 6 set | 180 | 195 | 195 | 195 |
| temp (° C.) | | | | |
| Zone 7 set | 180 | 190 | 190 | 190 |
| temp (° C.) | | | | |
| Zone 8 set | 180 | 190 | 190 | 190 |
| temp (° C.) | | | | |
| Zone 9 set | 180 | 190 | 190 | 190 |
| temp (° C.) | | | | |
| Die set | 180 | 200 | 200 | 200 |
| temp (° C.) | | | | |
| Average torque | N/A | 42 | 41 | 41 |
| (%) | | | | |
| Average die | N/A | 14 | 28 | 13 |
| pressure (bar) | | | | |

### Preparation and Analysis of Hot-Pressed or Hot-Pressed and Block-Stacked Plywood

Plywood was manufactured using Prefere® PF resin treated at 200 gai/m³ with suspension concentrates of pyraclostrobin (Comp 20, Pyraclostrobin SC), buprofezin (Comp 21, Buprofezin SC) and penconazole (Comp 23, Penconazole SC), and a soluble concentrate (SL) of emamectin benzoate (Comp 22, Emamectin benzoate SL) as conventional formulation reference samples, alongside the <106 μm sieve fractions of the Friable Biocide-Composite Samples 32-35. Plywood was hot pressed and block stacked as described in Example 10. Buprofezin and penconazole retentions were analysed by GC according to the bifenthrin procedure in Methods, while the retentions of pyraclostrobin and emamectin benzoate were analysed according to their own procedures in Methods.

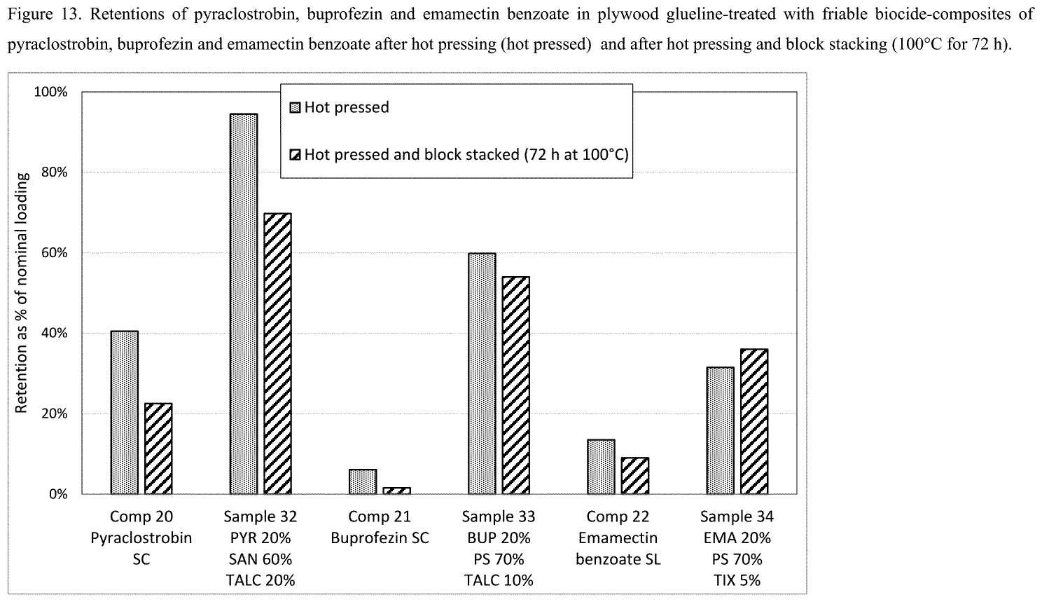

When applied as a conventional SC (Comp 20), pyraclostrobin recoveries were about 40% and 20% after hot pressing and simulated block stacking but increased about 2-fold and about 3-fold, respectively, when applied as a Friable Biocide-Composite (Sample 32, FIG. 13). Buprofezin was almost completely destroyed when applied as a SC (Comp 21) but recoveries were excellent when buprofezin was applied as a composite containing with STYRON® 685D and TALC A325 (Sample 33). Emamectin benzoate likewise gave very low recoveries as a conventional SC (Comp 22) but 30-40% recoveries when applied as a Friable Biocide-Composite (Sample 34, FIG. 13). A modest increase in penconazole recovery was achieved after block stacking when applied as a Friable Biocide-Composite (Sample 35) compared to the conventional SC (Comp 23 Penconazole SC, Table 17).

TABLE 17
Penconazole retentions in plywood after hot pressing and after hot
pressing and simulated block stacking (100° C. for 72 h).

| | Penconazole retention (% m/m) | |
|---|---|---|
| | Hot pressed | 72 h at 100° C. |
| Comp 23 Penconazole SC | 33.8% | 13.5% |
| Sample 35 (PEN 20% PS 70% | 27.0% | 20.3% |
| TALC 10%) | | |

### Particle Size Analysis of Friable Biocide Composite Samples 14, 25-29, 32 and 34

Sieve fractions from Friable Biocide Composite Samples 14, 25-29, 32 and 34 were subjected to particle size analysis by laser diffraction as described in Methods. The laser diffraction data in Table 18 demonstrate a range of useful particle sizes, expressed as Dv10 and Dv90 values, for use in glueline preservation of glued wood products.

TABLE 18
Dv10 and Dv90 values determined by laser diffraction for sieve fractions derived
from Friable Biocide Composite Samples 14, 25 to 29, 32 and 34.

| | | | Particle size by | |
|---|---|---|---|---|
| | | | laser diffraction | |
| | | Sieve | Dv10 | Dv90 |
| Sample | Sample Composition | fraction | (μm) | (μm) |
| 14 | 20 wt. % Imidacloprid (IMI), 75 wt. % KIBISAN ® | <106 μm | 35.8 | 176 |
| | (SAN), 5 wt. % Tixogel MP 100 (TIX) | | | |
| 14 | 20 wt. % Imidacloprid (IMI), 75 wt. % KIBISAN ® | 106-150 | 106 | 204 |
| | (SAN), 5 wt. % Tixogel MP 100 (TIX) | μm | | |
| 14 | 20 wt. % Imidacloprid (IMI), 75 wt. % KIBISAN ® | 150-212 | 146 | 269 |
| | (SAN), 5 wt. % Tixogel MP 100 (TIX) | μm | | |
| 14 | 20 wt. % Imidacloprid (IMI), 75 wt. % KIBISAN ® | 212-300 | 205 | 379 |
| | (SAN), 5 wt. % Tixogel MP 100 (TIX) | μm | | |
| 14 | 20 wt. % Imidacloprid (IMI), 75 wt. % KIBISAN ® | 300-500 | 302 | 659 |
| | (SAN), 5 wt. % Tixogel MP 100 (TIX) | μm | | |
| 25 | 20 wt. % bifenthrin (BIF), 75 wt. % Chemvin PVC | <106 μm | 36.7 | 156 |
| | (PVC), 5 wt. % Tixogel MP 100 (TIX) | | | |
| 26 | 10 wt. % bifenthrin (BIF), 80 wt. % ACRYREX ® | <106 μm | 40.2 | 114 |
| | (PMMA), 10 wt. % Tixogel MP 100 (TIX) | | | |
| 27 | 10 wt. % Etofenprox (ETO), 50 wt. % KIBISAN ® | <106 μm | 43.6 | 150 |
| | (SAN), 40 wt. % Tixogel MP 100 (TIX) | | | |
| 28 | 10 w. % fipronil (FIP), 70 wt. % ACRYREX ® | <106 μm | 19.5 | 126 |
| | (PMMA), 20 wt. % Tixogel MP 100 (TIX) | | | |
| 29 | 10 w. % fipronil (FIP), 70 wt. % KIBISAN ® (SAN) | <106 μm | 37.9 | 148 |
| | 20 wt. % Tixogel MP 100 (TIX) | | | |
| 32 | 20 wt. % Pyraclostrobin (PYR), 60 wt. % | <106 μm | 42.2 | 136 |
| | KIBISAN ® (SAN), 29 wt. % TALC | | | |
| 34 | 20 wt % Emamectin benzoate (EMA), 75 wt % | <300 μm | 113 | 338 |
| | STYRON 685D (PS), 5 wt. % Tixogel MP 100 | | | |
| | (TIX) | | | |

1. A biocide-composite comprising
a) at least one biocide and
b) at least one non-biocidal solid selected from the group consisting of a thermoplastic, an embrittling agent, and combinations thereof.

2. The biocide-composite according to claim 1, wherein the at least one biocide comprises one or more insecticides, or one or more fungicides, or a combination thereof.

3. The biocide-composite according to claim 1, wherein the at least one biocide comprises an insecticide comprising a neonicotinoid, a pyrethroid, a phenylpyrazole, an avermectin, chitin synthesis inhibitors, an uncoupler of oxidative phosphorylation, an insect growth regulator, a fungicide comprising from an azole, a quinone outside inhibitor fungicide, or any combinations thereof.

4. The biocide-composite according to claim 1, wherein the at least one non-biocidal solid is
i) a water-insoluble thermoplastic having a glass transition temperature (Tg) of 45° C. or more, or a Vicat softening temperature (VST) of 45° C. or more, and/or
ii) an embrittling agent.

5. The biocide-composite according to claim 4, wherein the thermoplastic is a polymer and/or copolymer comprising a styrene acrylonitrile copolymer, a polymethylmethacrylate, polyoxymethylene, polyimide, polyacrylonitrile, polycarbonate, polyetherimide, polyethersulfone, polyethylene, polyethylene terphthalate, polyphenylene sulphide, polypropylene, polystyrene, polysulfone, polyvinyl chloride, acrylonitrile butadiene styrene, an acrylate polymer, a methacrylate polymer, a sidechain modified polymer, a biopolymer comprising a cellulose ether or ester, polylactic acid, a water-insoluble protein, a high melting point wax, biopolymer blends, thermoplastic aliphatic and aromatic hydrocarbon resins, or any combination thereof.

6. The biocide-composite according to claim 1, wherein the embrittling agent is a ground mineral, a chemically modified clay, an organoclay, talc, a silicate, diatomaceous earth, pumice, limestone, chalk, calcium carbonate, calcite, dolomite, gypsum, feldspar, alumina, perlite, powdered coal or sulphur, ground ceramic, ground glass, sawdust, wood flour, ground bark, powdered lignin, ground nut shells, husks, kernels and combinations thereof.

7. The biocide-composite according to claim 1 having a particle size Dv10 of at least about 5 μm and Dv90 of about 500 μm or less

8. The biocide-composite according to claim 1, comprising from about 6 to about 40 wt. % biocide, from about 45 wt. % to about 60 wt. % thermoplastic, and from about 5 wt. % to about 40 wt. % embrittling agent, based on the combined weight of the biocide, the thermoplastic and the embrittling agent.

9. A formulation comprising the biocide-composite according to claim 1, wherein the formulation is a solid formulation comprising a powder or granules, or a liquid formulation comprising a suspension or a dispersion.

10. A glue for glueline treatment of glued-wood products comprising the biocide-composite of claim 1.

11. The glue according to claim 10, wherein the glue is a phenolic resin including phenol-formaldehyde resins, resorcinol-formaldehyde resins and phenol-resorcinol-formaldehyde resins, amino resins including hydroxymethyl or alkoxymethyl derivatives of urea, melamine, benzoguanamine, glycoluril, urea-formaldehyde, melamine-formaldehyde, melamine-urea formaldehyde resins, isocyanate resins including pMDI, thermoset epoxy and polyurethane resins, PVAs, and adhesives based on biomaterials including proteins, starches and lignocellulosic extractives including ligninsor combinations thereof.

12. A process for preparing a biocide-composite according to claim 1 comprising the steps of
a) contacting the at least one biocide with the at least one non-biocide solid,
b) mixing and melting the at least one biocide with the at least one non-biocide solid to form the biocide-composite
c) cooling the biocide-composite obtained in step b) to form a solid biocide-composite, and
d) optionally comminution of the solid biocide-composite to obtain the biocide-composite in particulate form.

13. The process of claim 12, wherein the at least one non-biocide solid is a thermoplastic, and wherein in step a) the at least one biocide and/or the thermoplastic are present in the form of a melt.

14. The process of claim 12, wherein the at least one non-biocide solid is an embrittling agent, and wherein in step a) the at least one biocide and/or the embrittling are present in the form of a powder, or
wherein in step a) the at least one biocide is present in the form of a melt, and the embrittling agent is present in the form of a powder.

15. The process of claim 12, wherein the at least one non-biocide solid is a thermoplastic and an embrittling agent, and
wherein in step a) the at least one biocide and/or the thermoplastic are present in the form of a melt and said embrittling agent is present in the form of a powder, or wherein in step a) the thermoplastic is present in the form of a melt, and the at least one biocide and the embrittling agent are present in the form of a powder.

16. A process for preparing a biocide-composite according to claim 1, comprising the steps of
a) dissolving the at least one biocide and the at least one non-biocide solid in a non-aqueous solvent, wherein the at least one non-biocide solid is a thermoplastic,
b) optionally adding an embrittling agent, and
c) removing the non-aqueous solvent to obtain the biocide-composite in the form of a solid, and
d) optionally comminution of the solid biocide-composite to obtain the biocide-composite in particulate form.

17. A process for preparing a biocide-composite according to claim 1, comprising the steps of
a) dissolving the at least one biocide in a non-aqueous solvent,
b) mixing the solution with the at least one non-biocide solid, which is an embrittling agent, and
c) removing the non-aqueous solvent to obtain the biocide-composite in the form of a solid, and
d) optionally comminution of the solid biocide-composite to obtain the biocide-composite in particulate form.

18. A method for increasing the friability of a biocide-composite comprising at least one biocide and a water-insoluble thermoplastic having a glass transition temperature (Tg) of 45° C. or more, or a Vicat softening temperature (VST) of 45° C. or more, comprising including an embrittling agent as defined in claim 6 into the biocide-composite.

19. A method for increasing the retention of at least one biocide in a glueline-treated glued-wood product that has been hot-pressed or hot-pressed and block-stacked during manufacture, comprising applying a biocide-composite according to claim 1.

20. A method for producing a glueline-treated glued-wood product comprising applying a biocide-composite according to claim 1 during glueline treatment.

21. The method according to claim 20, wherein the biocide-composite is blended directly into the glue, or
wherein the biocide-composite is applied indirectly to the glue by application to the wood component prior to, at the same time as, or after introduction of the glue during manufacture of the glued wood product.

22. A glueline-treated glued-wood product comprising a biocide-composite according to claim 1.

23. The glueline-treated glued-wood product according to claim 22, wherein the glued-wood product is an engineered wood product, glued-wood veneer, plywood, LVL, reconstituted wood-based product, glued-wood flake, chips, strands, particles, fibers, flour, dusts, nanofibrils, flakeboard, chipboard, strandboard, OSB, parallel strand lumber, particleboard, MDF, high density fibreboard, hardboard, or combinations thereof.

24. A glueline-treated glued-wood product manufactured according to the method of a claim 20.

25. A biocide-composite obtainable by a process for preparing a biocide-composite comprising the steps of
a) contacting the at least one biocide with the at least one non-biocide solid,
b) mixing and melting the at least one biocide with the at least one non-biocide solid to form the biocide-composite
c) cooling the biocide-composite obtained in step b) to form a solid biocide-composite, and
d) optionally comminution of the solid biocide-composite to obtain the biocide-composite in particulate form.
